(19) United States
(12) Patent Application Publication
(10) Pub. No.: US 2025/0340728 A1
(43) Pub. Date: Nov. 6, 2025

(54) RESIN COMPOSITION, MOLDED PRODUCT, MULTILAYER STRUCTURE, THERMOFORMED CONTAINER, BLOW-MOLDED CONTAINER, AND VAPOR DEPOSITION FILM

(71) Applicant: Kuraray Co., Ltd., Okayama (JP)

(72) Inventors: Mizuko OSHITA, Kurashiki-shi, Okayama (JP); Tatsuya HASEGAWA, Tainai-shi, Niigata (JP); Kentaro YOSHIDA, Kurashiki-shi, Okayama (JP); Minoru OKAMOTO, Kurashiki-shi, Okayama (JP); Kimio OKADA, Kurashiki-shi, Okayama (JP)

(73) Assignee: Kuraray Co., Ltd., Okayama (JP)

(21) Appl. No.: 18/696,979

(22) PCT Filed: Sep. 28, 2022
(86) PCT No.: PCT/JP2022/036247

§ 371 Date: Oct. 28, 2024

(30) Foreign Application Priority Data
Sep. 29, 2021 (JP) 2021-159079

(51) Int. Cl. C08L 29/04; C08K 5/07; C08K 5/09

(52) U.S. Cl. CPC C08L 29/04; C08K 5/07; C08K 5/09; C08K 2201/014; C08L 2201/08; C08L 2203/16; C08L 2203/18; C08L 2203/30; C08L 2205/025

(57) ABSTRACT

Provided are: a resin composition containing an ethylene-vinyl alcohol copolymer (EVOH), the resin composition allowing for inhibition of neck-in and die buildup at a time of melt molding; and the like.

The resin composition contains: an ethylene-vinyl alcohol copolymer (A) having an ethylene unit content of 20 mol % or more and 60 mol % or less; and crotonaldehyde (B1), wherein the resin composition further comprises at least one selected from the group consisting of 2,4-hexadienal (B2) and 2,4,6-octatrienal (B3), and the following inequalities (1) and (2) are satisfied. In the inequalities (1) and (2): b1 represents a content (ppm) of crotonaldehyde (B1) with respect to the ethylene-vinyl alcohol copolymer (A); b2 represents a content (ppm) of 2,4-hexadienal (B2) with respect to the ethylene-vinyl alcohol copolymer (A); and b3 represents a content (ppm) of 2,4,6-octatrienal (B3) with respect to the ethylene-vinyl alcohol copolymer (A).

$$2. \leq {b}_{1} / ( {b}_{2} + {b}_{3} ) < 150. \qquad ( 1 )$$

$${b}_{2} + 2 {b}_{3} \leq 0.65 . \qquad ( 2 )$$

### TECHNICAL FIELD

The present invention relates to a resin composition, a molded product, a multilayer structure, a thermoformed container, a blow-molded container, and a vapor deposition film.

### BACKGROUND ART

Ethylene-vinyl alcohol copolymers (hereinafter, may be abbreviated to “EVOH(s)”) are polymeric materials that are superior in gas barrier properties against oxygen and the like, oil resistance, antistatic properties, mechanical strength, melt molding properties, and the like. Thus, EVOH resin compositions are widely used as molding materials for containers, sheets, films, and the like. Typically, in molding of the containers and the like, melt molding is often used. Consequently, resin compositions to be subjected to melt molding are required to have performance involving superiority in long-run workability involving, e.g., defects such as fisheyes and streaks not occurring even when melt molding is performed over a long time period.

However, since the EVOH has a comparatively active hydroxy group in its molecule, an oxidizing and crosslinking reaction proceeds in a molten state at high temperatures even in the interior of an extrusion molding machine in a state being almost free from oxygen, and thus thermal deterioration products may be generated. In particular, when a continuous operation is carried out over a long time period, the thermal deterioration products may be deposited in the molding machine, leading to occurrence of gelling and aggregates which result in fisheyes. Thus, EVOH resin compositions may have insufficient long-run workability.

With regard to this, Patent Document 1 discloses that a resin composition containing EVOH and an unsaturated aldehyde at a content of 0.01 to 100 ppm inhibits the occurrence of defects such as fisheyes, gelling, and streaks, and is superior in long-run workability.

### PRIOR ART DOCUMENTS

### Patent Documents

Patent Document 1: PCT International Publication No. 2013/146961

### SUMMARY OF THE INVENTION

### Problems to be Solved by the Invention

It was revealed that in the case of using the EVOH resin composition of Patent Document 1, there may be a problem of neck-in, in which in film molding with a T-die, a width of the film extruded becomes smaller than an effective width of the die. As a result of thorough investigation by the present inventors, it was found that surprisingly, an EVOH resin composition containing certain multiple types of unsaturated aldehydes in a certain proportion enables inhibiting such neck-in. However, in investigating the content of the multiple types of unsaturated aldehydes to attempt neck-in inhibition, it was revealed that a problem had newly occurred in which depending on the proportion of the multiple types of unsaturated aldehydes, die buildup (die lip deposition, meaning deposits on an outer face of a die lip) tends to adhere to the outer face of the die lip of the melted resin composition.

On the other hand, in recent years, in order to, e.g., attain a synergistic effect of barrier property improvements by diversifying layer configurations and by providing with an inorganic vapor deposition layer, there have been increasing cases of producing multilayer structures by coextruding such that an EVOH layer is atop layer. The occurrence of the die buildup may become a significant problem in a case in which coextrusion is performed such that the EVOH layer is the top layer of the multilayer structure, which involves an area in which the EVOH comes in contact with the die lip being large.

The present invention was made in view of such circumstances, and an object of the present invention is to provide: a resin composition containing an EVOH, the resin composition allowing for inhibition of neck-in and die buildup at a time of melt molding; and a molded product, a multilayer structure, and the like in which the resin composition is utilized.

### Means for Solving the Problems

The above-described object is achieved by providing the following:

(1) A resin composition containing: an ethylene-vinyl alcohol copolymer (A) (hereinafter, may be abbreviated to “EVOH (A)”) having an ethylene unit content of 20 mol % or more and 60 mol % or less; and crotonaldehyde (B1), wherein the resin composition further comprises at least one selected from the group consisting of 2,4-hexadienal (B2) and 2,4,6-octatrienal (B3), and the following inequalities (1) and (2) are satisfied:

$$2. \leq {b}_{1} / ( {b}_{2} + {b}_{3} ) < 150. \qquad ( 1 )$$

$${b}_{2} + 2 {b}_{3} \leq 0.65 \qquad ( 2 )$$

wherein, in the above inequalities (1) and (2), b₁ represents a content (ppm) of crotonaldehyde (B1) with respect to the EVOH (A); b₂ represents a content (ppm) of 2,4-hexadienal (B2) with respect to the EVOH (A); and b₃ represents a content (ppm) of 2,4,6-octatrienal (B3) with respect to the EVOH (A);

(2) The resin composition according to (1), wherein a sum (b₁+b₂+b₃) of the contents of crotonaldehyde (B1), 2,4-hexadienal (B2), and 2,4,6-octatrienal (B3) with respect to the EVOH (A) is 0.01 ppm or more and 7.0 ppm or less;

(3) The resin composition according to (1) or (2), wherein the content b₁ of crotonaldehyde (B1) is 0.01 ppm or more and 4.0 ppm or less;

(4) The resin composition according to any one of (1) to (3), wherein the content b₂ of 2,4-hexadienal (B2) is 0.005 ppm or more and 0.65 ppm or less;

(5) The resin composition according to any one of (1) to (4), wherein the content b₃ of 2,4,6-octatrienal (B3) is 0.325 ppm or less;

(6) The resin composition according to any one of (1) to (5), further containing a conjugated polyene compound (C), wherein a content c of the conjugated polyene compound (C) with respect to the EVOH (A) is 1 ppm or more and less than 300 ppm;

(7) The resin composition according to (6), wherein the conjugated polyene compound (C) is sorbic acid;

(8) The resin composition according to any one of (1) to (7), wherein the EVOH (A) contains: an ethylene-vinyl alcohol copolymer (Aa) (hereinafter, may be abbreviated to “EVOH (Aa)”) having an ethylene unit content of 20 mol % or more and 50 mol % or less; and an ethylene-vinyl alcohol copolymer (Ab) (hereinafter, may be abbreviated to “EVOH (Ab)”) having an ethylene unit content of 30 mol % or more and 60 mol % or less, a difference (Ab−Aa) between the ethylene unit content of the EVOH (Ab) and the ethylene unit content of the EVOH (Aa) is 4.5 mol % or more, and a mass ratio (Aa/Ab) of the EVOH (Aa) to the EVOH (Ab) is 60/40 or more and 95/5 or less;

(9) The resin composition according to any one of (1) to (8), further containing inorganic particles (D), wherein a content d of the inorganic particles (D) with respect to the EVOH (A) is 50 ppm or more and 5,000 ppm or less;

(10) The resin composition according to any one of (1) to (9), further containing an nonionic surfactant (E), wherein a content e of the nonionic surfactant (E) with respect to the EVOH (A) is 0.1 ppm or more and 1,000 ppm or less;

(11) The resin composition according to any one of (1) to (10), further containing an antioxidant (F), wherein a content f of the antioxidant (F) is 0.01% by mass or more and 5% by mass or less;

(12) The resin composition according to any one of (1) to (11), further containing a thermoplastic elastomer (G), wherein a mass ratio (G/A) of the thermoplastic elastomer (G) to the EVOH (A) is 5/95 or more and 35/65 or less;

(13) A molded product including a part constituted from the resin composition according to any one of (1) to (12);

(14) A multilayer structure including at least one layer constituted from the resin composition according to any one of (1) to (12);

(15) A thermoformed container including a layer constituted from the resin composition according to any one of (1) to (12);

(16) A blow-molded container including a layer constituted from the resin composition according to any one of (1) to (12); and

(17) A vapor deposition film including: a base layer constituted from the resin composition according to any one of (1) to (12); and an inorganic vapor deposition layer provided on at least one face of the base layer.

### Effects of the Invention

The present invention enables providing: a resin composition containing an EVOH, the resin composition allowing for inhibition of neck-in and die buildup at a time of melt molding; and a molded product, a multilayer structure, and the like in which the resin composition is utilized.

### BRIEF DESCRIPTION OF THE DRAWINGS

FIG. 1 is a schematic perspective view illustrating a cup-shaped container which is one embodiment of a thermoformed container of the present invention.

FIG. 2 is a cross sectional view of the cup-shaped container illustrated in FIG. 1.

FIG. 3 is a schematic cross-sectional view illustrating a main section of the cup-shaped container illustrated in FIG. 1.

FIG. 4 is a schematic view for describing a method for producing the cup-shaped container illustrated in FIG. 1.

FIG. 5 is a schematic view for describing a method for producing the cup-shaped container illustrated in FIG. 1.

FIG. 6 is a schematic partial cross-sectional view illustrating one embodiment of a blow-molded container of the present invention.

### DESCRIPTION OF EMBODIMENTS

### Resin Composition

The resin composition of the present invention contains an EVOH (A) and crotonaldehyde (B1), wherein the resin composition further contains at least one selected from the group consisting of 2,4-hexadienal (B2) and 2,4,6-octatrienal (B3), and the following inequalities (1) and (2) are satisfied:

$$2. \leq {b}_{1} / ( {b}_{2} + {b}_{3} ) < 150. \qquad ( 1 )$$

$${b}_{2} + 2 {b}_{3} \leq 0.65 . \qquad ( 2 )$$

In the above inequalities (1) and (2), b₁ represents a content (ppm) of crotonaldehyde (B1) with respect to the EVOH (A); b₂ represents a content (ppm) of 2,4-hexadienal (B2) with respect to the EVOH (A); and b₃ represents a content (ppm) of 2,4,6-octatrienal (B3) with respect to the EVOH (A).

Due to the value of b₁/(b₂+b₃) being 2.0 or more and less than 150.0, neck-in resistance tends to be favorable. On the other hand, 2,4-hexadienal (B2) and 2,4,6-octatrienal (B3) exert an influence on the die buildup, and in particular, the influence of 2,4,6-octatrienal (B3) on the die buildup is large. Thus, due to the value of b₂+2b₃ being 0.65 ppm or less, the die buildup tends to be inhibited. Therefore, the resin composition can be suitably used as a melt molding material. It is to be noted that crotonaldehyde (B1), 2,4-hexadienal (B2), and 2,4,6-octatrienal (B3) may be collectively referred to as “unsaturated aliphatic aldehyde (B)”.

### EVOH (A)

The EVOH (A) is a copolymer having an ethylene unit and a vinyl alcohol unit, wherein the ethylene unit content is 20 mol % or more and 60 mol % or less. The EVOH (A) is typically obtained by saponification of an ethylene-vinyl ester copolymer. The production and saponification of the ethylene-vinyl ester copolymer may be performed by a well-known method. Examples of the vinyl ester include vinyl acetate, vinyl formate, vinyl propionate, vinyl valerate, vinyl caprate, vinyl laurate, vinyl stearate, vinyl pivalate, vinyl versatate, and other aliphatic carboxylic acid vinyl esters, and vinyl acetate is preferred.

The ethylene unit content of the EVOH (A) is 20 mol % or more, and is preferably 25 mol % or more, and more preferably 27 mol % or more. The ethylene unit content of the EVOH (A) is 60 mol % or less, and is preferably 55 mol % or less, and more preferably 50 mol % or less. When the ethylene unit content is less than 20 mol %, thermal stability during melt molding deteriorates, whereby gelation is likely to occur and there is a tendency for streaks, fisheyes, aggregates, and the like to occur. It is to be noted that the occurrence of streaks, fisheyes, aggregates, and the like becomes significant particularly during operations over a long time period at a higher temperature or a higher speed than typical conditions. When the ethylene unit content is more than 60 mol %, the gas barrier properties tend to deteriorate.

A degree of saponification of the EVOH (A) is preferably 90 mol % or more, more preferably 95 mol % or more, and still more preferably 99 mol % or more. When the degree of saponification of the EVOH (A) is 90 mol % or more, the gas barrier properties, thermal stability, moisture resistance, and the like in the resin composition of the present invention, as well as various molded products such as films obtained from the resin composition, tend to be favorable. Furthermore, the degree of saponification may be 100 mol % or less, may be 99.97 mol % or less, or may be 99.94 mol % or less.

Furthermore, the EVOH (A) may, within a range not leading to impairment of the object of the present invention, have other structural unit(s) aside from the ethylene unit, the vinyl alcohol unit, and the vinyl ester unit. In the case in which the EVOH (A) has the other structural unit(s), a content of the other structural unit(s) with respect to total structural units of the EVOH (A) is preferably 30 mol % or less, more preferably 20 mol % or less, still more preferably 10 mol % or less, may be yet more preferably 5 mol % or less, and may be particularly preferably 1 mol % or less. Furthermore, in the case in which the EVOH (A) has the other structural unit(s), the content thereof may be 0.05 mol % or more, or may be 0.1 mol % or more. Examples of the other structural unit(s) include structural units derived from: unsaturated carboxylic acids such as acrylic acid, methacrylic acid, crotonic acid, and itaconic acid, or anhydrides, salts, mono- or dialkyl esters, or the like thereof; nitriles such as acrylonitrile and methacrylonitrile; amides such as acrylamide and methacrylamide; olefin sulfonic acids such as vinyl sulfonic acid, allylsulfonic acid, and methallylsulfonic acid, or salts thereof; vinyl silane compounds such as vinyltrimethoxysilane, vinyltriethoxysilane, vinyl tris(P-methoxy-ethoxy)silane, and γ-methacryloxypropyl methoxysilane; alkyl vinyl ethers; vinyl ketone; N-vinylpyrrolidone; vinyl chloride; vinylidene chloride; and the like.

The other structural unit(s) may be at least one of: a structural unit (I) represented by the following formula (I); a structural unit (II) represented by the following formula (II); and a structural unit (III) represented by the following formula (III).

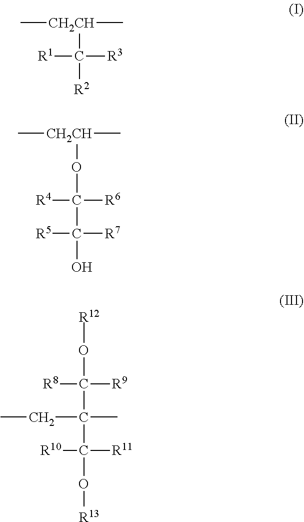

In the above formulae (I), (II), and (III): R¹, R², R³, R⁴, R⁵, R⁶, R⁷, R⁸, R⁹, R¹⁰, and R¹¹ each independently represent a hydrogen atom, a hydroxy group, an aliphatic hydrocarbon group having 1 to 10 carbon atoms, an alicyclic hydrocarbon group having 3 to 10 carbon atoms, or an aromatic hydrocarbon group having 6 to 10 carbon atoms. Furthermore, two selected from R¹, R², and R³; R⁴ and R⁵; and R⁶ and R⁷ may respectively be bonded to form a part of a ring structure. A part or all of hydrogen atoms contained in the aliphatic hydrocarbon group having 1 to 10 carbon atoms, the alicyclic hydrocarbon group having 3 to 10 carbon atoms, and the aromatic hydrocarbon group having 6 to 10 carbon atoms may be substituted with a hydroxy group, an alkoxy group, a carboxy group, or a halogen atom. In the above formula (III), R¹² and R¹³ each independently represent a hydrogen atom, a formyl group, or an alkanoyl group having 2 to 10 carbon atoms.

In the case in which the EVOH (A) has the structural unit (I), (II), or (III), there is a tendency for the flexibility and processability of the resin composition to improve, and for the stretchability, thermoformability, and the like of the various molded products, such as the film and the multilayer structure, to be obtained to become favorable.

In the structural units (I), (II), and (III), the aliphatic hydrocarbon group having 1 to 10 carbon atoms is exemplified by an alkyl group, an alkenyl group, and the like; the alicyclic hydrocarbon group having 3 to 10 carbon atoms is exemplified by a cycloalkyl group, a cycloalkenyl group, and the like; and the aromatic hydrocarbon group having 6 to 10 carbon atoms is exemplified by a phenyl group and the like.

In the structural unit (I), R¹, R², and R³ each independently represent preferably a hydrogen atom, a methyl group, an ethyl group, a hydroxy group, a hydroxymethyl group, or a hydroxyethyl group. Of these, a hydrogen atom, a methyl group, a hydroxy group, or a hydroxymethyl group is preferred in light of enabling further improving the moldability of the resin composition and the stretchability and thermoformability of the various molded products, such as the multilayer structure, to be obtained.

A method of incorporating the structural unit (I) into the EVOH (A) is not particularly limited, and for example, a method of copolymerizing a monomer from which the structural unit (I) is derived in polymerization of the ethylene and the vinyl ester may be exemplified. Examples of the monomer from which the structural unit (I) is derived include alkenes such as propylene, butylene, pentene, and hexene; and alkenes having an ester group or a hydroxy group such as 3-hydroxy-1-propene, 3-acyloxy-1-propene, 3-acyloxy-1-butene, 4-acyloxy-1-butene, 3,4-diacyloxy-1-butene, 3-acyloxy-4-hydroxy-1-butene, 4-acyloxy-3-hydroxy-1-butene, 3-acyloxy-4-methyl-1-butene, 4-acyloxy-2-methyl-1-butene, 4-acyloxy-3-methyl-1-butene, 3,4-diacyloxy-2-methyl-1-butene, 4-hydroxy-1-pentene, 5-hydroxy-1-pentene, 4,5-dihydroxy-1-pentene, 4-acyloxy-1-pentene, 5-acyloxy-1-pentene, 4,5-diacyloxy-1-pentene, 4-hydroxy-3-methyl-1-pentene, 5-hydroxy-3-methyl-1-pentene, 4,5-dihydroxy-3-methyl-1-pentene, 5,6-dihydroxy-1-hexene, 4-hydroxy-1-hexene, 5-hydroxy-1-hexene, 6-hydroxy-1-hexene, 4-acyloxy-1-hexene, 5-acyloxy-1-hexene, 6-acyloxy-1-hexene, and 5,6-diacyloxy-1-hexene. Of these, in light of copolymerization reactivity and the processability and the gas barrier properties of the various molded products to be obtained, propylene, 3-acyloxy-1-propene, 3-acyloxy-1-butene, 4-acyloxy-1-butene, and 3,4-diacyloxy-1-butene are preferred. It is to be noted that as the “acyloxy,” acetoxy is preferred, and more specifically, 3-acetoxy-1-propene, 3-acetoxy-1-butene, 4-acetoxy-1-butene, or 3,4-diacetoxy-1-butene is preferred. In the case of the alkene having an ester, the alkene is derived into the structural unit (I) in the saponification reaction.

In the structural unit (II), R⁴ and R⁵ preferably both represent a hydrogen atom. In particular, it is more preferable that R⁴ and R⁵ both represent a hydrogen atom, and that one of R⁶ and R⁷ represents the aliphatic hydrocarbon group having 1 to 10 carbon atoms, and the other of R⁶ and R⁷ represents a hydrogen atom. This aliphatic hydrocarbon group is preferably an alkyl group or an alkenyl group. In light of particularly emphasizing the gas barrier properties in the various molded products, such as the multilayer structure, to be obtained, it is more preferable that one of R⁶ and R⁷ represents a methyl group or an ethyl group, and the other of R⁶ and R⁷ represents a hydrogen atom. Furthermore, it is still more preferable that one of R⁶ and R⁷ represents a substituent represented by (CH₂)ₕOH (wherein h is an integer of 1 to 8), and the other of R⁶ and R⁷ represents a hydrogen atom. In the substituent represented by (CH₂)ₕOH, h is preferably an integer of 1 to 4, more preferably 1 or 2, and still more preferably 1.

A method of incorporating the structural unit (II) into the EVOH (A) is not particularly limited, and for example, a method of incorporating the structural unit (II) by allowing the EVOH (A) obtained by a saponification reaction to react with a monovalent epoxy compound, or the like may be used. As the monovalent epoxy compound, any one of compounds represented by the following formulae (IV) to (X) may be suitably used.

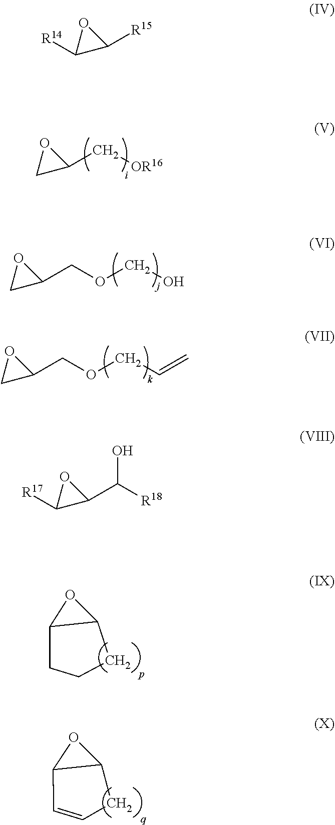

In the above formulae (IV) to (X), R¹⁴, R¹⁵, R¹⁶, R¹⁷, and R¹⁸ each independently represent a hydrogen atom, an aliphatic hydrocarbon group having 1 to 10 carbon atoms (an alkyl group, an alkenyl group, etc.), an alicyclic hydrocarbon group having 3 to 10 carbon atoms (a cycloalkyl group, a cycloalkenyl group, etc.), or an aliphatic hydrocarbon group having 6 to 10 carbon atoms (a phenyl group, etc.). Furthermore, i, j, k, p, and q each independently represent an integer of 1 to 8. However, in the case in which R¹⁷ represents a hydrogen atom, R¹⁸ is a group other than a hydrogen atom.

Examples of the monovalent epoxy compound represented by the above formula (IV) include epoxyethane (ethylene oxide), epoxypropane, 1,2-epoxybutane, 2,3-epoxybutane, 3-methyl-1,2-epoxybutane, 1,2-epoxypentane, 3-methyl-1,2-epoxypentane, 1,2-epoxyhexane, 2,3-epoxyhexane, 3,4-epoxyhexane, 3-methyl-1,2-epoxyhexane, 3-methyl-1,2-epoxyheptane, 4-methyl-1,2-epoxyheptane, 1,2-epoxyoctane, 2,3-epoxyoctane, 1,2-epoxynonane, 2,3-epoxynonane, 1,2-epoxydecane, 1,2-epoxydodecane, epoxyethylbenzene, 1-phenyl-1,2-epoxypropane, 3-phenyl-1,2-epoxypropane, and the like. Examples of the monovalent epoxy compound represented by the above formula (V) include various types of alkyl glycidyl ethers. Examples of the monovalent epoxy compound represented by the above formula (VI) include various types of alkylene glycol monoglycidyl ethers. Examples of the monovalent epoxy compound represented by the above formula (VII) include various types of alkenyl glycidyl ethers. Examples of the monovalent epoxy compound represented by the above formula (VIII) include various types of epoxy alkanols such as glycidol. Examples of the monovalent epoxy compound represented by the above formula (IX) include various types of epoxy cycloalkanes. Examples of the monovalent epoxy compound represented by the above formula (X) include various types of epoxy cycloalkenes.

Among the monovalent epoxy compounds, epoxy compounds having 2 to 8 carbon atoms are preferred. In particular, the monovalent epoxy compound more preferably has 2 to 6 atoms, and still more preferably has 2 to 4 carbon atoms, in light of ease in handling the compound and in light of reactivity. Furthermore, the monovalent epoxy compound is particularly preferably a compound represent by the above formula (IV) or the above formula (V). More specifically, in light of reactivity with the EVOH (A) and processability, gas barrier properties, and the like of the resin composition and the various molded products, such as the film, to be obtained, the monovalent epoxy compound is preferably 1,2-epoxybutane, 2,3-epoxybutane, epoxypropane, epoxyethane, or glycidol, and of these, is more preferably epoxypropane or glycidol.

In the structural unit (III), R⁸, R⁹, R¹⁰, and R¹¹ represent preferably a hydrogen atom or an aliphatic hydrocarbon group having 1 to 5 carbon atoms, and the aliphatic hydrocarbon group is preferably a methyl group, an ethyl group, an n-propyl group, an isopropyl group, an n-butyl group, an isobutyl group, a tert-butyl group, or an n-pentyl group.

A method of incorporating the structural unit (III) into the EVOH (A) is not particularly limited, and for example, a method disclosed in Japanese Unexamined Patent Application, Publication No. 2014-034647 may be exemplified.

The lower limit of a melting point of the EVOH (A) is preferably 140° C., more preferably 150° C., and still more preferably 160° C. On the other hand, the upper limit of the melting point is preferably 220° C., more preferably 210° C., and still more preferably 200° C. When the melting point of the EVOH (A) falls within the above range, the melt moldability tends to improve, and the neck-in and die buildup at the time of melt molding tend to be further inhibited. The melting point of the EVOH can be a value measured by a method described in EXAMPLES.

The EVOH (A) may be used alone of one type, or two or more types thereof may be used together.

The EVOH (A) may contain an EVOH (Aa) and an EVOH (Ab) having different ethylene unit contents. In such a case, the EVOH (A) can be superior in gas barrier properties, thermoformability, and the like. The EVOH (Aa) and the EVOH (Ab) may be two types of EVOHs having different melting points. For example, in the case of measuring the melting point of the resin composition by the method described in EXAMPLES, a peak temperature corresponding to each EVOH may be confirmable. Furthermore, the resin composition may be in a form having a phase separation structure in which one EVOH has the other EVOH dispersed therein, or may be in a form in which the two types of EVOHs are completely admixed together.

The lower limit of the ethylene unit content of the EVOH (Aa) is, for example, 20 mol %, and is preferably 23 mol %, and more preferably 25 mol %. On the other hand, the upper limit of the ethylene unit content of the EVOH (Aa) is, for example, 50 mol %, and is preferably 47 mol %, and may be more preferably 43 mol %, 40 mol %, or 35 mol %. When the ethylene unit content of the EVOH (Aa) is more than or equal to the lower limit, the effects of the thermoformability, flexibility, and the like of the resin composition are sufficiently exhibited. On the other hand, when the ethylene unit content of the EVOH (Aa) is less than or equal to the upper limit, the gas barrier properties of the resin composition can be improved.

A degree of saponification of the EVOH (Aa) is preferably 90 mol % or more, more preferably 95 mol % or more, and still more preferably 99 mol % or more. When the degree of saponification of the EVOH (Aa) is 90 mol % or more, the gas barrier properties, thermal stability, moisture resistance, and the like of the resin composition of the present invention, as well as of various molded products such as the multilayer structure obtained from the resin composition, tend to be favorable. Furthermore, the degree of saponification of the EVOH (Aa) may be 100 mol % or less, may be 99.97 mol % or less, or may be 99.94 mol % or less.

The lower limit of a melting point of the EVOH (Aa) is preferably 150° C., more preferably 160° C., and still more preferably 170° C. On the other hand, the upper limit of the melting point is preferably 220° C., more preferably 210° C., and still more preferably 200° C. When the melting point of the EVOH (Aa) falls within the above range, the melt moldability tends to improve, and the neck-in and die buildup at the time of melt molding tend to be further inhibited.

The lower limit of the ethylene unit content of the EVOH (Ab) is, for example, 30 mol %, preferably 34 mol %, and more preferably 38 mol %. On the other hand, the upper limit of the ethylene unit content of the EVOH (Ab) is, for example, 60 mol %, preferably 55 mol %, and more preferably 52 mol %. When the ethylene unit content of the EVOH (Ab) is more than or equal to the lower limit, the effects of the thermoformability, flexibility, and the like of the resin composition are sufficiently exhibited. On the other hand, when the ethylene unit content of the EVOH (Ab) is less than or equal to the upper limit, the gas barrier properties of the resin composition can be improved.

A suitable degree of saponification of the EVOH (Ab) can be set similarly to that of the EVOH (Aa).

The lower limit of a melting point of the EVOH (Ab) is preferably 90° C., more preferably 100° C., and may be still more preferably 110° C., 120° C., 130° C., 140° C., or 150° C. On the other hand, the upper limit of the melting point is preferably 220° C., more preferably 210° C., still more preferably 200° C., and may be yet more preferably 190° C., 180° C., or 170° C. When the melting point of the EVOH (Ab) falls within the above range, the melt moldability tends to improve, and the neck-in and die buildup at the time of melt molding tend to be further inhibited.

The lower limit of a difference (Ab−Aa) between the ethylene unit content of the EVOH (Ab) and the ethylene unit content of the EVOH (Aa), in other words, the lower limit of a value obtained by subtracting the ethylene unit content of the EVOH (Aa) from the ethylene unit content of the EVOH (Ab), is, for example, 4.5 mol %, and is preferably 8 mol %, more preferably 12 mol %, and still more preferably 15 mol %. Furthermore, the upper limit of the difference (Ab−Aa) between the ethylene unit contents is preferably 40 mol %, more preferably 30 mol %, and still more preferably 20 mol %. When the difference between the ethylene unit contents of the EVOH (Ab) and the EVOH (Aa) is more than or equal to the lower limit, the thermoformability, heat stretching properties, and the like of the resin composition can be improved. Conversely, when the difference between the ethylene unit contents is less than or equal to the upper limit, the gas barrier properties of the resin composition can be further improved, and the like.

The lower limit of a mass ratio (Aa/Ab) of the EVOH (Aa) to the EVOH (Ab), in other words, the lower limit of a mass ratio of the content of the EVOH (Aa) to the content of the EVOH (Ab), is, for example, 60/40, and is preferably 62/38, and may be more preferably 65/35, 68/32, 70/30, or 75/25. The upper limit of the mass ratio is, for example, 95/5, and is preferably 93/7, more preferably 92/8, still more preferably 91/9, and may be yet more preferably 85/15. When the mass ratio falls within the above range, the resin composition may be superior in thermoformability, flexibility, and the like, while maintaining the gas barrier properties with respect to various gases. For example, when the mass ratio (Aa/Ab) is more than or equal to the lower limit, the gas barrier properties, oil resistance, and the like of the resin composition may be improved. On the other hand, when the mass ratio (Aa/Ab) is less than or equal to the upper limit, the thermoformability, flexibility, and the like of the resin composition may be improved.

The lower limit of a difference (Aa−Ab) between a melting point of the EVOH (Aa) and a melting point of the EVOH (Ab), in other words, the lower limit of a value obtained by subtracting the melting point of the EVOH (Ab) from the melting point of the EVOH (Aa), may be, for example, 5° C., and is preferably 8° C. When this melting point difference is 8° C. or more, the thermoformability and the like may improve, and for example, when obtaining a thermoformed container from the resin composition, the appearance of a bottom thereof may be favorable. The lower limit of the melting point difference is more preferably 12° C., still more preferably 16° C., yet more preferably 20° C., and even more preferably 24° C. The melting point difference may further be 30° C., 40° C., 50° C., or 60° C. The upper limit of the difference between the melting point of the EVOH (Aa) and the EVOH (Ab) may be, for example, 100° C., and is preferably 90° C., and may be more preferably 80° C., 70° C., 60° C., 50° C., 40° C., or 30° C. When the melting point difference is more than or equal to the lower limit, the thermoformability, heat stretching properties, and the like of the resin composition may be improved. Conversely, when the melting point difference is less than or equal to the upper limit, gas barrier properties and an effect of inhibiting flow marks during a long-run operation (continuous operation over a long time period) using the resin composition can be improved.

Furthermore, the EVOH (Aa) and the EVOH (Ab) may, within a range not leading to impairment of the object of the present invention, have other structural unit(s) aside from the ethylene unit, the vinyl alcohol unit, and the vinyl ester unit. In the case in which the EVOH (Aa) or the EVOH (Ab) has the other structural unit(s), a content of the other structural unit(s) with respect to total structural units of the EVOH (A) or the EVOH (Ab) is preferably 30 mol % or less, more preferably 20 mol % or less, still more preferably 10 mol % or less, yet more preferably 5 mol % or less, and may be even more preferably 1 mol % or less. Furthermore, in the case in which the EVOH (Aa) or the EVOH (Ab) has the other structural unit(s), a content thereof may be 0.05 mol % or more, or may be 0.10 mol % or more. Examples of the other structural unit(s) include structural units exemplified as the other structural unit(s) which may be contained in the EVOH (A), and the like.

In light of improving thermoformability, flexibility, and the like of the resin composition, the EVOH (Ab) preferably has at least one structural unit (x) selected from the group consisting of the structural unit represented by the above formula (I), the structural unit represented by the above formula (II), and the structural unit represented by the above formula (III). The structural unit (x) is preferably at least one selected from the group consisting of the structural unit represented by the above formula (I) and the structural unit represented by the above formula (II).

In the case in which the EVOH (Ab) contains the structural unit (x), the lower limit of a percentage content of the structural unit (x) with respect to total vinyl alcohol structural units in the EVOH (Ab) is preferably 0.3 mol %, more preferably 1 mol %, and still more preferably 3 mol %. When the percentage content of the structural unit (x) is more than or equal to the lower limit, the thermoformability, flexibility, and the like of the resin composition may be sufficiently improved. On the other hand, the upper limit of the percentage content is preferably 40 mol %, more preferably 30 mol %, and still more preferably 20 mol %. When the percentage content of the structural unit (x) is less than or equal to the upper limit, the gas barrier properties and the like may be improved.

It is to be noted that the EVOH (A) aside from the EVOH (Ab), such as the EVOH (Aa), may have the structural unit (x).

The lower limit of a total content of the EVOH (Aa) and the EVOH (Ab) of the resin composition is preferably 80% by mass, more preferably 90% by mass, still more preferably 95% by mass, and may be particularly preferably 99.9% by mass. The EVOH (A) may be constituted from only the EVOH (Aa) and the EVOH (Ab), or may further contain other EVOH(s). The lower limit of a total content of the EVOH (Aa) and the EVOH (Ab) in the EVOH (A) is preferably 80% by mass, more preferably 90% by mass, still more preferably 95% by mass, and may be particularly preferably 99.9% by mass.

In light of gas barrier properties and the like, a content of the EVOH (A) in the resin composition of the present invention is preferably 70% by mass or more, more preferably 80% by mass or more, and particularly preferably 90% by mass or more, and may be 95% by mass or more, 99% by mass or more, or 99.9% by mass or more. The resin constituting the resin composition may be constituted from only the EVOH (A). On the other hand, the content of the EVOH (A) in the resin composition may be, for example, 99.9% by mass or less, or may be 99% by mass or less.

Unsaturated Aliphatic Aldehyde (B) The resin composition of the present invention contains crotonaldehyde (B1), and further contains at least one selected from the group consisting of 2,4-hexadienal (B2) and 2,4,6-octatrienal (B3).

The lower limit of a content b₁ of crotonaldehyde (B1) with respect to the EVOH (A) in the resin composition is preferably 0.01 ppm, more preferably 0.20 ppm, still more preferably 0.40 ppm, and may be yet more preferably 0.70 ppm or 1.20 ppm. On the other hand, the upper limit of the content b₁ is preferably 4.0 ppm, more preferably 3.5 ppm, still more preferably 2.7 ppm, and may be yet more preferably 2.0 ppm or 1.5 ppm. When the content b₁ falls within the above range, the values of (b₁/(b₂+b₃)), (b₁+b₂+2b₃), and (b₂₊₂b₃), described later, can be easily adjusted to fall within suitable ranges. Furthermore, when the content b₁ falls within the above range, there is a tendency to enable inhibiting coloring.

When, as one embodiment, the resin composition contains 2,4-hexadienal (B2) in a certain proportion with respect to crotonaldehyde (B1), the resin composition tends to be superior in neck-in resistance while allowing for inhibition of die buildup. The lower limit of a content (b₂) of 2,4-hexadienal (B2) with respect to the EVOH (A) is preferably 0.005 ppm, more preferably 0.01 ppm, and still more preferably 0.02 ppm. On the other hand, the upper limit of the content b₂ is preferably 0.65 ppm, more preferably 0.20 ppm, still more preferably 0.10 ppm, yet more preferably 0.08 ppm, and particularly preferably 0.06 ppm. When the content b₂ falls within the above range, the values of (b₁/(b₂+b₃)), (b₁+b₂+2b₃), and (b₂₊₂b₃), described later, can be easily adjusted to fall within suitable ranges. Furthermore, when the content b₂ falls within the above range, there is a tendency to enable inhibiting coloring.

When, as one embodiment, the resin composition contains 2,4,6-octatrienal (B3) in a certain proportion with respect to crotonaldehyde (B1), the resin composition tends to be superior in neck-in resistance while inhibiting die buildup. In comparison to 2,4-hexadienal (B2), 2,4,6-octatrienal (B3) has a larger influence on die buildup with respect to an amount of addition thereof. Accordingly, in light of improving neck-in resistance while inhibiting die buildup, the resin composition preferably contains 2,4-hexadienal (B2) rather than 2,4,6-octatrienal (B3). The lower limit of a content (b₃) of 2,4,6-octatrienal (B3) with respect to the EVOH (A) is preferably 0.325 ppm, more preferably 0.23 ppm, still more preferably 0.07 ppm, and particularly preferably 0.04 ppm. The lower limit of the content b₃ may be 0 ppm, or may be 0.005 ppm. When the content b₃ falls within the above range, the values of (bi/(b₂+b₃)), (b₁+b₂+b₃), and (b₂+2b₃), described later, can be easily adjusted to fall within suitable ranges. Furthermore, when the content b₃ falls within the above range, there is a tendency to enable inhibiting coloring.

Due, in the resin composition, to the value of a ratio (b₁/(b₂+b₃)) of the content bi (ppm) of crotonaldehyde (B1) to a sum of the content b₂ (ppm) of 2,4-hexadienal (B2) and the content b₃ (ppm) of 2,4,6-octatrienal (B3) being 2.0 or more and less than 150.0, the resin composition is superior in neck-in resistance. Such neck-in resistance is an effect not seen in a case of using a compound of any of the unsaturated aliphatic aldehydes (B) alone, and is only demonstrated when (b₁/(b₂+b₃)) falls within a certain range. The lower limit of (bi/(b₂+b₃)) is preferably 4.0, and more preferably 8.0. On the other hand, the upper limit of (b₁/(b₂+b₃)) is preferably 60.0, more preferably 25.0, and still more preferably 13.0. When (b₁/(b₂+b₃)) falls within the above range, the neck-in can be more sufficiently inhibited.

The upper limit of a sum (b₂+2b₃) of the content b₂ (ppm) of 2,4-hexadienal (B2) and 2 times the content b₃ (ppm) of 2,4,6-octatrienal (B3) is 0.65 ppm, and is preferably 0.50 ppm, more preferably 0.30 ppm, and still more preferably 0.10 ppm. When (b₂+2b₃) is more than the upper limit, inhibition of the occurrence of die buildup may fail. (b₂+2b₃) may be 0.005 ppm or more, or may be 0.01 ppm or more.

In the resin composition, the upper limit of a sum (b₁+b₂+b₃) of the contents of crotonaldehyde (B1), 2,4-hexadienal (B2), and 2,4,6-octatrienal (B3) with respect to the EVOH (A) is preferably 7.0 ppm, more preferably 4.0 ppm, still more preferably 3.5 ppm, yet more preferably 3.0 ppm, even more preferably 1.5 ppm, and may be particularly preferably 1.0 ppm. When (b₁+b₂+b₃) is less than or equal to the upper limit, coloring of the resin composition can be sufficiently inhibited. On the other hand, the lower limit of (b₁+b₂+b₃) is preferably 0.01 ppm, more preferably 0.10 ppm, and may be still more preferably 0.30 ppm or 0.50 ppm.

### Conjugated Polyene Compound (C)

The resin composition of the present invention preferably further contains the conjugated polyene compound (C). The conjugated polyene compound (C) enables inhibiting hue deterioration due to oxidative degradation of the EVOH (A) at the time of melt molding. The conjugated polyene compound (C) as referred to herein means a compound having a conjugated double bond, as generally referred to, i.e., a compound: having a structure formed by alternately linking a carbon-carbon double bond and a carbon-carbon single bond; and having 2 or more carbon-carbon double bonds. However, 2,4-hexadienal (B2) and 2,4,6-octatrienal (B3) are not regarded as falling under the conjugated polyene compound (C). The conjugated polyene compound (C) may be a conjugated diene having two conjugated double bonds, a conjugated triene having three conjugated double bonds, or a conjugated polyene having more than 3 conjugated double bonds. In addition, the conjugated double bond structure may be present in a multiple number in a single molecule without the conjugated double bonds being conjugated with each other. For example, compounds having three conjugated triene structures in the same molecule, such as tong oil, may be also be encompassed in the conjugated polyene compound (C). The upper limit of the number of conjugated double bonds in the conjugated polyene compound (C) is preferably 7. In the case of containing the conjugated polyene compound (C) having 8 or more conjugated double bonds, the probability of coloring of pellets and therefore the molded product increases.

The conjugated polyene compound (C) may have, in addition to the conjugated double bond, another functional group such as a carboxy group and a salt thereof, a hydroxy group, an ester group, an ether group, an amino group, an imino group, an amide group, a cyano group, a diazo group, a nitro group, a sulfone group and a salt thereof, a sulfonyl group, a sulfoxide group, a sulfide group, a thiol group, a phosphoric acid group and a salt thereof, a phenyl group, a halogen atom, a double bond, and a triple bond.

The lower limit of the number of carbon atoms in the conjugated polyene compound (C) is preferably 4. Furthermore, the upper limit of the number of carbon atoms in the conjugated polyene compound (C) is preferably 30, and more preferably 10.

Examples of the conjugated polyene compound (C) include:
conjugated diene compounds such as isoprene, 2,3-dimethyl-1,3-butadiene, 2,3-diethyl-1,3-butadiene, 2-t-butyl-1,3-butadiene, 1,3-pentadiene, 2,3-dimethyl-1,3-pentadiene, 2,4-dimethyl-1,3-pentadiene, 3,4-dimethyl-1,3-pentadiene, 3-ethyl-1,3-pentadiene, 2-methyl-1,3-pentadiene, 3-methyl-1,3-pentadiene, 4-methyl-1,3-pentadiene, 1,3-hexadiene, 2,4-hexadiene, 2,5-dimethyl-2,4-hexadiene, 1,3-octadiene, 1,3-cyclopentadiene, 1,3-cyclohexadiene, 1-phenyl-1,3-butadiene, 1,4-diphenyl-1,3-butadiene, 1-methoxy-1,3-butadiene, 2-methoxy-1,3-butadiene, 1-ethoxy-1,3-butadiene, 2-ethoxy-1,3-butadiene, 2-nitro-1,3-butadiene, chloroprene, 1-chloro-1,3-butadiene, 1-bromo-1,3-butadiene, 2-bromo-1,3-butadiene, ocimene, phellandrene, myrcene, famesene, sorbic acid, sorbic acid esters, and sorbic acid salts;
conjugated triene compounds such as 1,3,5-hexatriene, 2,4,6-octatriene-1-carboxylic acid, eleostearic acid, tung oil, cholecalciferol, fulvene, and tropone;
cyclooctatetraene, 2,4,6,8-decatetraene-1-carboxylic acid, retinol, and retinoic acid; and the like.

As the conjugated polyene compound (C), sorbic acid, a sorbic acid ester, a sorbic acid salt, myrcene, or a mixture of 2 or more of these is preferred, and sorbic acid, a sorbic acid salt (sodium sorbate, potassium sorbate, etc.), or a mixture of these is more preferred. Sorbic acid, a sorbic acid salt, or a mixture of these is preferred in light of hygiene and availability due to having a superior effect of inhibiting oxidative degradation at high temperatures, and being widely industrially used as food additives as well.

A molecular weight of the conjugated polyene compound (C) is typically 1,000 or less, preferably 500 or less, and more preferably 300 or less. When the molecular weight of the conjugated polyene compound (C) is less than or equal to the upper limit, a state of dispersion of the conjugated polyene compound (C) into the resin composition tends to become favorable, whereby the appearance after melt molding tends to improve. The lower limit of the molecular weight of the conjugated polyene compound (C) is, for example, 54, and may be 60, or may be 80.

The lower limit of a content c of the conjugated polyene compound (C) with respect to the EVOH (A) in the resin composition is preferably 1 ppm, and more preferably 3 ppm. Furthermore, the content c of the conjugated polyene compound (C) with respect to the EVOH (A) in the resin composition is preferably less than 300 ppm, more preferably 100 ppm or less, still more preferably 70 ppm or less, yet more preferably 30 ppm or less, and may be particularly preferably 20 ppm or less or 10 ppm or less. When the content c of the conjugated polyene compound (C) falls within the above range, there is a tendency to further enable inhibiting hue deterioration at the time of melt molding.

### Inorganic Particles (D)

The resin composition of the present invention may further contain inorganic particles (D). In the case in which the resin composition contains the inorganic particles (D), at a time of forming an inorganic vapor deposition layer on a surface of the film containing the layer formed from the resin composition, there is a tendency to enable inhibiting vapor deposition flaws and improving adhesion strength to the inorganic vapor deposition layer. Furthermore, breakage resistance and the like of the film containing the layer formed from the resin composition tend to be favorable. As referred to herein, the term “inorganic particles” mean particles containing an inorganic substance as a principal component. The “principal component” as referred to herein means the component having the highest content, and for example, is a component having a content of 50% by mass or more.

The inorganic substance constituting the inorganic particles (D) is preferably an inorganic substance containing at least one type of element selected from the group consisting of silicon, aluminum, magnesium, zirconium, cerium, tungsten, and molybdenum. Of these, in light of availability, the inorganic substance is more preferably an inorganic substance containing at least one type of element selected from the group consisting of silicon, aluminum, and magnesium. Examples of the inorganic substance include oxides, nitrides, oxynitrides, and the like of the exemplified elements, and an oxide is preferred. The inorganic particles (D) may contain one, or two or more types of particles. Furthermore, one particle may be formed from one, or two or more types of inorganic substances.

The lower limit of an average particle diameter of the inorganic particles (D) is preferably 0.5 μm, more preferably 1.5 μm, and still more preferably 2.0 μm. The upper limit of the average particle diameter of the inorganic particles (D) is preferably 10 μm, more preferably 8 μm, and still more preferably 5 μm. When the average particle diameter of the inorganic particles (D) falls within the above range, improving the breakage resistance, the vapor deposition flaw-inhibiting property, the adhesion strength to the inorganic vapor deposition layer, and the like of the film and/or the like to be obtained may be enabled. In particular, in the case in which the average particle diameter of the inorganic particles (D) is more than or equal to the lower limit, the adhesion strength to the inorganic vapor deposition layer tends to improve.

The lower limit of a content d of the inorganic particles (D) with respect to the EVOH (A) is, for example, 50 ppm, and is preferably 100 ppm, and more preferably 150 ppm. The upper limit of the content d of the inorganic particles (D) is, for example, 5,000 ppm, and is preferably 4,000 ppm, more preferably 3,000 ppm, and may be still more preferably 2,000 ppm or 1,000 ppm. When the content d of the inorganic particles (D) falls within the above range, improving the breakage resistance, the vapor deposition flaw-inhibiting property, the adhesion strength to the vapor deposition layer, and the like of the film and/or the like to be obtained may be enabled. In particular, in the case in which the content d of the inorganic particles (D) is more than or equal to the lower limit, the adhesion strength to the inorganic vapor deposition layer tends to improve.

### Nonionic Surfactant (E)

The resin composition of the present invention may further contain a nonionic surfactant (E). In the case in which the resin composition contains the nonionic surfactant (E), a discharge amount of the resin at the time of melt molding can be increased, and productivity tends to increase. Furthermore, when the resin composition contains the nonionic surfactant (E) at a certain amount, there is a tendency to inhibit coloring of the molded product to be obtained.

A content e of the nonionic surfactant (E) with respect to the EVOH (A) in the resin composition is preferably 0.1 ppm or more and 1,000 ppm or less. When the content e of the nonionic surfactant (E) is 0.1 ppm or more, the effect of the discharge amount of the resin composition increasing, and the effect of inhibiting coloring may be sufficiently demonstrated. The content e is preferably 0.5 ppm or more, and more preferably 1 ppm or more. On the other hand, when the content e is 1,000 ppm or less, there is a tendency to inhibit a phenomenon in which the resin slips, resulting in supply of the resin into an extruder becoming insufficient and the discharge amount of the resin composition decreasing. Furthermore, when the content e is 1,000 ppm or less, interlayer adhesiveness of a laminate obtained tends to improve. The content e is preferably 500 ppm or less, more preferably 300 ppm or less, still more preferably 200 ppm or less, and particularly preferably 150 ppm or less.

The nonionic surfactant (E) is not particularly limited, and is preferably at least one selected from the group consisting of an ether type, an aminoether type, an ester type, an ester/ether type, and an amide type. These nonionic surfactants (E) may be used alone, or in a combination of two or more types.

### Ether-Type Nonionic Surfactant

The ether-type nonionic surfactant is preferably a polyoxyalkylene alkyl ether, a polyoxyalkylene alkenyl ether, or a polyoxyethylene styrenated phenyl ether.

The polyoxyalkylene alkyl ether and the polyoxyalkylene alkenyl ether are preferably represented by the following formula (i).

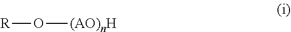

In the formula (i), R represents a linear or branched alkyl group or an alkenyl group having 6 to 22 carbon atoms; each A independently represents an alklyene group having 2 to 4 carbon atoms; and n represents a degree of condensation of a polyoxyalkylene unit, being 1 to 30.

In the formula (i), the number of carbon atoms in R is preferably 8 to 18, and more preferably 12 or more; the number of carbon atoms in A is preferably 2 or 3; and n is preferably 2 to 25, more preferably 3 to 20, and still more preferably 4 or more.

Specific examples of the polyoxyalkylene alkyl ether include polyoxyethylene alkyl ethers such as polyoxyethylene hexyl ether, polyoxyethylene heptyl ether, polyoxyethylene octyl ether, polyoxyethylene-2-ethylhexyl ether, polyoxyethylene nonyl ether, polyoxyethylene decyl ether, polyoxyethylene lauryl ether, polyoxyethylene tetradecyl ether, polyoxyethylene cetyl ether, polyoxyethylene stearyl ether, and polyoxyethylene icosyl ether; polyoxypropylene alkyl ethers such as polyoxypropylene stearyl ether; polyoxyethylenepolyoxy propylenealkyl ether; and the like.

Specific examples of the polyoxyalkylene alkenyl ether include polyoxyethylene alkenyl ethers such as polyoxyethylene oleyl ether.

Specific examples of the polyoxyethylene styrenated phenyl ether include polyoxyethylene monostyrenated phenyl ether, polyoxyethylene distyrenated phenyl ether, and polyoxyethylene tristyrenated phenyl ether. The ethylene oxide adduct number of the polyoxyethylene styrenated phenyl ether is suitably 5 to 30 moles.

### Aminoether-Type Nonionic Surfactant

The aminoether-type nonionic surfactant is preferably a polyoxyalkylene alkylamine, a polyoxyalkylene alkenylamine, or the like. The polyoxyalkylene alkylamine is suitably an cocoalkylamine-ethylene oxide adduct, polyoxyethylene stearylamine, polyoxyethylene laurylamine, polyoxyethylene-polyoxypropylene-laurylamine, polyoxyethylene stearylamine, or the like. The polyoxyalkylene alkenylamine is suitably polyoxyethylene oleylamine or the like. The ethylene oxide adduct number of the polyoxyalkylene alkylamine is preferably 1 to 40 moles.

### Ester-Type Nonionic Surfactant

The ester-type nonionic surfactant is suitably a polyoxyalkylene alkyl ester, a polyoxyalkylene alkenyl ester, a sorbitan alkyl ester, a sorbitan alkenyl ester, a polyoxyethylenesorbitan alkyl ester, a polyoxyethylenesorbitan alkylene ester, a glycerol alkyl ester, a glycerol alkenyl ester, a polyglycerol alkyl ester, a polyglycerol alkenyl ester, or the like.

The polyoxyalkylene alkyl ester and the polyoxyalkylene alkenyl ester are preferably represented by the following formula (ii):

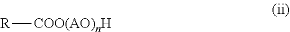

In the formula (ii), R, A, and n are as defined in the above formula (i). In the formula (ii), the number of carbon atoms in R is preferably 8 to 18, the number of carbon atoms in A is preferably 2 or 3, and n is preferably 7 to 14. When n falls within the above range, a balance can be achieved between a favorable discharge amount and appearance.

Examples of the polyoxyalkylene alkyl ester include polyoxyethylene monolaurate, polyoxyethylene dilaurate, polyoxyethylene monopalmitate, polyoxyethylene monostearate, polyoxyethylene distearate, and the like.

Examples of the polyoxyalkylene alkenyl ester include polyoxyethylene oleate, polyethyleneglycol dioleate, and the like.

Examples of the sorbitan alkyl ester include sorbitan monocaprylate, sorbitan monolaurate, sorbitan monopalmitate, sorbitan monostearate, sorbitan distearate, sorbitan tristearate, sorbitan monolaurate, and the like.

Examples of the sorbitan alkenyl ester include sorbitan monooleate, sorbitan trioleate, sorbitan sesquioleate, and the like.

Examples of the polyoxyethylenesorbitan alkyl ester include polyoxyethylene sorbitan monolaurate, polyoxyethylene sorbitan monopalmitate, polyoxyethylene sorbitan monostearate, polyoxyethylene sorbitan tristearate, polyoxyethylene sorbitan triisostearate, polyoxyethylene sorbitan monolaurate, and the like.

Examples of the polyoxyethylene sorbitan alkenyl ester include polyoxyethylene sorbitan monooleate, polyoxyethylene sorbitan trioleate, and the like.

Examples of the glycerol alkyl ester include glycerol monostearate, glycerol monomyristate, and the like.

Examples of the glycerol alkenyl ester include glycerol monooleate and the like.

Examples of the polyglycerol alkyl ester include diglycerol laurate, tetraglycerol stearate, polyglycerol laurate, polyglycerol stearate, and the like.

Examples of the polyglycerol alkenyl ester include polyglycerol oleate and the like.

### Ester/Ether-Type Nonionic Surfactant

The ester/ether-type nonionic surfactant is exemplified by a polyoxyethylene sorbitan alkyl ester, a polyoxyethylene sorbitan alkenyl ester, and the like.

### Amide-Type Nonionic Surfactant

The amide-type nonionic surfactant is preferably a higher fatty acid amide, and more preferably a higher fatty acid alkanolamide. It is to be noted that “higher fatty acid” means, for example, an acid having 6 or more carbon atoms. The number of carbon atoms in the higher fatty acid may be 10 or more, or may be 12 or more.

The higher fatty acid alkanolamide is exemplified by a higher fatty acid mono- or di-alkanolamide, and specific examples thereof include caproic acid mono- or di-ethanolamide, caprylic acid mono- or di-ethanolamide, capric acid mono- or di-ethanolamide, lauric acid mono- or di-ethanolamide, palmitic acid mono- or di-ethanolamide, stearic acid mono- or di-ethanolamide, oleic acid mono- or di-ethanolamide, coconut oil fatty acid mono- or di-ethanolamide, higher fatty acid alkanolamides in which the ethanolamide constituting these is substituted with propanolamide or butanolamide, and the like.

Examples of the higher fatty acid amide other than the higher fatty acid alkanolamide include caproic acid amide, caprylic acid amide, capric acid amide, lauric acid amide, palmitic acid amide, stearic acid amide, oleic acid amide, and the like.

The nonionic surfactant (E) is more suitably at least one selected from the group consisting of the polyoxyalkylene alkyl ether, the polyoxyalkylene alkenyl ether, the polyoxyethylene styrenated phenyl ether, the polyoxyalkylene alkylamine, the polyoxyalkylene alkenylamine, the polyoxyalkylene alkyl ester, the polyoxyalkylene alkenyl ester, the sorbitan alkyl ester, the sorbitan alkenyl ester, the polyoxyethylene sorbitan alkyl ester, the polyoxyethylene sorbitan alkenyl ester, the glycerol alkyl ester, the glycerol alkenyl ester, the polyglycerol alkyl ester, the polyglycerol alkenyl ester, and the higher fatty acid amide.

Particularly in light of, e.g., a sufficient increase in the discharge amount and obtaining a molded product in which the coloring is inhibited, the nonionic surfactant (E) is particularly the ether type, the aminoether type, or the ester type, more preferably the ether type or the aminoether type, and still more preferably the ether type. In the case of using the ether-type nonionic surfactant (E), the coloring tends to be further inhibited.

### Antioxidant (F)

The resin composition of the present invention may further contain the antioxidant (F). In the case in which the resin composition further contains the antioxidant, oxidative degradation resistance of the molded product, such as a pipe, formed from the resin composition may be improved, whereby generation of cracks in, e.g., a case of using the molded product over a long time period at a high temperature can be inhibited.

The antioxidant (F) is a compound having an oxidation-preventing function. A melting point of the antioxidant (F) is not necessarily limited, but is preferably 170° C. or lower. In the case in which the melting point of the antioxidant (F) is 170° C. or lower, in producing a resin composition by melt mixing, melting in an extruder is easier. Thus, the antioxidant (F) is localized in the resin composition, whereby a highly concentrated part becoming colored can be inhibited. Furthermore, the melting point of the antioxidant (F) is preferably 50° C. or higher, and may be more preferably 100° C. or higher. In the case in which the melting point of the antioxidant (F) is 50° C. or higher, the antioxidant bleeding out to a surface of the molded product (the pipe, etc.) obtained, whereby the appearance deteriorates, can be inhibited.

A molecular weight of the antioxidant (F) is preferably 300 or more. In the case in which the molecular weight of the antioxidant (F) is 300 or more, when the molded product has been obtained from the resin composition, the antioxidant bleeding out to the surface and deteriorating the appearance can be inhibited, and furthermore, the thermal stability of the resin composition is improved. The molecular weight is more preferably 400 or more, and particularly preferably 500 or more. On the other hand, the upper limit of the molecular weight of the antioxidant (F) is not particularly limited, and in light of dispersibility, is preferably 8,000 or less, more preferably 6,000 or less, still more preferably 4,000 or less, and particularly preferably 2,000 or less.

A compound having a hindered phenol group is suitably used as the antioxidant (F). While on one hand the compound having a hindered phenol group has excellent thermal stability itself, it also has the ability to capture the oxygen radical that is the cause of oxidation degradation, and when blended with the resin composition as an antioxidant, the compound exhibits a superior effect of preventing oxidative degradation.

Commercially available products, for example those described below, can be used as the compound having a hindered phenol group.
(1) “IRGANOX 1010,” manufactured by BASF: Pentaerythritol tetrakis[3-(3,5-di-tert-butyl-4-hydroxyphenyl)propionate] with a melting point in the range of 110 to 125° C. and a molecular weight of 1,178
(2) “IRGANOX 1076,” manufactured by BASF: Octadecyl-3-(3,5-di-tert-butyl-4-hydroxyphenyl)-propionate with a melting point in a range of 50 to 55° C. and a molecular weight of 531
(3) “IRGANOX 1098,” manufactured by BASF: N, N′-hexane-1,6-diylbis[3-(3,5-di-tert-butyl-4-hydroxyphenyl)propionamide)] with a melting point in a range of 156 to 161° C. and a molecular weight of 637
(4) “IRGANOX 245,” manufactured by BASF: Triethylene glycol-bis[3-(3-tert-butyl-5-methyl-4-hydroxyphenyl)propionate] with a melting point in a range of 76 to 79° C. and a molecular weight of 587
(5) “IRGANOX 259,” manufactured by BASF: 1,6-hexanediol-bis[3-(3,5-di-tert-butyl-4-hydroxyphenyl)propionate] with a melting point in a range of 104 to 108° C. and a molecular weight of 639
(6) “Sumilizer MDP-s,” manufactured by Sumitomo Chemical Co., Ltd.: 2,2′-methylene-bis(4-methyl-6-tert-butylphenol) with a melting point of about 128° C. and a molecular weight of 341
(7) “Sumilizer GM,” manufactured by Sumitomo Chemical Co., Ltd.: 2-tert-butyl-6-(3-tert-butyl-2-hydroxy-5-methylbenzyl)-4-methylphenyl acrylate with a melting point of about 128° C. and a molecular weight of 395
(8) “Sumilizer GA-80,” manufactured by Sumitomo Chemical Co., Ltd.: 3,9-bis[2-{3-(3-tert-butyl-4-hydroxy-5-methylphenyl)propionyloxy}-1,1-dimethylethyl]-2,4,8,10-tetraoxaspiro[5,5]undecane with a melting point of about 110° C. and a molecular weight of 741

A compound having a hindered amine group may also be suitably used as the antioxidant (F). When a compound having a hindered amine group is blended with the resin composition as the antioxidant (F), the compound does not just prevent thermal degradation of the EVOH (A), but also exhibits the effect of capturing the aldehyde generated as a result of thermal decomposition of the EVOH (A), and can inhibit generation of a void or air bubble during molding by reducing generation of decomposition gases. Furthermore, when the resin composition is used as a food packaging container, spoiling of the taste of the content due to the smell of the aldehyde is addressed due to the capture of the aldehyde.

A piperidine derivative is preferred as the compound having a hindered amine group, and in particular, a 2,2,6,6-tetraalkylpiperidine derivative having a substituent group at the fourth position is preferable. A carboxy group, an alkoxy group, or an alkylamino group can be used as the substituent at the fourth position.

Furthermore, an alkyl group may be substituted at an N-position of the hindered amine group, but the use of the compound having a hindered amine group having a hydrogen atom bonding is preferred due to being superior in a thermal stability effect.

Commercially available products, for example those described below, can be used as the compound having a hindered amine group.
(9) “TINUVIN 770,” manufactured by BASF: Bis(2,2,6,6-tetramethyl-4-piperidyl) sebacate with a melting point in a range of 81 to 85° C. and a molecular weight of 481
(10) “TINUVIN 765,” manufactured by BASF: Bis(1,2,2,6,6-pentamethyl-4-piperidyl) sebacate, which is a liquid compound with a molecular weight of 509, and 1,2,2,6,6-pentamethyl-4-piperidyl sebacate (mixture)
(11) “TINUVIN 622LD,” manufactured by BASF: Polycondensate of dimethyl succinate and 1-(2-hydroxyethyl)-4-hydroxy-2,2,6,6-tetramethylpiperidine with a melting point in a range of 55 to 70° C. and a molecular weight of 3,100 to 4,000
(12) “CHIMASSORB 119FL,” manufactured by BASF: Condensate of N,N′-bis(3-aminopropyl)ethylenediamine and 2,4-bis[N-butyl-N-(1,2,2,6,6-pentamethyl-4-piperidyl)amino]-6-chloro-1,3,5-triazine with a melting point in a range of 130 to 140° C. and a molecular weight of 2,000 or more
(13) “CHIMASSORB 944LD,” manufactured by BASF: poly[[6-(1,1,3,3-tetramethylbutyl)amino-1,3,5-triazin-2,4-diyl](2,2,6,6-tetramethyl-4-piperidyl)imino]hexamethylene(2,2,6,6-tetramethyl-4-piperidyl)imino]] with a melting point in a range of 100 to 135° C. and a molecular weight between 2,000 and 3,100
(14) “TINUVIN 144,” manufactured by BASF: Bis(1,2,2,6,6-pentamethyl-4-piperidyl)[[3,5-bis(1,1-dimethylethyl)-4-hydroxyphenyl]methyl]butyl malonate with a melting point in a range of 146 to 150° C. and a molecular weight of 685
(15) “UVINUL 4050H,” manufactured by BASF: N, N′-1,6-hexanediylbis{N-(2,2,6,6-tetramethyl-4-piperidinyl)formamide with a melting point of 157° C. and a molecular weight of 450
(16) “UVINUL 5050H,” manufactured by BASF: Compound having the following structure with a melting point in a range of 104 to 112° C. and a molecular weight of about 3,500

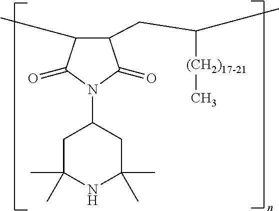

These compounds having a hindered phenol group or a hindered amine group may be used either alone, or by combining two or more types.

The lower limit of a content f of the antioxidant (F) in the resin composition is, for example, 0.01% by mass, and is preferably 0.1% by mass, and more preferably 0.3% by mass. The upper limit of the content f of the antioxidant (F) is, for example, 5% by mass, and is preferably 3% by mass, and more preferably 1% by mass. When the content f of the antioxidant (F) falls within the above range, the antioxidant (F) is favorably dispersed, wherein, in the case of obtaining a molded product from the resin composition, there is a tendency to exhibit superiority in appearance, and to enable demonstrating favorable oxidative degradation resistance, heat resistance, and the like.

### Thermoplastic Elastomer (G)

The resin composition of the present invention may further contain the thermoplastic elastomer (G). In the case in which the resin composition further contains the thermoplastic elastomer (G), flex resistance and the like of the molded product and the like obtained from the resin composition may be improved.

The thermoplastic elastomer (G) is not particularly limited, and a thermoplastic polyester elastomer, a thermoplastic polystyrene elastomer, a thermoplastic polyolefin elastomer, and the like can be used. These may be used as one type, or two or more types may be combined. Of these, in light of improving the flex resistance, the thermoplastic elastomer (G) is preferably at least one selected from the group consisting of a thermoplastic polystyrene elastomer and a thermoplastic polyolefin elastomer.

The thermoplastic elastomer (G) is preferably a modified thermoplastic elastomer. The modified thermoplastic elastomer is preferably modified with an unsaturated carboxylic acid or a derivative thereof, and examples of the unsaturated carboxylic acid and the derivative thereof include maleic acid, fumaric acid, itaconic acid, maleic anhydride, itaconic anhydride, maleic acid monomethyl ester, maleic acid monoethyl ester, maleic acid diethyl ester, fumaric acid monomethyl ester, and the like. Of these, the thermoplastic elastomer (G) is more preferably an maleic anhydride-modified thermoplastic elastomer. The thermoplastic elastomer (G) being the modified thermoplastic elastomer is preferred due to miscibility with the EVOH (A) being improved, and the gas barrier properties, transparency, flexibility, and peelability being further improved.

The thermoplastic polyester elastomer (hereinafter, may be also referred to as “TPEE”) may be exemplified by multi-block copolymer that includes in the molecule, a polyester as a hard segment, and a polyether or a polyester having a low glass transition temperature (Tg) as a soft segment. The TPEE can be separated into the following types depending on differences in the molecular structure, and of these, a polyester-polyether type TPEE and a polyester-polyester type TPEE are preferred.

### (1) Polyester-Polyether Type TPEE

Generally, being a thermoplastic elastomer in which an aromatic crystalline polyester is used as a hard segment, and a polyether is used as a soft segment.

### (2) Polyester-Polyester Type TPEE

Being a thermoplastic elastomer in which an aromatic crystalline polyester is used as a hard segment, and an aliphatic polyester is used as a soft segment.

### (3) Crystalline TPEE

This is a thermoplastic elastomer in which rigid liquid crystal molecules are used as a hard segment, and an aliphatic polyester is used as a soft segment.

Examples of the polyester segment include polyester segments containing a dicarboxylic acid component such as: aromatic dicarboxylic acids such as terephthalic acid, isophthalic acid, and naphthalenedicarboxylic acid; alicyclic dicarboxylic acids such as 1,4-cyclohexanedicarboxylic acid; and aliphatic dicarboxylic acids such as succinic acid and adipic acid, and a diol component such as: aliphatic diols such as ethylene glycol, 1,2-propylene glycol, and 1,4-butanediol; and alicyclic diols such as cyclohexane-1,4-dimethanol. Examples of the polyether segment include aliphatic polyether segments such as polyethylene glycol, polypropylene glycol, and polybutylene glycol. The thermoplastic polyester elastomer is preferably a modified thermoplastic polyester elastomer and more preferably a maleic anhydride-modified thermoplastic polyester elastomer.

The thermoplastic polystyrene elastomer is not particularly limited, and typically contains a styrene-monomer polymer block (Hb) as the hard segment and a conjugated diene-compound polymer block or a hydrogenated block thereof (Sb) as the soft segment. The thermoplastic styrene elastomer may have a structure of a diblock structure represented by Hb-Sb, a triblock structure represented by Hb-Sb-Hb or Sb-Hb-Sb, a tetrablock structure represented by Hb-Sb-Hb-Sb, or a polyblock structure in which a total of 5 or more of Hb and Sb are linearly bonded.

The styrene monomer used for the styrene-monomer polymer block (Hb) is not particularly limited, and examples thereof may include styrene, derivatives thereof, and the like. Specific examples include vinyl group-containing aromatic compounds such as: styrenes such as styrene, α-methylstyrene, 2-methylstyrene, 4-methylstyrene, 4-propylstyrene, 4-t-butylstyrene, 4-cyclohexylstyrene, 4-dodecylstyrene, 2-ethyl-4-benzylstyrene, 4-(phenylbutyl)styrene, 2,4,6-trimethylstyrene, monofluorostyrene, difluorostyrene, monochlorostyrene, dichlorostyrene, methoxystyrene, and t-butoxystyrene; vinylnaphthalenes such as 1-vinylnaphthalene and 2-vinylnaphthalene; and the like, vinyl group-containing aromatic compounds such as indene and acenaphthylene, and the like. Of these, styrene is preferred. The styrene monomer may be of only one type, or may be of two or more types.

The conjugated diene compound used for the conjugated diene-compound polymer block or a hydrogenated block thereof (Sb) is also not particularly limited, and examples thereof may include butadiene, isoprene, 2,3-dimethylbutadiene, pentadiene, hexadiene, and the like. Of these, butadiene is preferred. The conjugated diene compound may be only one type or may be two or more types. Moreover, another comonomer, for example, ethylene, propylene, butylene, or styrene may be copolymerized. Furthermore, the conjugated diene-compound polymer block may be a hydrogenation product that is partially or completely hydrogenated.

Specific examples of the thermoplastic polystyrene elastomer include styrene-isoprene diblock copolymers (SI), styrene-butadiene diblock copolymers (SB), styrene-isoprene-styrene triblock copolymers (SIS), styrene-butadiene/isoprene-styrene triblock copolymers (SB/IS), and styrene-butadiene-styrene triblock copolymers (SBS), and hydrogenation products thereof. Of these, the thermoplastic polystyrene elastomer is preferably at least one selected from the group consisting of a hydrogenation product of styrene-isoprene diblock copolymers (SEP), a hydrogenation product of styrene-butadiene diblock copolymers (SEB), a hydrogenation product of styrene-isoprene-styrene triblock copolymers (SEPS), a hydrogenation product of styrene-butadiene/isoprene-styrene triblock copolymers (SEEPS), and a hydrogenation product of styrene-butadiene-styrene triblock copolymers (SEBS). The polystyrene-based thermoplastic elastomer is preferably a modified thermoplastic polystyrene elastomer, and more preferably a maleic anhydride-modified thermoplastic polystyrene elastomer.

The thermoplastic polyolefin elastomer includes thermoplastic elastomers, for example, containing a polyolefin block, such as polypropylene or polyethylene, as the hard segment and a rubber block, such as an ethylene-propylene-diene copolymer, as the soft segment. It is to be noted that such thermoplastic elastomers include a blend type and an implant type. Furthermore, modified thermoplastic polyolefin elastomers may include a maleic anhydride-modified ethylene-butene-1 copolymer, a maleic anhydride-modified ethylene-propylene copolymer, a butyl halide-based rubber, modified polypropylene, and modified polyethylene. The thermoplastic polyolefin elastomer is preferably a modified thermoplastic polyolefin elastomer, and more preferably a maleic anhydride-modified thermoplastic polyolefin elastomer.

The lower limit of a mass ratio (G/A) of the thermoplastic elastomer (G) to the EVOH (A) in the resin composition is preferably 5/95, more preferably 8/92, still more preferably 12/88, and may be yet more preferably 15/85 or 25/75. When the mass ratio (G/A) is more than or equal to the lower limit, the flex resistance and the like of the molded product and/or the like to be obtained can be improved. On the other hand, the upper limit of the mass ratio (G/A) is preferably 35/65, more preferably 30/70, and may be still more preferably 25/75. When the mass ratio (G/A) is less than or equal to the upper limit, the gas barrier properties and the like can be improved.

### Phase Separation Structure

In the resin composition of the present invention containing the thermoplastic elastomer (G), particles of the thermoplastic elastomer (G) are preferably dispersed in a matrix of the EVOH (A). That is, the resin composition containing the thermoplastic elastomer (G) preferably has a sea-island structure in which the sea phase is mainly constituted from the EVOH (A), and the island phases are mainly constituted from the thermoplastic elastomer (G). When the sea structure is thus mainly constituted from the EVOH (A), the flexibility can be improved while maintaining the gas barrier properties.

In the case in which the resin composition has the sea-island structure in which the sea phrase is mainly constituted from the EVOH (A) and the island phrases are mainly constituted from the thermoplastic elastomer (G), in light of improving the transparency, an average particle diameter of the island phases constituted from the thermoplastic elastomer (G) is preferably 4.5 μm or less, more preferably 3.5 μm or less, still more preferably 3.0 μm or less, particularly preferably 2.5 μm or less, and most preferably 2.0 μm or less. The average particle diameter of the thermoplastic elastomer (G) may be 0.1 μm or more. The average particle diameter of the island phases constituted from the thermoplastic elastomer (G) falling within the above range is preferred due to the flexibility tending to be improved while maintaining the gas barrier properties and the transparency and, furthermore, delamination properties tending to be improved. The average particle diameter of the thermoplastic elastomer (G) can be adjusted by adjusting kneading intensity, adjusting a component ratio of the EVOH (A) and the thermoplastic elastomer (G), and the like.

In the resin composition containing the thermoplastic elastomer (G), a refractive index difference between the EVOH (A) and the thermoplastic elastomer (G) is preferably 0.05 or less, more preferably 0.04 or less, and still more preferably 0.03 or less. The refractive index difference may be 0.005 or more. The refractive index difference falling within the above range is preferred due to the transparency of the resin composition tending to be more favorable.

### Additive(s)

The resin composition of the present invention may contain one or more types of additive(s) selected from the group consisting of an antioxidant, an ultraviolet ray-absorbing agent, a plasticizer, an antistatic agent, a lubricant, and a filler. A total content of the additive(s) in the resin composition may be 0.005% by mass or more and 50% by mass or less, or may be 20% by mass or less, 10% by mass or less, 5% by mass or less, or 1% by mass or less.

Specific examples of the antioxidant are as described above as the antioxidant (F).

Examples of the ultraviolet ray absorbing agent include ethylene-2-cyano-3,3′-diphenyl acrylate, 2-(2′-hydroxy-5′-methylphenyl)benzotriazole, 2-(2′-hydroxy-5′-methylphenyl)benzotriazole, 2-(2′-hydroxy-5′-methylphenyl)benzotriazole, 2-(2′-hydroxy-3′-t-butyl-5′-methylphenyl)-5-chlorobenzotriazole, 2-hydroxy-4-methoxybenzophenone, 2,2′-dihydroxy-4-methoxybenzophenone, 2-hydroxy-4-octoxybenzophenone, and the like.

Examples of the plasticizer include dimethyl phthalate, diethyl phthalate, dioctyl phthalate, wax, liquid paraffin, phosphoric acid esters, and the like.

Examples of the antistatic agent include pentaerythritol monostearate, sorbitan monopalmitate, sulfated polyolefins, polyethylene oxide, polyethylene glycol (trade name: Carbowax), and the like.

Examples of the lubricant include ethylene bis stearamide, butyl stearate, and the like.

Examples of the filler include glass fibers, wollastonite, calcium silicate, talc, montmorillonite, and the like.

### Other Optional Component(s)

The resin composition of the present invention may contain, as other optional component(s) aside from the EVOH (A), the unsaturated aliphatic aldehyde (B), the conjugated polyene compound (C), the inorganic particles (D), the nonionic surfactant (E), the antioxidant (F), the thermoplastic elastomer (G), and the above-described additive(s), a boron compound, a carboxylic acid, a phosphorus compound, a metal ion, a colorant, an other resin aside from the EVOH (A) and the thermoplastic elastomer (G), a metal salt of a higher fatty carboxylic acid, and/or the like. The resin composition may contain two or more of these components. In the case in which the resin composition contains the other optional component(s), the upper limit of a total content thereof is preferably 1% by mass, and may be preferably 0.5% by mass.

The boron compound inhibits gelation at the time of melt molding, and also inhibits torque fluctuation (a change in viscosity during heating) of an extrusion molding machine and/or the like. Examples of the boron compound include: boric acids such as orthoboric acid, metaboric acid, and tetraboric acid; boric acid esters such as triethyl borate and trimethyl borate; boric acid salts such as alkali metal salts or alkaline earth metal salts of the boric acids and borax; boron hydrides; and the like. Of these, the boric acids are preferred, and orthoboric acid (hereinafter, may be also referred to as “boric acid”) is more preferred. The lower limit of a content of the boron compound with respect to the EVOH (A) is preferably 100 ppm, and more preferably 500 ppm. Furthermore, the upper limit of the content of the boron compound with respect to the EVOH (A) is preferably 5,000 ppm, more preferably 3,000 ppm, and still more preferably 1,000 ppm. When the content of the boron compound is more than or equal to the lower limit, the torque fluctuation of the extrusion molding machine and/or the like can be sufficiently inhibited. On the other hand, when the content of the boron compound is less than or equal to the upper limit, gelation becomes less likely to occur at the time of melt molding, whereby the appearance of the resin composition and in turn the appearance of the molded product may improve. It is to be noted that the content of the boron compound is a content of the boron compound in terms of orthoboric acid equivalent.

The carboxylic acid is a substance that can prevent coloring of the resin composition and in turn coloring of the molded product, as well as inhibit gelation at the time of melt molding. Examples of the carboxylic acid include formic acid, acetic acid, propionic acid, butyric acid, lactic acid, salts thereof, and the like. The carboxylic acid is preferably a carboxylic acid or saturated carboxylic acid having 4 or fewer carbon atoms, and more preferably an acetic acid. The acetic acid encompasses acetic acid and acetic acid salts. As the acetic acid, using acetic acid and an acetic acid salt together is preferred, and using acetic acid and sodium acetate together is more preferred. The lower limit of a content of the carboxylic acid with respect to the EVOH (A) is preferably 50 ppm, more preferably 100 ppm, and still more preferably 150 ppm. The upper limit of the content of the carboxylic acid with respect to the EVOH (A) is preferably 1,000 ppm, more preferably 500 ppm, and still more preferably 400 ppm. When the content of the acetic acid is more than or equal to the lower limit, a sufficient coloring-inhibiting effect can be obtained, whereby the occurrence of yellowing can be sufficiently inhibited. On the other hand, when the content of the carboxylic acid is less than or equal to the upper limit, gelation is less likely to occur at the time of melt molding, particularly at the time of carrying out melt molding over a long time period, whereby the appearance of the molded product and/or the like may be favorable.

The phosphorus compound inhibits coloring and the generation of defects such as streaks and fish eyes, and additionally improves the long-run workability. Examples of the phosphorus compound include, e.g., phosphates of phosphoric acid, phosphorous acid, and the like. The phosphate may be in any form of a monobasic phosphate salt, a dibasic phosphate salt, and a tribasic phosphate salt. In addition, the cationic species contained in the phosphate is not particularly limited, and alkali metal salts and alkaline earth metal salts are preferred. Of these, sodium dihydrogen phosphate, potassium dihydrogen phosphate, disodium hydrogen phosphate, and dipotassium hydrogen phosphate are more preferred, and sodium dihydrogen phosphate and dipotassium hydrogen phosphate are still more preferred. The lower limit of a content of the phosphorus compound in the EVOH (A) is preferably 1 ppm, more preferably 10 ppm, still more preferably 20 ppm, and particularly preferably 30 ppm. The upper limit of the content of the phosphorus compound is preferably 200 ppm, more preferably 150 ppm, and still more preferably 100 ppm. When the content of the phosphorus compound is more than or equal to the lower limit or less than or equal to the upper limit, the thermal stability may improve, and the occurrence of gelatinous aggregates and the occurrence of coloring and the like are less likely at the time of carrying out melt molding over a long time period.

The metal ion may be exemplified by a monovalent metal ion, a divalent metal ion, and another transition metal ion, and these may consist of one type, or a plurality of types. Of these, the monovalent metal ion and the divalent metal ion are preferred. As the monovalent metal ion, an alkali metal ion is preferred, and examples thereof include ions of lithium, sodium, potassium, rubidium, and cesium; in light of industrial availability, an ion of sodium or potassium is preferred. Furthermore, examples of an alkali metal salt which gives the alkali metal ion include aliphatic carboxylic acid salts, aromatic carboxylic acid salts, carbonates, hydrochloric acid salts, nitric acid salts, sulfuric acid salts, phosphoric acid salts, and metal complexes. Of these, in light of availability, the aliphatic carboxylic acid salts and the phosphoric acid salts are preferred, and specifically, sodium acetate, potassium acetate, sodium phosphate, and potassium phosphate are preferred. It may be preferable for the divalent metal ion to be contained as the metal ion. When the metal ion contains the divalent metal ion, for example, heat deterioration of the EVOH at a time of recovering and reusing trim may be inhibited, and generation of gels and aggregates of the molded product to be obtained may be inhibited. Examples of the divalent metal ion include ions of beryllium, magnesium, calcium, strontium, barium, and zinc, and in light of industrial availability, an ion of magnesium, calcium, or zinc is preferred. Furthermore, examples of a divalent metal salt which gives the divalent metal ion include carboxylic acid salts, carbonates, hydrochloric acid salts, nitric acid salts, sulfuric acid salts, phosphoric acid salts, and metal complexes, and the carboxylic acid salts are preferred. A carboxylic acid which constitutes the carboxylic acid salt is preferably a carboxylic acid having 1 to 30 carbon atoms, and specific examples thereof include acetic acid, propionic acid, butyric acid, stearic acid, lauric acid, montanic acid, behenic acid, octylic acid, sebacic acid, ricinoleic acid, myristic acid, palmitic acid, and the like, and of these, acetic acid and stearic acid are preferred. The lower limit of a content of the metal ion with respect to the EVOH (A) is preferably 1 ppm, more preferably 100 ppm, and still more preferably 150 ppm. On the other hand, the upper limit of the content of the metal ion is preferably 1,000 ppm, more preferably 400 ppm, and still more preferably 350 ppm. When the content of the metal ion with respect to the EVOH (A) is 1 ppm or more, the interlayer adhesiveness of the multilayer structure to be obtained tends to be favorable. On the other hand, when the content of the metal ion is 1,000 ppm or less, the coloring resistance tends to be favorable.

Examples of the colorant include carbon black, phthalocyanine, quinacridone, indoline, azo pigments, bengara, and the like.

Examples of the other resin aside from the EVOH (A) and the thermoplastic elastomer (G) include polyamides, polyolefins, and the like.

Examples of the metal salt of the higher fatty carboxylic acid include sodium stearate, potassium stearate, calcium stearate, magnesium stearate, and the like.

In the resin composition of the present invention, a total content of the EVOH (A) and the unsaturated aliphatic aldehyde (B) (crotonaldehyde (B1), 2,4-hexadienal (B2), and 2,4,6-octatrienal (B3)) is preferably 90% by mass or more, more preferably 95% by mass or more, and may be still more preferably 98% by mass or more or 99% by mass or more. The resin composition may be constituted from substantially only the EVOH (A) and the unsaturated aliphatic aldehyde (B), or the resin composition may be constituted from only the EVOH (A) and the unsaturated aliphatic aldehyde (B). It is to be noted that “constituted from substantially only” as referred to herein means that optional component(s) is/are permitted to be contained within a range not influencing the effects of the present invention, and “constituted from only” as referred to herein means that optional component(s) other than impurities which are inevitably contained is/are excluded.

In the resin composition of the present invention, a total content of the EVOH (A), the unsaturated aliphatic aldehyde (B), and the optional component(s), being the inorganic particles (D), the nonionic surfactant (E), the antioxidant (F), and the thermoplastic elastomer (G), is preferably 90% by mass or more, more preferably 95% by mass or more, still more preferably 98% by mass or more, and particularly preferably 99% by mass or more.

The lower limit of a melt flow rate (MFR) of the resin composition of the present invention at a temperature of 210° C. and under a load of 2,160 g is preferably 0.5 g/10 min, and more preferably 1 g/10 min. On the other hand, the upper limit of this MFR is preferably 30 g/10 min, and more preferably 20 g/10 min. When the MFR of the resin composition falls within the above range, the melt moldability and the like can be enhanced. Furthermore, when the MFR of the resin composition falls within the above range, the neck-in resistance tends to be more favorable.

### Method for Preparing Resin Composition

A method for preparing the resin composition of the present invention is not particularly limited as long as it is a method which enables blending the unsaturated aliphatic aldehyde (B) into the EVOH (A). Examples of the method may include a method for preparing a resin composition, the method including:
(1) a step of copolymerizing ethylene with a vinyl ester; and
(2) a step of saponifying a copolymer obtained by step (1), wherein
   the method is characterized in that the unsaturated aliphatic aldehyde (B) is contained in the resin composition in a certain amount and at a certain proportion.

A procedure for incorporating the unsaturated aliphatic aldehyde (B) into the resin composition is not particularly limited, and is exemplified by: a procedure in which the unsaturated aliphatic aldehyde (B) is added in step (1); a procedure in which the unsaturated aliphatic aldehyde (B) is added in step (2); a procedure in which the unsaturated aliphatic aldehyde (B) is added to the EVOH (A) obtained in step (2); and the like. It is to be noted that in the case of the procedure in which the unsaturated aliphatic aldehyde (B) is added in step (1), or the procedure in which the unsaturated aliphatic aldehyde (B) is added in step (2) is employed, in order to incorporate a desired amount of the unsaturated aliphatic aldehyde (B) into the resin composition to be obtained, it is necessary to increase the amount of addition of the unsaturated aliphatic aldehyde (B) taking into consideration the amount of the unsaturated aliphatic aldehyde (B) consumed in the polymerization reaction in step (1) and/or the saponification reaction in step (2). Therefore, in a case in which the unsaturated aliphatic aldehyde (B) is added in the polymerization reaction and/or the saponification reaction step, it is preferable to further add the amount of the unsaturated aliphatic aldehyde (B) to be consumed. On the other hand, the procedure in which unsaturated aliphatic aldehyde (B) is added to the EVOH (A) obtained in step (2) achieves superior operability since the addition of the unsaturated aliphatic aldehyde (B) may be executed without taking into consideration the consumption thereof during the procedure.

In the preparation of the resin composition containing the EVOH (Aa) and the EVOH (Ab), for example, after mixing the EVOH (Aa) and the EVOH (Ab) to prepare the EVOH (A), the unsaturated aliphatic aldehyde (B) can be added to this EVOH (A) to prepare the resin composition. The unsaturated aliphatic aldehyde (B) may be added to each of the EVOH (Aa) and the EVOH (Ab), followed by mixing these to prepare the resin composition. Alternatively, the unsaturated aliphatic aldehyde (B) may be added to one of the EVOH (Aa) and the EVOH (Ab), followed by mixing this with the other of the EVOH (Aa) and the EVOH (Ab) to prepare the resin composition.

The procedure for adding the unsaturated aliphatic aldehyde (B) to the EVOH (A) is exemplified by: a procedure in which pelletizing is carried out after blending the unsaturated aliphatic aldehyde (B) with the EVOH (A) beforehand to give pellets; a procedure in which a strand deposited in a step of depositing a paste after the saponification of the ethylene-vinyl ester copolymer is impregnated with the unsaturated aliphatic aldehyde (B); a procedure in which a strand obtained by deposition is cut, and is then impregnated with the unsaturated aliphatic aldehyde (B); a procedure in which the unsaturated aliphatic aldehyde (B) is added to a solution of redissolved chips of a dry resin composition; a procedure in which a blend of two components, these being the EVOH (A) and the unsaturated aliphatic aldehyde (B), is melt kneaded; a procedure in which the unsaturated aliphatic aldehyde (B) is fed and thereby contained in a melt of the EVOH (A) during extrusion; a procedure in which a masterbatch is produced by blending a high concentration of the unsaturated aliphatic aldehyde (B) with a part of the EVOH (A) and pelletizing the blend, the masterbatch is dry blended with the EVOH (A), and the mixture is melt kneaded; and the like.

Of these, the procedure in which pelletizing is carried out after blending the unsaturated aliphatic aldehyde (B) with the EVOH (A) beforehand to give pellets is preferred in light of a enabling more uniformly dispersing a slight amount of the unsaturated aliphatic aldehyde (B) in the EVOH (A). Specifically, the unsaturated aliphatic aldehyde (B) is added to a solution prepared by dissolving the EVOH (A) in a good solvent such as a mixed solvent of water and methanol, and a thus resulting mixture solution is extruded into a poor solvent through a nozzle or the like to allow for deposition and/or coagulation, followed by washing and/or drying the same, whereby the resin composition pellets including the unsaturated aliphatic aldehyde (B) mixed with the EVOH (A) in a highly uniform manner can be obtained.

A procedure of adding other component(s) aside from the unsaturated aliphatic aldehyde (B) to the EVOH (A) is exemplified by: a procedure in which the pellets are mixed together with the other component(s) and melt kneaded; a procedure in which, at the time of preparing the pellets, the unsaturated aliphatic aldehyde (B) is mixed together with the other component(s); a procedure in which the pellets are immersed in a solution containing the other component(s); a procedure in which the other component(s) are dry-blended into the pellets; and the like. It is to be noted that a ribbon blender, a high-speed mixer cokneader, a mixing roll, an extruder, an intensive mixer, and the like may be employed for the mixing of the other component(s).

A method for producing the resin composition containing the nonionic surfactant (E) is exemplified by: a procedure in which, after producing the resin composition containing the EVOH (A) and the unsaturated aliphatic aldehyde (B) by the above-described procedure, this resin composition is mixed with the nonionic surfactant (E); a procedure in which the EVOH (A), the unsaturated aliphatic aldehyde (B), and the nonionic surfactant (E) are mixed at once; and the like.

As a procedure for mixing the resin composition containing the EVOH (A) and the unsaturated aliphatic aldehyde (B) with the nonionic surfactant (E), a well-known procedure such as melt kneading may be carried out.

The melt kneading of the EVOH (A), the nonionic surfactant (E), and the like can be performed using, for example, a known mixing apparatus or kneading apparatus such as a kneader ruder, an extruder, a mixing roll, a Banbury mixer, or the like. Examples of a form of the nonionic surfactant (E) include a solid such as a powder, a melt, a solution such as an aqueous solution, a dispersion such as an aqueous dispersion, and the like. The nonionic surfactant (E) being in such a form can be mixed with the EVOH (A) and/or the other component(s). As the form of the nonionic surfactant (E), the solution and the dispersion are preferred. A temperature at a time of melt kneading the mixture containing the EVOH (A), the nonionic surfactant (E), and the like may be appropriate adjusted in accordance with, e.g., a melting point of the EVOH (A) to be used, and is typically 120° C. or higher and 300° C. or lower.

The resin composition containing the nonionic surfactant (E) is preferably produced by a production method including a step of melt kneading the EVOH (A) with the nonionic surfactant (E) and a water-containing mixture. The mixture may further contain the unsaturated aliphatic aldehyde (B). A content of water in the mixture with respect to 100 parts by mass of the EVOH (A) is preferably 0.1 parts by mass or more and 50 parts by mass or less, and more preferably 0.5 parts by mass or more and 50 parts by mass or less. When this content is 0.1 parts by mass or more, the resin composition to be obtained tends to be less susceptible to coloring. On the other hand, when the content is 50 parts by mass or less, a tendency for foaming to occur in the resin composition discharged from the extruder due to phase separation occurring between the EVOH (A) and water can be inhibited. The content of water in the mixture means a total of water added independently and water added together with the other component(s), and water contained in the EVOH (A), the nonionic surfactant (E), and the like due to moisture absorption and the like is also included. A procedure of adding water together with the other component(s) is exemplified by: a procedure of using the aqueous solution or the aqueous dispersion as the nonionic surfactant (E); as described later, using, as the EVOH (A), a substance which contains a certain amount of water; and the like.

The production method preferably includes a step of obtaining the mixture by adding the aqueous solution or the aqueous dispersion containing the nonionic surfactant (E) to the EVOH (A), or to the resin composition containing the EVOH (A) and the unsaturated aliphatic aldehyde (B). By adding the nonionic surfactant (E) as the aqueous solution or the aqueous dispersion, the nonionic surfactant (E) is more likely to be dispersed in the EVOH (A).

In the production method, the aqueous solution or the aqueous dispersion containing the nonionic surfactant (E) may be added to the unmelted EVOH (A), or to the resin composition containing the EVOH (A) and the unsaturated aliphatic aldehyde (B). Furthermore, the aqueous solution or the aqueous dispersion containing the nonionic surfactant (E) may be added to the melted EVOH (A), or to the composition containing the EVOH (A) and the unsaturated aliphatic aldehyde (B).

A procedure of melt kneading the EVOH (A), the nonionic surfactant (E), and the water-containing mixture is exemplified by: a procedure in which the EVOH (A), or the resin composition containing the EVOH (A) and the unsaturated aliphatic aldehyde (B) is introduced into an extruder, and then the nonionic surfactant (E) and, as needed, the other component(s) are added and kneaded with respect to the melted EVOH (A), and then discharged; and the like. At this time, the EVOH (A) having a moisture content of 5 to 40% by mass, or the resin composition containing the EVOH (A) and the unsaturated aliphatic aldehyde (B) and having a moisture content of 5 to 40% by mass may be introduced into the extruder.

In light of ease of handleability, the resin composition of the present invention is preferably in pellet form. A shape of the pellets of the resin composition is not particularly limited, and examples thereof include cylindrical, prismatic, spherical, lenticular, and the like. Of these, in light of transportation stability, handleability, producibility, and the like of the pellets, the shape is preferably cylindrical, spherical, or lenticular. In the case of the shape being cylindrical, a diameter thereof is preferably 1 mm or more and 10 mm or less and more preferably 2 mm or more and 8 mm or less, and a height thereof is preferably 1 mm or more and 10 mm or less, more preferably 2 mm or more and 8 mm or less, and still more preferably 3 mm or more and 5 mm or less. In the case of the shape being lenticular, a length in a latitudinal direction thereof is preferably 1 mm or more and 10 mm or less and more preferably 2 mm or more and 8 mm or less, and a length in a longitudinal direction thereof is preferably 1 mm or more and 10 mm or less and more preferably 2 mm or more and 8 mm or less.

### Molded Product

The resin composition of the present invention can be formed into a molded product such as a film, a sheet, a tube, a bag, and a bottle by melt molding or the like. Since the molded product having a part constituted from the resin composition enables inhibiting neck-in and die buildup, the molded product is superior in producibility. It is to be noted that the molded product of the present invention must only have the part formed from the resin composition of the present invention. In other words, the molded product may be a molded product constituted from only the resin composition of the present invention, or may be constituted from a part formed from only the resin composition of the present invention, and an other part. The “film” as referred to herein means a molded product typically having an average thickness of less than 300 μm, whereas the “sheet” as referred to herein means a molded product typically having an average thickness of 300 μm or more. It is to be noted that unless otherwise specified particularly, the “average thickness” as referred to herein means an average value of thicknesses measured at 5 arbitrary sites. Examples of the procedure for the melt molding include extrusion molding, cast molding, inflation extrusion molding, blow molding, melt spinning, injection molding, injection blow molding, coextrusion blow molding, and the like. The melt molding temperature may vary depending on the melting point of the EVOH (A) and the like, and is preferably 150° C. to 270° C. It is possible to subject these molded products to remolding for the purpose of reuse of the same after grinding. Alternatively, the film, the sheet, or the like can also be monoaxially or biaxially stretched. The film, the sheet, the multilayer structure, a monoaxially stretched multilayer structure, a biaxially stretched multilayer structure, a packaging material, a container, a pipe, the thermoformed container, the blow-molded container, a vapor deposition film, a vertical form fill seal pouch, a vacuum wrapping bag, a spout-attached pouch, a laminate tube container, a lid material for a container, a vacuum insulator, and the like, each described later, are each a mode of the molded product of the present invention.

### Film and Sheet

Since the film and the sheet (hereinafter, may be abbreviated to “film, etc.”) formed from the resin composition of the present invention result in the occurrence of neck-in and die buildup being inhibited, the film, etc. are superior in producibility. The film, etc., encompass both a monolayer film, etc., and a multilayer film, etc. The film, etc. may be used as various types of packaging materials and the like.

The film, etc. can be produced by a method similar to that described as the procedure for producing the molded product, described above. Of these, a preferred method includes: a cast molding step of melt-extruding the resin composition of the present invention on casting rolls; and a step of stretching an unstretched film obtained from the resin composition (a monoaxial stretching step, a sequential twin-screw step, a simultaneous biaxial stretching step, an inflation molding step, etc.). According to the method for producing the film, etc., including these steps enables improvement of breakage resistance.

### Multilayer Structure

The multilayer structure of the present invention has at least one layer (hereinafter, may be also referred to as “barrier layer” or “EVOH layer”) constituted from the resin composition of the present invention, and a layer constituted from an other component. Compared to the molded product having a monolayer configuration, the multilayer structure has benefits such as an improvement in function and the like. Furthermore, since the multilayer structure of the present invention is produced using the resin composition, which inhibits neck-in and die buildup, the multilayer structure is superior in continuous producibility. The lower limit of the number of layers of the multilayer structure may be 2, or may be 3. The upper limit of the number of layers of the multilayer structure may be 1,000, may be 100, or may be 10. All layers of the multilayer structure may be formed each from a resin. Furthermore, the multilayer structure may further have a layer formed from a component other than a resin, such as a layer formed from a paper, a metal layer, an inorganic vapor deposition layer, and/or the like.

As the layer constituted from the other component (the layer other than the layer constituted from the resin composition of the present invention), a thermoplastic resin layer formed from a thermoplastic resin is preferred. Furthermore, the layer constituted from the other component may also be exemplified by an adhesive resin layer formed from an adhesive resin. A layer configuration of the multilayer structure is not particularly limited, and when: the barrier layer is represented by “E”; the adhesive resin layer is represented by “Ad”; the thermoplastic resin layer is represented by “T”; and a state of being directly laminated is represented by “/”, configurations such as T/E/T, E/Ad/T, T/Ad/E/Ad/T, E/Ad/T/Ad/E, E/Ad/T/Ad/E/Ad/T/Ad/E, and the like may be exemplified. Each of these layers may be either a monolayer or a multilayer. It is to be noted that the adhesive resin layer Ad may be included in the thermoplastic resin layer.

The thermoplastic resin layer is a layer containing, as a principal component, a thermoplastic resin. A content of the thermoplastic resin in the thermoplastic resin layer is preferably 90% by mass or more and 100% by mass or less. Examples of the thermoplastic resin include: linear low-density polyethylene, low-density polyethylene, medium-density polyethylene, high-density polyethylene, ethylene-vinyl acetate copolymers, ethylene-propylene copolymers, polypropylene, propylene-α-olefin (α-olefin having 4 to 20 carbon atoms) copolymers, homopolymers of an olefin such as polybutene or polypentene and copolymers thereof; polyesters such as polyethylene terephthalate; polyester elastomers; polyamides such as nylon-6 and nylon-66; polystyrenes; polyvinyl chlorides, polyvinylidene chlorides; acrylic resins; vinyl ester resins; polyurethane elastomers; polycarbonates; chlorinated polyethylenes; chlorinated polypropylenes; and the like. Of these, examples of preferably employed thermoplastic resins include polypropylenes, polyethylenes, ethylene-propylene copolymers, ethylene-vinyl acetate copolymers, polyamides, polystyrenes, and polyesters. The thermoplastic resin layer may further contain component(s) other than the thermoplastic resin.

The adhesive resin layer (B) is a layer containing, as a principal component, an adhesive resin. A content of the adhesive resin in the adhesive resin layer is preferably 90% by mass or more and 100% by mass or less. The adhesive resin is not particularly limited as long as it has adhesiveness to the barrier layer and the layer constituted from the other component, and is preferably an adhesive resin containing a carboxylic acid-modified polyolefin. As the carboxylic acid-modified polyolefin, a modified olefin polymer containing a carboxy group resulting from chemically bonding an ethylenic unsaturated carboxylic acid, an ester thereof, or an anhydride therefrom to an olefin polymer, is preferred. The olefin polymer as referred to herein means a polyolefin such as polyethylene, linear low-density polyethylene, polypropylene, or polybutene, or a copolymer of the olefin with another monomer. Of these, linear low-density polyethylene, an ethylene-vinyl acetate copolymer, and an ethylene-ethyl acrylate copolymer are preferred, and linear low-density polyethylene and an ethylene-vinyl acetate copolymer are particularly preferred. The adhesive resin layer may further contain component(s) other than the adhesive resin.

In light of inhibiting die buildup, a mode in which the multilayer structure includes the barrier layer as atop layer is suitably employed. It is to be noted that the “top layer” as referred to means a layer having only one face which comes in contact with another layer of the multilayer structure. In a case in which there is a distinction in the multilayer structure between an inner face and an outer face, the top layer may be a layer on an outer face side (outermost layer), or may be a layer on an inner face side (innermost layer). In the case in which the barrier layer is included as the top layer, the multilayer structure is preferably produced by coextrusion molding, and afterward, the inorganic vapor deposition layer may be formed on the barrier layer of the multilayer structure, or the layer constituted from the other component may be laminated thereon. Since EVOH has high affinity with the inorganic vapor deposition layer, particularly with a vapor deposition layer of aluminum or aluminum oxide, interlayer adhesiveness of the barrier layer with the inorganic vapor deposition layer tends to be favorable. As a layer configuration which includes the barrier layer as the top layer, when: the barrier layer is represented by “E”; the adhesive resin layer is represented by “Ad”; the thermoplastic resin layer is represented by “T”; and a state of being directly laminated is represented by “/”, E/Ad/T, E/Ad/T/Ad/E, E/Ad/T/Ad/E/Ad/T/Ad/E, and the like may be exemplified. It is to be noted that in the case of the multilayer structure which includes the barrier layer as the top layer, in light of achieving favorable recyclability, T is preferably a layer of a polyolefin.

A method for producing the multilayer structure is not particularly limited, and is exemplified by: a method of melt-extruding an other component with the molded product (the film, the sheet, etc.) constituted from the resin composition of the present invention; a method of coextruding the other component with the resin composition; a method of coinjection-molding the other component with the resin composition; a method of laminating the barrier layer constituted from the resin composition and the layer constituted from the other component, using a well-known adhesive such as an organic titanium compound, an isocyanate compound, or a polyester compound; and the like.

A procedure of coextrusion of the resin composition of the present invention with the other component is not particularly limited, and is exemplified by a multimanifold-merging T-die process, a feedblock-merging T-die process, an inflation molding process, and the like.

The multilayer structure may be in the form of a film or sheet, or may be molded into any of various shapes. The multilayer structure can be used for packaging materials, containers, tubes, and the like, and can be suitably used also as materials for thermoforming of thermoformed containers and the like. The thermoformed product obtained from the multilayer structure tends to be accompanied by fewer defects such as stripes and to be superior in appearance characteristics. Such a thermoformed product is also involved in one mode of the multilayer structure of the present invention.

As a procedure for further molding to give a molded product by using the multilayer sheet of the present invention, for example, a heat stretching process, a vacuum molding process, a pressure molding process, a vacuum/pressure molding process, a blow molding process, and the like may be exemplified. The multilayer structure to be variously subjected to secondary molding may be a multilayer sheet. The multilayer structure may be used for packaging materials, containers, tubes, and the like. The multilayer structure may be an unstretched multilayer sheet, or may be a stretched multilayer sheet.

### Monoaxially Stretched Multilayer Structure

The monoaxially stretched multilayer structure, being one embodiment of the present invention, is a product in which the multilayer structure of the present invention, being unstretched, is stretched to a size of 2 times or more and 12 times or less in at least an axial direction. This multiplication factor may be 3 times or more and 10 times or less, or may be 4 times or more and 8 times or less. The multilayer structure thus being monoaxially stretched tends to be superior in gas barrier properties, breakage resistance, and the like. The monoaxially stretched multilayer structure can be suitably used as a packaging material or the like. The monoaxial stretching on the multilayer structure (multilayer sheet) may be performed by a conventionally well-known procedure.

### Biaxially Stretched Multilayer Structure

The biaxially stretched multilayer structure, being one embodiment of the present invention, is a product in which the multilayer structure of the present invention, being unstretched, is stretched to a size of 2 times or more and 12 times or less in each of two axial directions. This multiplication factor may be 10 times or less, may be 8 times or less, or may be 6 times or less. The multilayer structure thus being biaxially stretched tends to be superior in gas barrier properties, breakage resistance, and the like. The biaxially stretched multilayer structure can be suitably used as a packaging material or the like. The biaxial stretching on the multilayer structure (multilayer sheet) may be performed by a conventionally well-known procedure.

### Packaging Material

The packaging material, being one embodiment of the present invention, is a packaging material obtained by molding the multilayer structure of the present invention by a heat stretching process. The heat stretching process is a process in which the multilayer structure is heated, and then stretched in one direction or a plurality of directions to achieve molding. The packaging material being obtained by molding the multilayer structure by the heat stretching process can be easily and reliably produced, and furthermore, tends to be superior in appearance, gas barrier properties, and the like.

In the case of the heat stretching process, the thermoplastic resin to be used is preferably stretchable within a range of heat stretching temperatures satisfying the following inequality (3).

$$X - 11 \; 0 \leq Y \leq X - 10 \qquad ( 3 )$$

In the above inequality (3), X represents the melting point (° C.) of the EVOH (A); the melting point of the EVOH (A) containing a plurality of EVOHs having different melting points is the average value on a mass basis. Y represents the heat stretching temperature (° C.). In a case where the packaging material is produced using the multilayer sheet through the heat stretching process, when the resin is used as the thermoplastic resin, more superior appearance characteristics can be exhibited, and additionally defects such as cracks can be further inhibited.

### Container

The container, being one embodiment of the present invention, is a container obtained by molding the multilayer structure of the present invention by a vacuum/pressure molding process. In the vacuum/pressure molding process, the multilayer sheet is heated, and molded using a combination of a vacuum and pressure. The container being obtained by molding the multilayer structure by the vacuum/pressure molding process can be easily and reliably produced, and furthermore, tends to be superior in appearance, gas barrier properties, and the like.

In the aforementioned vacuum/pressure molding process, the multilayer structure is, for example, heated to be softened, and thereafter molded so as to fit a die shape. Examples of the molding process include: a process in which molding is carried out so as to fit a die shape by means of vacuum or compressed air, which may be used in combination with a plug in addition, if necessary (a straight process, a drape process, an air slip process, a snap-back process, a plug-assist process, and the like); a press molding process; and the like. Various types of molding conditions such as the molding temperature, the degree of vacuum, the pressure of the compressed air, and the molding speed may be appropriately determined in accordance with the shape of the plug and/or the die shape, as well as properties of a raw material film or multilayer structure, and the like.

The molding temperature is not particularly limited as long as the resin is softened sufficiently to be molded at the temperature. For example, in a case in which the multilayer structure is subjected to thermoforming, it is desired that the multilayer structure is not exposed to: high temperatures at which melting of the multilayer structure by heating occurs or the roughness of a metal surface of a heater plate is transferred to the multilayer sheet; or low temperatures at which shaping cannot be sufficiently attained. Specifically, the temperature of the multilayer sheet is 50° C. to 180° C., and suitably 60° C. to 160° C.

One mode of the container is a container is produced by thermoforming the multilayer structure into a three-dimensional shape such that a recessed part is provided on the plane of the multilayer structure of the present invention. The container is suitably molded through the aforementioned vacuum/pressure molding process. In a case in which the container is obtained through molding of a multilayer structure having a total thickness of all layers of less than about 300 μm, the effects of the invention may be exhibited more effectively at a draw ratio (S) of suitably 0.2 or more, more suitably 0.3 or more, and still more suitably 0.4 or more. Alternatively, in a case where the container is obtained through molding of a multilayer structure having a total thickness of all layers of about 300 μm or more, the effects of the invention may be exhibited more effectively at a draw ratio (S) of suitably 0.3 or more, more suitably 0.5 or more, and still more suitably 0.8 or more.

The draw ratio (S) as referred to herein means a value calculated using the following equation (4):

$$S = ( a depth pf the container ) / ( a maximum diameter of a circle inscribed in the opening of the container ) \qquad ( 4 )$$

In other words, the draw ratio (S) is a value obtained by dividing a value of the depth of the bottom of the recessed part of the container by a value of the diameter of the largest inscribed circle tangent to the shape of the recessed part (opening) provided on the plane of the multilayer structure. For example, when the shape of the opening of the recessed part is circular, the value of the diameter of an inscribed circle having a maximum diameter means a diameter of the circular shape; when the shape of the opening of the recessed part is elliptical, the value of the diameter of an inscribed circle having a maximum diameter means a minor axis of the elliptical shape; and when the shape of the opening of the recessed part is rectangular, the value of the diameter of an inscribed circle having a maximum diameter means a length of the shorter side of the rectangular shape.

Molded Product, Etc. Having Layer Constituted from Resin Composition Containing Antioxidant

The molded product and the like having the layer (EVOH layer) constituted from the resin composition containing the antioxidant is resistant to the formation of cracks in the EVOH layer due to oxidative degradation, even in a case of being used over a long time period at a high temperature. Thus, the molded product and the like are suitable for a daily use product, a packaging material, a machine component, and the like, each of which is for use outdoors. Examples of intended uses in which the characteristics of such a molded product and the like are effectively exhibited include packaging materials for food/drinks, packing materials for containers, films, agricultural films, geomembranes, bag materials for medical fluid infusions, high-pressure tank materials, gasoline tank materials, fuel containers, tube materials for tires, cushion materials for shoes, inner bag materials for bag-in-boxes, tank materials for organic liquid storage, pipes (pipe materials for transporting organic liquids, pipe materials for warm water for heating (warm water pipe materials for floor heating, etc.), and the like), resin wallpapers, plant mediums, and the like. In particular, the molded product and the like are suitably used as films, pipes, agricultural films, plant mediums, and geomembranes in which the EVOH layer is coextruded as the top layer of a laminate, each of which is for use outdoors and is resistant to deterioration due to heat and/or light.

### Pipe

A pipe of one embodiment of the present invention has a layer constituted from the resin composition of the present invention. The pipe has few defects such as streaks at the time of melt molding, is superior in appearance, and has improved stability compared to other products using the same EVOH in a case of being used over a long time period at a high temperature.

Furthermore, in the case in which the resin composition contains the unsaturated aliphatic aldehyde (B) and the antioxidant (F) in a certain amount, the layer constituted from the resin composition of the present invention being included in the pipe enables, e.g., usage over a long time period since the occurrence of cracks, etc. is inhibited due to the molded product having few defects.

The pipe may be a monolayer pipe, or may be a multilayer pipe. In the case in which the pipe is a multilayer pipe, the layer configuration thereof may be exemplified by layer configurations similar to those of the multilayer structure of the present invention, described above. With regard to the layer configuration of the multilayer pipe, for example, when: the layer constituted from the resin composition of the present invention is represented by “E”; an adhesive layer is represented by “Ad”; and a layer obtained from the thermoplastic resin is represented by “T”, configurations such as T/E/T, E/Ad/T, and T/Ad/E/Ad/T may be exemplified. Each of these layers may be either a monolayer or a multilayer. Specific examples of the resin used in the adhesive layer and the thermoplastic resin include resins similar to those used in these layers in the multilayer structure of the embodiment of the present invention. Furthermore, a method for producing the pipe is also not particularly limited, and various molding methods exemplified as the method of melt-molding the resin composition of the present invention may be employed.

An intended usage of the pipe is not particularly limited, and for example, the pipe can be used as a hot water circulation pipe, a heat insulating multilayer pipe, a fuel pipe, a gas pipe, and the like.

In the case in which the pipe is a multilayer pipe, and the multilayer pipe is used as a hot water circulation pipe, a 3-layer configuration of T/Ad/E, having the layer constituted from the resin composition of the present invention as the outermost layer, is typically adopted. This is because in reality, many pipe manufacturers have adopted this configuration since by adding equipment for coextrusion coating of the resin composition of the present invention and the adhesive resin to production lines of monolayer pipes, such as existing crosslinked polyolefins, the production lines can be easily converted to a production line for the multilayer pipe.

Providing, e.g., polyolefin layers on both sides of the layer constituted from the resin composition of the present invention and using the resin composition layer as an intermediate layer is effective for, e.g., damage prevention of the resin composition layer. However, in the case of using the multilayer pipe as a hot water circulation pipe, e.g., a floor heating pipe, since the multilayer pipe is typically laid under the floor, the risk of damage to the layer constituted from the resin composition of the present invention by physical impact and the like is comparatively low. Therefore, in light of gas barrier properties, it is rather desirable to provide the layer constituted from the resin composition as the outermost layer. The gas barrier properties of the EVOH (A) generally exhibit high moisture dependency, whereby the barrier properties tend to degrade under a condition involving high humidity. Thus, when the layer constituted from the resin composition of the present invention is provided as the outermost layer, the layer constituted from the resin composition, being constituted from the EVOH (A), is mainly positioned at a site the furthest away from a surface inside the pipe which comes in contact with water; consequently, this layer configuration is the most useful layer configuration in terms of the barrier performance of the multilayer pipe. On the other hand, typically, in the case of providing the EVOH layer as the outermost layer, due to coming directly in contact with air, the EVOH layer is likely to be affected by oxidative degradation. In such an environment, since the layer constituted from the resin composition, containing the antioxidant, is unlikely to undergo oxidative degradation even at a high temperature and is provided as the outermost layer, the effect of providing the multilayer pipe in which the occurrence of cracks due to oxidative degradation is reduced while having favorable barrier properties can be more effectively exhibited.

Furthermore, in the case of the multilayer pipe being used as the heat insulating multilayer pipe for, e.g., area cooling/heating, it is preferable to have: a 3-layer configuration (hereinafter, may be abbreviated to laminate 1) of T/Ad/E, in which the layer constituted from the resin composition of the present invention is provided closer to the inner side than the thermoplastic resin layer; or, in light of preventing damage to the resin composition layer, a 5-layer configuration (hereinafter, may be abbreviated to laminate 2) of T/Ad/E/Ad/T.

A configuration of the heat insulating multilayer pipe for, e.g., area heating/cooling is not particularly limited, and for example, from the inner side, being provided with an inner pipe, a heat insulating foam layer covering a circumference of the inner pipe, and then the laminate 1 or 2 having the layer constituted from the resin composition of the present invention, as the outer layer, in this order, is preferred.

A type (material), shape, and size of the pipe used as the inner pipe is not particularly limited as long as it enables transporting a heating medium such as gas or liquid, and may be appropriately selected in accordance with a type of the heating medium, an intended usage and usage form of the piping material, and the like. Specifically, metals such as steel, stainless steel, aluminum, and the like; polyolefins (polyethylene, crosslinked polyethylene (PEX), polypropylene, poly 1-butene, poly 4-methyl-1-pentene, etc.), and the laminate 1 or 2 having the layer constituted from the resin composition of the present invention may be exemplified, and of these, the crosslinked polyethylene (PEX) is suitably used.

As a heat insulating foam constituting the heat insulating foam layer, polyurethane foam, polyethylene foam, polystyrene foam, phenol foam, or polyisocyanurate foam may be used, and in light of improving heat insulating performance, polyurethane foam is suitably used.

Chlorofluorocarbon gases, various alternative chlorofluorocarbons, water, chlorinated hydrocarbons, hydrocarbons, carbon dioxide, and the like may be used as a foaming agent of the heat insulating foam, and in light of foaming effects and impact on the environment, a hydrocarbon, specifically n-pentane or cyclopentane, is suitably used.

As a method for producing the heat insulating pipe, for example, a procedure in which the inner pipe which transports the heating medium is inserted inside a pipe-shaped outer layer and the inner pipe is secured with a spacer to create a dual-layer pipe, and various foam feedstocks are injected into a gap part between the inner pipe and the outer layer to allow for foaming and hardening can be exemplified. A material for the spacer is not particularly limited, and in order to reduce damage by the spacer to the inner pipe and the outer layer, polyethylene or polyurethane is preferred.

In the case of using the pipe as the fuel pipe, the layer constituted from the resin composition of the present invention preferably further contains the thermoplastic elastomer (G). When the thermoplastic elastomer (G) is contained, crack resistance and the like of the pipe can further improve.

In the case of use as the fuel pipe, an innermost layer is formed so as to be electrically conductive. For this purpose, an electrically conductive additive which per se is known, such as, for example, carbon black, graphite fibers, or the like, is mixed into the thermoplastic resin of the innermost layer.

### Method for Producing Pipe, Etc.

Hereinafter, a method for producing the multilayer pipe is described as an example of the pipe, but a part or all of this method may be applied to methods for producing other molded products (films, sheets, etc.). The multilayer pipe may be produced, as described above, by performing coextrusion coating on a monolayer pipe of, e.g., crosslinked polyolefin using the resin composition of the present invention and the adhesive resin. At the time of performing the coextrusion coating on the monolayer pipe using the resin composition of the present invention and the adhesive resin, the coating may be performed by simply using a film obtained by melting the resin composition of the present invention and the adhesive resin on the monolayer pipe, but there may be a case in which adhesiveness between the monolayer pipe and the coating layer is insufficient, whereby there is a possibility that the coating layer may peel during use over a long period, resulting in loss of the gas barrier properties. As a measure against this, it is effective to, before coating, subject the surface of the pipe to be coated to a frame treatment and/or a corona discharge treatment.

As another multilayer molding procedure for producing the multilayer pipe, a procedure of carrying out what is generally referred to as coextrusion molding may be exemplified. In this procedure, extruders in a number corresponding to the types of resin layers are used, and simultaneous extrusion molding is performed in a state such that flows of resins melted in the extruders are stacked in layers. Furthermore, a multilayer molding procedure such as dry lamination may also be adopted.

The method for producing the multilayer pipe preferably includes a step of cooling with water at 10 to 70° C. immediately after molding. In other words, after the melt molding, before curing the layer constituted from the resin composition of the present invention, the resin composition layer is desirably cooled with water at 10 to 70° C. for curing. When the temperature of the cooling water is too low, in a case of bending the multilayer pipe in the secondary processing step which follows, a crack is likely to occur due to warping of the layer constituted from the resin composition of the present invention at the bending part. Details of a cause for the crack being likely to occur due to warping are not necessarily clarified, but it is presumed that residual stress in the molded article may have an influence. In light of this, the temperature of the cooling water is more preferably 15° C. or higher, and still more preferably 20° C. or higher. On the other hand, when the temperature of the cooling water is too high, a crack is likely to occur at the time of the secondary processing, due to warping of the layer constituted from the resin composition of the present invention at the bending part. Details of a cause for this are also not sufficiently clarified, but it is presumed that this results from a level of crystallization of the layer constituted from the resin composition of the present invention becoming too high. In light of this, the temperature of the cooling water is more preferably 60° C. or lower, and still more preferably 50° C. or lower.

Subjecting the multilayer pipe obtained by the above procedure to the secondary processing enables various types of molded products to be obtained. A procedure for the secondary processing is not particularly limited and a well-known secondary processing procedure may be appropriately adopted, and for example, a procedure of carrying out processing involving the multilayer pipe being heated to 80 to 160° C. and then deformed into a desired shape, and then secured for 1 minute to 2 hours in that state may be exemplified.

Furthermore, also in the case in which the pipe is the monolayer pipe, the production can be performed by the well-known molding processes described above as a process for melt molding the resin composition of the present invention.

### Thermoformed Container

The thermoformed container of the present invention has a layer (a) constituted from the resin composition of the present invention. The thermoformed container can be used in intended usages for which oxygen barrier properties are demanded in a variety of fields such as, for example, foods, cosmetics, medical/chemical drugs, toiletries, and the like. The layer (a) of the thermoformed container is formed from the resin composition, which inhibits neck-in and die buildup at the time of melt molding. Thus, the thermoformed container has superior uniformity in gas barrier properties and a favorable appearance. The gas barrier properties per se of the thermoformed container are also favorable. The thermoformed container is formed having a retaining portion by, for example, subjecting a structure (the multilayer structure, etc.) having the layer (a) to thermoforming.

The retaining portion is a portion for retaining contents such as foods. The shape of this retaining portion is decided in accordance with the shape of the contents. Specifically, the thermoformed container may be formed to give, for example, a cup-shaped container, a tray-shaped container, a bag-shaped container, a bottle-shaped container, a pouch-shaped container, or the like.

The structure, used as one example of the production of the thermoformed container, has the layer (a) constituted from the resin composition. The structure may be a multilayer body resulting from laminating at least one of one face or the other face of the layer (a) to another layer. As referred to, the “one face” means the inner face side of the retaining portion when the structure has been made into the thermoformed structure, and the “other face” means the outer face side of the retaining portion. The structure may be in a film form, or may be in a sheet form.

In the case in which the thermoformed container or the structure is the multilayer body, the lower limit of a thickness ratio (I/O) of the total average thickness (I) of the other layer(s) laminated to one face side of the layer (a) to the total average thickness (O) of the other layer(s) laminated to the other face side of the layer (a) is preferably 1/99, and more preferably 30/70. The upper limit of I/O described above is preferably 70/30, and more preferably 55/45.

The lower limit of an overall average thickness of the thermoformed container is preferably 300 μm, more preferably 500 μm, and still more preferably 700 μm. Furthermore, the upper limit of the overall average thickness is preferably 10,000 μm, more preferably 8,500 μm, and still more preferably 7,000 μm. It is to be noted that the “overall average thickness” of the thermoformed container as referred to herein means the average thickness of the total layers in the retaining portion of the thermoformed container. When the overall average thickness of the thermoformed container is less than or equal to the upper limit, production cost of the thermoformed container is suppressed. On the other hand, when the overall average thickness of the thermoformed container is less than or equal to the upper limit, the rigidity increases, whereby the thermoformed container is less likely to break easily. Thus, it is important to set the average overall thickness of the thermoformed container to a thickness in accordance with a volume and intended usage.

The other layer(s) laminated to the layer (α) constituted from the resin composition are exemplified by: a layer β containing a thermoplastic resin layer as a principal component; a layer (γ) container a carboxylic acid-modified polyolefin as a principal component; a layer (δ) containing EVOH, a thermoplastic resin, and a carboxylic acid-modified polyolefin; and the like. Hereinafter, the layer (α), the layer (β), the layer (γ), and the layer (δ) will be described in detail.

### Layer (α)

The layer (α) is a layer constituted from the resin composition of the present invention. The lower limit of an average thickness of the layer (α) is not particularly limited, and in light of barrier properties, mechanical strength, and the like, is, with respect to the overall average thickness, preferably 0.5%, more preferably 1.0%, still more preferably 1.5%, and yet more preferably 2.0% or 3.0%. On the other hand, the upper limit of the average thickness of the layer (α) with respect to the overall average thickness is preferably 6.0%, more preferably 5.0%, still more preferably 4.5%, and yet more preferably 4.1%. It is to be noted that unless otherwise specified particularly, the “average thickness” as referred to herein means an average value of thicknesses measured at 10 arbitrary sites.

### Layer (β)

The layer (β) is, for example, laminated on each of an inner face side and an outer face side of the layer (α). The layer (β) may be, for example, a layer containing, as a principal component, a thermoplastic resin in which a solubility parameter calculated from Fedor's equation is 11 (cal/cm³)^{1/2} or less. A resin in which the solubility parameter as calculated in accordance with the above equation is 11 (cal/cm³)^{1/2} or less is superior in terms of moisture resistance. It is to be noted that the “solubility parameter as calculated from Fedor's equation” as referred to herein is a value represented by (E/V)^{1/2}. In the above equation, E represents molecular cohesive energy (cal/mol), and is represented by E=Σei. It is to be noted that ei represents evaporative energy. Furthermore, V represents a molar volume (cm³/mol), and is represented by V=Σvi (vi: molar volume).

Examples of the thermoplastic resin constituting the layer (β) include those exemplified as the thermoplastic resin which can be used in the thermoplastic resin layer in the multilayer structure, described above, and the like. Of these, as the thermoplastic resin constituting the layer (β), the polyethylenes, the ethylene-propylene copolymers, the ethylene-vinyl acetate copolymers, the polypropylenes, and the polystyrenes are preferred.

It is to be noted that with as the thermoplastic resin, a typically commercially available product may be appropriately selected and used. Furthermore, within a range not leading to impairment of the effects of the present invention, the layer (β) may contain other optional component(s).

The lower limit of the average thickness of the layer (β) is not particularly limited, and is, with respect to the overall average thickness, preferably 5%, more preferably 10%, and may be still more preferably 20%, 30%, 40%, or 50%. On the other hand, the upper limit of the average thickness of the layer (β) is not particularly limited, and is, with respect to the overall average thickness, preferably 95%, and may be still more preferably 90%, 80%, or 70%.

### Layer (γ)

The layer (γ) is, for example, provided between the layer (α) and the layer (β). The layer (γ) is a layer containing, as a principal component, a carboxylic acid-modified polyolefin. The layer (γ) can function as an adhesive layer between the layer (α) and another layer, such as the layer (β). Examples of the carboxylic acid-modified polyolefin constituting the layer (γ) include those exemplified as examples of the adhesive resin which can be used in the adhesive resin layer in the multilayer structure, described above, and the like.

It is to be noted that within a range not leading to impairment of the effects of the present invention, the layer (γ) may contain optional component(s).

The lower limit of the average thickness of the layer (γ) is not particularly limited, and is, with respect to the overall average thickness, preferably 0.3%, more preferably 0.6%, still more preferably 1.2%, and yet more preferably 2.0%. The upper limit of the average thickness of the layer (γ) is, with respect to the overall average thickness, preferably 12%, more preferably 9%, and may be still more preferably 6%. When the average thickness of the layer (γ) as the adhesive resin layer is more than or equal to the lower limit, the adhesiveness can be increased. Furthermore, when the average thickness of the layer (γ) is less than or equal to the upper limit, the production cost can be suppressed.

### Layer (δ)

The layer (δ) is a layer which contains an EVOH, a thermoplastic resin, and a carboxylic acid-modified polyolefin. Furthermore, the layer (δ) is preferably formed by using recovered materials of the layer (α), the layer (β), and the layer (γ) in the production step of the thermoformed container. Examples of the recovered material include burrs generated in the production step of the thermoformed container, products which have failed an inspection, and the like. When the thermoformed container further contains the layer (δ) as such a regrind layer, loss of the resin used during production of the thermoformed container can be reduced.

The layer (δ) may be used as a substitute for the layer (β) described above. However, in general, the layer (δ) is preferably used after being laminated with the layer (β), since the layer (δ) usually has less mechanical strength than the layer (β). Taking into consideration that when the thermoformed container is subjected to an external impact, concentration of stress would occur in the container, and in the stress concentration area, a compression stress in response to the impact would be generated on the inner layer side of the container, which may lead to breakage, the layer (δ), which is inferior in strength, is preferably provided so as to be situated on the outer layer side with respect to the layer (α). Moreover, in a case where a large amount of the resin needs to be recycled, e.g., in the case of the generation of a large amount of the burr, the regrind layer as the layer (δ) may be provided on both sides of the layer (α).

The upper limit of a content of the EVOH in the layer (δ) is preferably 9.0% by mass. When the content of the EVOH in the layer (δ) is less than or equal to the upper limit, a crack is unlikely to occur at an interface with other layer(s), and breakage of the overall thermoformed container, originating at this crack, can be inhibited. It is to be noted that the lower limit of the content of the EVOH in the layer (δ) is, for example, 3.0% by mass.

The lower limit of the average thickness of the layer (δ) is not particularly limited, and is, with respect to the overall average thickness, preferably 10%, more preferably 20%, and still more preferably 30%. The upper limit of the average thickness of the layer (δ) is, with respect to the overall average thickness, preferably 60%, more preferably 55%, and still more preferably 50%.

In terms of the layer configuration of the thermoformed container, the layer (β) is preferably provided as an outermost layer. More specifically, providing in an order of: layer (β)/layer (γ)/layer (α)/layer (γ)/layer (β) from the inner surface of the retaining portion to the outer surface of the retaining portion (hereinafter, represented as “(β)/(γ)/(α)/(γ)/(β) from the inner surface to the outer surface”) is preferred in light of the impact resistance. Furthermore, in the case of including the layer (δ), being the regrind layer, examples of the layer configuration include:
(β)/(γ)/(α)/(γ)/(δ)/(β) from the inner surface to the outer surface;
(β)/(δ)/(γ)/(α)/(γ)/(δ)/(β) from the inner surface to the outer surface;
(δ)/(γ)/(α)/(γ)/(δ) from the inner surface to the outer surface; and the like.
   It is to be noted that in these layer configurations, the layer (δ) may be provided in place of the layer (β). As the layer configuration, of these, (β)/(γ)/(α)/(γ)/(δ)/(β) from the inner surface to the outer surface, and (β)/(δ)/(γ)/(α)/(γ)/(δ)/(β) from the inner surface to the outer surface are preferred. It is to be noted that in the case of a construction in which the layer (α) to the layer (δ) are each used in a plurality of number, the resin constituting each layer may be the same or different. Furthermore, the thermoformed container in which the layer (α) is at least one of the innermost layer and the outermost layer is also a mode of the present invention.

### Method for Producing Thermoformed Container

A method for producing the thermoformed container includes: a step of forming a structure having the layer (α), which is constituted from the resin composition; and a step of thermoforming the structure, wherein the resin composition contains: an EVOH (A) having an ethylene unit content of 20 mol % or more and 60 mol % or less; and crotonaldehyde (B1), the resin composition further contains at least one selected from the group consisting of 2,4-hexadienal (B2) and 2,4,6-octatrienal (B3), and the following inequalities (1′) and (2′) are satisfied.

$$2. \leq {b}_{1} / ( {b}_{2} + {b}_{3} ) < 150. \qquad ( 1 ’ )$$

$${b}_{2} + 2 {b}_{3} \leq 0.65 \qquad ( 2 ’ )$$

In the above inequalities (1′) and (2′), b₁ represents a content (ppm) of crotonaldehyde (B1) with respect to the ethylene-vinyl alcohol copolymer (A); b₂ represents a content (ppm) of 2,4-hexadienal (B2) with respect to the ethylene-vinyl alcohol copolymer (A); and b₃ represents a content (ppm) of 2,4,6-octatrienal (B3) with respect to the ethylene-vinyl alcohol copolymer (A).

Specific modes and suitable modes of the resin composition used in the production method are similar to specific modes and suitable modes of the resin composition of the present invention, described above. Hereinafter, details of the production method are described taking the case in which the structure is the multilayer structure as an example.

### Method for Producing Structure

In the case in which the structure used in the thermoformed container is the multilayer structure, a method for producing the multilayer structure is not particularly limited, and examples thereof include an extrusion lamination process, a dry lamination process, an extrusion blow molding process, a coextrusion lamination process, a coextrusion molding process, a coextrusion pipe molding process, a coextrusion blow molding process, a coinjection molding process, a solution coating process, and the like. In light of versatility, the method for producing the multilayer structure is preferably coextrusion molding or coinjection molding, and forming is more preferably performed using a coextrusion molding apparatus. The multilayer body may be formed so as to have a predetermined layer configuration by, for example, charging the resin composition for forming the layer (α), the resin for forming the layer (β), the resin for forming the layer (γ), and the resin composition for forming the layer (δ) into separate extruders, and carrying out coextrusion using these extruders.

The extrusion molding of each layer is carried out by operating an extruder equipped with a single screw at a certain temperature. The temperature for forming the layer (α) is set to, for example, 170° C. or higher and 240° C. or lower. Furthermore, the temperature for forming the layer (β) is set to, for example, 200° C. or higher and 240° C. or lower. Moreover, the temperature for forming the layer (γ) is set to, for example, 160° C. or higher and 220° C. or lower. Moreover, the temperature for forming the layer (δ) is set to, for example, 200° C. or higher and 240° C. or lower.

### Thermoforming

The thermoformed container can be formed by heating the multilayer body of, e.g., the multilayer structure, being the film, sheet, etc., to be softened, and thereafter carrying out forming by molding so as to fit a die shape (thermoforming). The thermoforming procedure is exemplified by: a procedure involving carrying out the molding so as to fit a die shape by means of vacuum or compressed air, which may be used in combination with a plug as needed (a straight process, a drape process, an air slip process, a snap-back process, a plug-assist process, and the like); a procedure involving press molding; and the like. Various molding conditions such as the molding temperature, the degree of vacuum, the pressure of the compressed air, and the molding speed are appropriately selected in accordance with the shape of the plug and/or the die, as well as properties of the film/sheet as a base material, and the like.

The molding temperature is not particularly limited as long as it is a temperature at which the resin can be sufficiently softened for molding, and a suitable range of the temperature may vary in accordance with the configuration of the multilayer structure, being the film, sheet, etc.

In the case of thermoforming the film, it is desired that the film is not exposed to: high temperatures at which melting of the film by heating occurs or the roughness of a metal surface of a heater plate is transferred to the multilayer sheet; or low temperatures at which shaping cannot be sufficiently attained. The lower limit of a specific heating temperature of the film is typically 50° C., preferably 60° C., and more preferably 70° C. The upper limit of the heating temperature of the film is typically 120° C., preferably 110° C., and more preferably 100° C.

On the other hand, in the case of thermoforming the sheet, in comparison to the case of the film, forming at even a high temperature may be possible. The heating temperature of the sheet may be set to, for example, 130° C. or higher and 180° C. or lower.

### Cup-Shaped Container

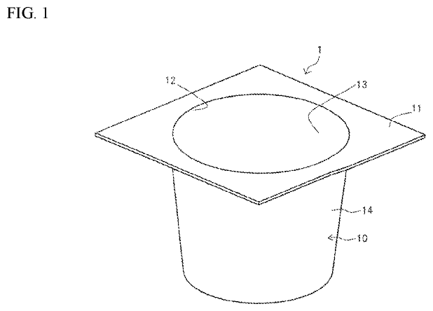

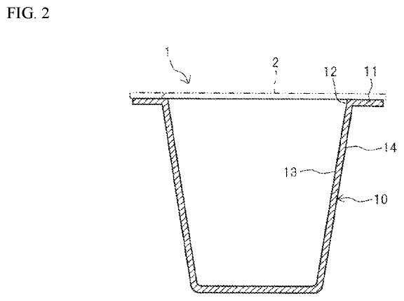

Next, a cup-shaped container shown in FIGS. 1 and 2 will be specifically described by way of an example of the thermoformed container. However, the cup-shaped container is merely an example of the thermoformed container, and the following explanation of the cup-shaped container does not limit the scope of the present invention.

The cup-shaped container 1 shown in FIGS. 1 and 2 includes a cup main body 10 as the retaining portion, and a flange portion 11. The cup-shaped container 1 is used such that contents are retained in the cup main body 10, and a lid 2 is attached to the flange portion 11 so as to seal an opening 12 of the cup main body 10. The sealer is exemplified by a resin film, a metal foil, a metal-resin composite film, and the like, and among these, a metal-resin composite film in which a metal layer is laminated to a resin film is preferred. Examples of the resin film include polyethylene films, polyethylene terephthalate films, and the like. The metal layer is not particularly limited, and is preferably a metal foil or a metal vapor deposition layer, and is more preferably an aluminum foil in light of gas barrier properties and productivity.

The cup-shaped container 1 is obtained by subjecting the multilayer structure having, for example, the film shape, the sheet shape, etc., to thermoforming. It is preferred that the multilayer structure includes at least the layer (α), and an other layer is preferably laminated to the layer (α). The other layer is exemplified by the layer (β), the layer (γ), the layer (δ), and the like.

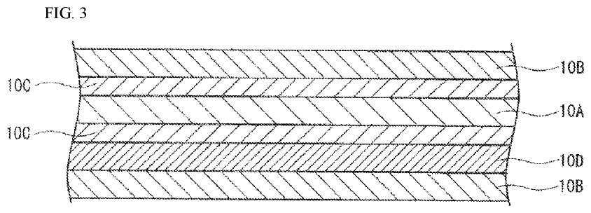

The layer configuration of the cup-shaped container 1 is preferably the configuration shown in FIG. 3. With regard to the layer configuration shown in FIG. 3, the layer (β) 10B is laminated to one face side of the layer (α) TOA (an inner surface 13 side of the cup main body 10 of the cup-shaped container 1) via the layer (γ) 10C, and the layer (δ) 10D and the layer (β) 10B are laminated to the other face side (an outer surface 14 side of the cup main body 10 of the cup-shaped container 1) via the layer (γ) 10C.

### Method for Producing Cup-Shaped Container

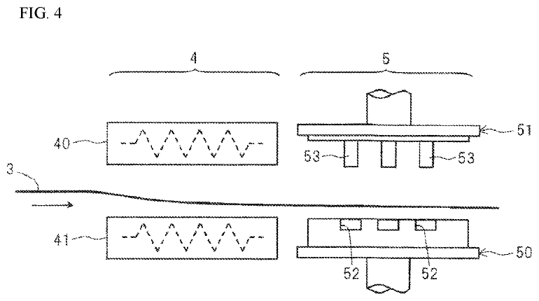

As shown in FIG. 4, the cup-shaped container 1 is produced by heating a continuous multilayer structure 3 having, e.g., a film shape or a sheet shape, by means of a heating apparatus 4 to permit softening, followed by thermoforming by using a die apparatus 5.

The heating apparatus 4 is provided with a pair of heaters 40 and 41, and is configured such that the continuous multilayer structure 3 can be passed between the heaters 40 and 41. It is to be noted that as the heating apparatus 4, an apparatus which performs heating by hot pressing may be used.

The die apparatus 5 is suitable for thermoforming by a plug-assist process, and includes a lower mold half 50 and an upper mold half 51 that are placed in a chamber (not shown in the Figure). The lower mold half 50 and the upper mold half 51 are configured such that they are each independently vertically movable, and in a state of being spaced apart from one another, the continuous multilayer structure 3 can be passed between the lower mold half 50 and the upper mold half 51. The lower mold half 50 includes a plurality of recessed parts 52 for shaping the retaining portion of the cup-shaped container 1. The upper mold half 51 includes a plurality of plugs 53 that protrude toward the lower mold half 50. The plurality of plugs 53 are each provided in the position corresponding to each of the plurality of recessed parts 52 of the lower mold half 50. Each plug 53 can be inserted into the corresponding recessed part 52.

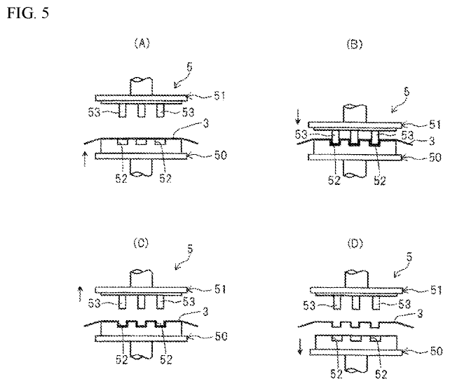

First, as shown in FIGS. 4 and 5(A), the lower mold half 50 is moved upward with respect to the continuous multilayer structure 3 which has been softened using the heating apparatus 4 to bring the softened continuous multilayer structure 3 into close contact with the lower mold half 50, and the continuous multilayer body 3 is somewhat lifted up to apply tension to the continuous multilayer structure 3. Next, as shown in FIG. 5(B), the upper mold half 51 is moved downward, whereby the plugs 53 are inserted into each corresponding recessed part 52.

Subsequently, as shown in FIG. 5(C), the upper mold half 51 is moved upward to separate the plugs 53 from each corresponding recessed part 52, and the inside of the chamber (not shown in the Figure) is evacuated to bring the continuous multilayer structure 3 into close contact with the inner face of the recessed parts 52. Thereafter, the mold is cooled by blowing air thereto to fix the shape. As shown in FIG. 5(D), the inside of the chamber (not shown in the Figure) is then exposed to ambient air and the lower mold half 50 is moved downward to release the lower mold half 50, whereby a primary molded article is obtained. The primary molded article is cut away to give the cup-shaped container 1 shown in FIGS. 1 and 2.

### Other Embodiments of Thermoformed Container

The thermoformed container of the present invention is not limited to the modes described above, and a tray-shaped container is also included in exemplary thermoformed containers. The tray-shaped container can also be produced by a method similar to that of the cup-shaped container, described above. Furthermore, the thermoformed container of the present invention is acceptable as long as it includes at least the layer (α). Specifically, the layer (δ) and the like may be included as a regrind layer. Furthermore, other layer(s) may be laminated. Moreover, the thermoformed container of the present invention may be formed by thermoforming a monolayer structure including only the layer (α) constituted from the resin composition (a). A thermoforming method, a shape of the thermoformed container, and the like in this case may be similar to those of the thermoformed container described above.

### Blow-Molded Container

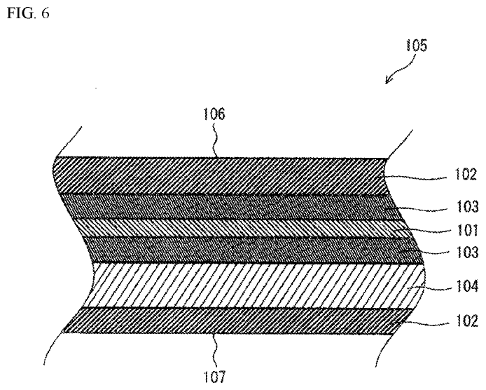

The blow-molded container of the present invention has the layer (α) constituted from the resin composition of the present invention. The blow-molded container can be used for various containers which are required to have gas barrier properties, oil resistance, and the like. The layer (α) of the blow-molded container is formed from the resin composition, which inhibits neck-in and die buildup at the time of melt molding. Thus, the blow-molded container is superior in appearance and impact resistance. Hereinafter, the blow-molded container is specifically described using, as an example, a blow-molded container 105 shown in FIG. 6. It is to be noted that FIG. 6 is a partial cross-sectional view of a peripheral wall of the blow-molded container 105.

The blow-molded container 105 of FIG. 6 has: a layer (α) 101 constituted from the resin composition of the present invention; a layer (β) 102 containing a thermoplastic resin as a principal component; a layer (γ) 103 containing a carboxylic acid-modified polyolefin as a principal component; and a layer (δ) 104 containing an EVOH, a thermoplastic resin, and a carboxylic acid-modified polyolefin.

Specifically, the blow-molded container 105 has a multilayer configuration in which the layer (β) 102, the layer (γ) 103, the layer (α) 101, the layer (γ) 103, the layer (δ) 104, and the layer (β) 102 are laminated in this order, from a container inner surface 106 to a container outer surface 107.

The lower limit of an overall average thickness of the blow-molded container 105 is preferably 300 μm, more preferably 500 μm, and still more preferably 1,000 μm. On the other hand, the upper limit of the overall average thickness of the blow-molded container 105 is preferably 10,000 μm, more preferably 8,500 μm, and still more preferably 7,000 μm. It is to be noted that the “overall average thickness” of the blow-molded container 105 as referred to herein means the average thickness in a trunk part of the blow-molded container 105. When the overall average thickness is less than or equal to than the upper limit, an increase in mass is inhibited, whereby, for example, in a case of use for a fuel container of an automobile or the like, fuel economy can be improved, and production cost can also be controlled. On the other hand, when the overall average thickness is more than or equal to the lower limit, the rigidity can be increased, whereby the blow-molded container 105 becomes unlikely to break easily.

### Layer (α)

The layer (α) is a layer constituted from the resin composition of the present invention. A suitable range of the average thickness of the layer (α) with respect to the overall average thickness in the blow-molded container is the same as the suitable range of the average thickness of the layer (α) with respect to the overall average thickness in the thermoformed container, described above.

### Layer (β)

The layer (β) is laminated to at least one of the inner face side and the outer face side of the layer (α), and is a layer containing, as a principal component, a thermoplastic resin in which a solubility parameter calculated from Fedors equation is 11 (cal/cm³)^{1/2} or less. Specific modes of the layer (β) in the blow-molded container are similar to the specific modes of the layer (β) in the thermoformed container, described above. The layer (β) may be, as in the embodiment shown in FIG. 6, laminated to each of the inner face side and the outer face side of the layer (α), or may be laminated to only one of the inner face side and the outer face side of the layer (α).

### Layer (γ)

The layer (γ) is, for example, a layer which is provided between the layer (α) and the layer (β) and contains a carboxylic acid-modified polyolefin as a principal component. Specific modes of the layer (γ) in the blow-molded container are the same as specific modes of the layer (γ) in the thermoformed container, described above.

### Layer (δ)

The layer (δ) is a layer which contains an EVOH, a thermoplastic resin, and a carboxylic acid-modified polyolefin. Furthermore, the layer (δ) is preferably a layer formed using recovered materials of the layer (α), the layer (β), and the layer (γ) in the production step of the blow-molded container. Specific modes of the layer (δ) in the blow-molded container are similar to specific modes of the layer (δ) in the thermoformed container, described above.

In the case in which the blow-molded container includes the layer (β), the layer (β) may be preferably provided as an outermost layer. In other words, in view of impact resistance, from the inner surface of the container to the outer surface of the container, the arrangement of (inside) β/γ/α/γ/β (outside) is preferred. Furthermore, in the case of including the layer (δ) as the regrind layer or the like, an arrangement of (inside) β/γ/α/γ/δ/β (outside), (inside) β/δ/γ/α/γ/δ/β (outside), or (inside) δ/γ/α/γ/δ (outside) is preferred, and an arrangement of (inside) β/γ/α/γ/δ/β (outside) or (inside) β/δ/γ/α/γ/δ/β (outside) is more preferred. It is to be noted that a configuration which includes the layer (δ) in place of the layer (β) may be adopted, and in the case of an arrangement in which a plurality of each of the layers (α) to (δ) is used, the resin constituting each layer may be the same or different.

Furthermore, the blow-molded container in which the layer (α) is at least one of the innermost layer and the outermost layer is also a suitable mode of the present invention. In the case in which the layer (α) is the innermost layer, the blow-molded container can be suitably used as an organic solvent-resistant container, and the like. In the case in which the layer (α) is the outermost layer, damage to the outer face can be suppressed, and the like. It is to be noted that typically, when the outermost layer of the blow-molded container has aggregates or the like, damage is more likely to occur during transportation, whereby there may be cases of deterioration in the impact resistance and the like. Furthermore, the impact resistance and the like are also susceptible to deterioration in a case in which layer thickness is uneven. However, in the case in which the outermost layer is the layer (α), which is formed from the resin composition, aggregates and the like on the outermost layer are few in number, whereby damage is unlikely to occur during transportation, and furthermore, unevenness in thickness is also inhibited, whereby superior impact resistance and the like can be exhibited. Examples of layer configurations of the blow-molded container in which the layer (α) is at least one of the innermost layer and the outermost layer include (inside) α/γ/β (inside), α/γ/δ/β (outside), (inside) β/γ/α (outside), (inside) β/δ/γ/α (outside), (inside) α/γ/β/γ/α (outside), and the like.

A fuel container is described as one mode of the blow-molded container. The fuel container may be further provided with a filter, a fuel gauge, a baffle plate and the like in addition to the blow-molded container. Due to being provided with the blow-molded container, the fuel container is also superior in gas barrier properties, oil resistance, and the like; therefore, it can be suitably used as a fuel container. The “fuel container” as referred to herein means a fuel container mounted in an automobile, a motorcycle, a watercraft, an airplane, an electric power generator, an industrial or agricultural instrument or the like, or a portable fuel container for supplying the fuel to such a fuel container, as well as a container for retaining the fuel. Further, typical examples of the fuel include gasoline, in particular, oxygen-containing gasoline prepared by blending gasoline with methanol, ethanol, MTBE or the like, and further, heavy oil, light mineral oil, kerosene and the like are also included. The fuel container is particularly suitably used as a fuel container for oxygen-containing gasoline, among these.

A bottle is described as an other mode of the blow-molded container. The bottle may further have structure(s) aside from the blow-molded container, such as a cover film, a cap, and the like. A method for molding the bottle may be exemplified by direct blow molding, injection blow molding, and the like. The blow-molded container molded into a bottle shape can be suitably used as a bottle container for foods, cosmetics, and/or the like.

### Method for Producing Blow-Molded Container

A method for producing the blow-molded container includes a step of performing blow molding using a resin composition, wherein the resin composition contains: an EVOH (A) having an ethylene unit content of 20 mol % or more and 60 mol % or less; and crotonaldehyde (B1), wherein the resin composition further comprises at least one selected from the group consisting of 2,4-hexadienal (B2) and 2,4,6-octatrienal (B3), and the following inequalities (1″) and (2″) are satisfied.

$$2. \leq {b}_{1} / ( {b}_{2} + {b}_{3} ) < 150. \qquad ( 1 ” )$$

$${b}_{2} + 2 {b}_{3} \leq 0.65 \qquad ( 2 ” )$$

In the above inequalities (1″) and (2″), b₁ represents a content (ppm) of crotonaldehyde (B1) with respect to the EVOH (A); b₂ represents a content (ppm) of 2,4-hexadienal (B2) with respect to the EVOH (A); and b₃ represents a content (ppm) of 2,4,6-octatrienal (B3) with respect to the EVOH (A).

Specific modes and suitable modes of the resin composition used in the method for producing the blow-molded container are the same as the specific modes and suitable modes of the resin composition which forms the layer (α) contained in the blow-molded container, described above.

For example, the blow-molded container 105 can be molded by: carrying out the blow molding by using resin composition pellets which form the layer (α) 101, high-density polyethylene or the like which forms the layer (β) 102, carboxylic acid-modified polyolefin or the like which forms the layer (γ) 103, and recovered resin or the like which forms the layer (δ) 104 and using a 4-type, 6-layer parison of, for example, layer (β)/layer (γ)/layer (α)/layer (γ)/layer (δ)/layer (β) in a blow-molding machine at a temperature of 100° C. or higher and 400° C. or lower, and cooling at an internal die temperature of 10° C. or higher and 30° C. or lower for 10 sec or more and 30 min or less, whereby a hollow container having an overall average thickness of 300 μm or more and 10,000 μm or less is obtained.

### Other Embodiments of Blow-Molded Container

The blow-molded container is not limited to the above-described modes, and is acceptable as long as it includes at least the layer (α). Specifically, the layer (δ) and the like may be included as a regrind layer. Furthermore, other layer(s) may be laminated. Moreover, when a combination of resins having favorable adhesiveness is selected, the layer (γ) as the adhesive layer may be omitted. Furthermore, the blow-molded container may be a monolayer blow-molded container constituted from only the layer (α).

### Vapor Deposition Film

The vapor deposition film of the present invention is a vapor deposition film having: a base layer (a) constituted from the resin composition of the present invention; and an inorganic vapor deposition layer (b) provided on at least one face of the base layer (a). The vapor deposition film is used in intended usages for which gas barrier properties are demanded in a variety of fields such as, for example: packaging materials for foods, cosmetics, medical drugs, chemicals, toiletries, and the like; and heat-insulating materials for household electric appliances, homes, and automobiles. The vapor deposition film may, in addition to the above-described layers, also include: an adhesive layer (c); a thermoplastic resin layer (d); a resin coating layer (e); and an other layer. Hereinafter, each layer is described.

### Base Layer (a)

The base layer (a) is a layer constituted from the resin composition of the present invention. Since the resin composition allows for inhibition of neck-in at the time of melt molding, unevenness in thickness of the base layer (a) to be obtained is decreased. Thus, uniformity of the gas barrier properties of the base layer (a) tends to improve, and as a result, uniformity of the gas barrier properties of the vapor deposition film tends to improve. Furthermore, since the resin composition inhibits die buildup at the time of melt molding, vapor deposition flaws in the vapor deposition layer are few in number, and adhesion strength of the inorganic vapor deposition layer increases. As a result, the vapor deposition film enables exhibiting superior gas barrier properties. Moreover, the resin composition results in aggregates, streaks, and the like being unlikely to occur, even when melt molding is repeatedly performed. Thus, the vapor deposition film obtained using the resin composition is also superior in recyclability.

The average thickness of the base layer (a) is not particularly limited, and the lower limit thereof may be, for example, 0.5 μm, 1 μm, 5 μm, 7 μm, or 10 μm. When the average thickness of the base layer (a) is more than or equal to the lower limit, the gas barrier properties can be further improved, and the like. On the other hand, the upper limit of the average thickness may be, for example, 100 μm, 30 μm, 25 μm, or 20 μm. When the average thickness of the base layer (a) is less than or equal to the upper limit, appearance characteristics, recyclability, and the like tend to be favorable.

The upper limit of an oxygen transmission rate of the base layer (a) is preferably 50 mL·20 μm/m²·day·atm, more preferably 10 mL·20 μm/m² day·atm, still more preferably 5 mL·20 μm/m²·day·atm, and particularly preferably 1 mL·20 μm/m²·day·atm.

The base layer (a) is preferably a stretched layer. When the vapor deposition layer has the stretched base layer (a), the gas barrier properties can be further improved, and the like.

The base layer (a) can be, for example, formed as a monolayer film (a base film) constituted from the resin composition of the present invention. A forming method in this case is not particularly limited, and a melting process, a solution process, a calendering process, and the like may be exemplified, of which a melting process is preferred. The melting process is exemplified by a casting process and an inflation process, and of these, a casting process is preferred.

In the case of the film formation by the casting process, stretching may be carried out. The stretching procedure is not particularly limited, and may be any of monoaxial stretching, simultaneous biaxial stretching, and sequential biaxial stretching. The lower limit of the draw ratio on area basis is preferably 8 times, and more preferably 9 times. The upper limit of the draw ratio is preferably 12 times, and more preferably 11 times. When the draw ratio falls within the above range, uniformity of the thickness, gas barrier properties and mechanical strength of the film can be improved.

In the case in which the stretching is carried out, it is preferred that an original piece (the film before stretching) is hydrated beforehand. Accordingly, continuous stretching is facilitated. The lower limit of the moisture content of the original piece before stretching is preferably 2% by mass, more preferably 5% by mass, and still more preferably 10% by mass. The upper limit of the moisture content of the original piece before stretching is preferably 30% by mass, more preferably 25% by mass, and still more preferably 20% by mass.

Although the stretching temperature may somewhat vary depending on the moisture content of the original piece before the stretching, and on the stretching procedure, the stretching temperature is typically 50° C. or higher and 130° C. or lower. In order to obtain a biaxially stretched film accompanied by less stretching unevenness, the stretching temperature is: preferably 70° C. or higher and 100° C. or lower in simultaneous biaxial stretching; preferably 70° C. or higher and 100° C. or lower in stretching along a longitudinal direction with rollers in sequential biaxial stretching; and preferably 80° C. or higher and 120° C. or lower in stretching along a width direction with a tenter.

The base layer (a) may be a layer of a multilayer film (base film) further having other layer(s). For example, the vapor deposition film may be a film having a structure in which an inorganic vapor deposition layer (b) is provided on one face of the base layer (a), and a thermoplastic resin layer (d) is laminated, via the adhesive layer (c), on a side of the base layer (a) opposite to that to which the inorganic vapor deposition layer (b) is provided. In such a case, the multilayer film (base film) having the base layer (a), the adhesive layer (c), and the thermoplastic resin layer (d) laminated in this order can be produced, and then the inorganic vapor deposition layer (b) can be provided on the face of an exposed side of the base layer (a) in this multilayer film. It is to be noted that the multilayer film is not limited to the above-described layer configuration, and may be a film having the base layer (a) as one outermost side, and having one or more other layers. However, the multilayer film preferably has the base layer (a) together with the thermoplastic resin layer (d), and more preferably further has the adhesive layer (c) provided between the base layer (a) and the thermoplastic resin layer (d).

A method for producing the multilayer film is not particularly limited, and examples thereof include coextrusion cast molding, coextrusion inflation molding, coextrusion coat molding, and the like.

An overall thickness of the multilayer film can be appropriately set in accordance with an intended usage thereof. The overall thickness is preferably 10 μm or more, more preferably 13 μm or more, and still more preferably 15 μm or more. When the overall thickness is 10 μm or more, industrial productivity tends to improve. Furthermore, the overall thickness is preferably 300 μm or less, more preferably 200 μm or less, still more preferably 100 μm or less, and particularly preferably 50 μm or less. When the overall thickness is 300 μm or less, industrial productivity tends to improve.

The multilayer film is preferably stretched. In this case, for example, when the multilayer film has at least the base layer (a), the adhesive layer (c), and the thermoplastic resin layer (d), the vapor deposition film to be obtained preferably results from at least the base layer (a), the adhesive layer (c), and the thermoplastic resin layer (d) being stretched as one body. A degree of stretching, as a draw ratio on area basis in at least a monoaxial direction, preferably involves stretching 3 times or more and 12 times or less, more preferably involves stretching 4 times or more and 10 times or less, and still more preferably involves stretching 5 times or more and 8 times or less. When the draw ratio is 3 times or more, the gas barrier properties can be improved. On the other hand, when the draw ratio is 12 times or less, the film appearance can be favorable.

The multilayer film may be stretched, as a draw ratio on area basis in a biaxial direction, 9 times or more and 144 times or less, and is preferably stretched 16 times or more and 100 times or less, and more preferably stretched 25 times or more and 64 times or less. When the draw ratio is 9 times or more, the gas barrier properties can be improved. On the other hand, when the draw ratio is 144 times or less, the film appearance can be favorable.

A method for stretching the multilayer film is not particularly limited, and examples thereof include a tenter stretching process, a tubular stretching process, a roll stretching process, and the like. In light of production cost, successive biaxial stretching or simultaneous biaxial stretching by the tenter stretching process or the tubular stretching process is preferred. Furthermore, in light of equipment cost, monoaxial stretching by the roll stretching process is preferred. Moreover, in the case in which the multilayer film is an inflation molded body, in light of enabling easily subjecting the multilayer film, having a cylindrical shape and being folded after the inflation molding, to stretching in a monoaxial direction, the roll stretching process is preferred.

### Inorganic Vapor Deposition Layer (b)

The inorganic vapor deposition layer (b) is provided for principally ensuring the gas barrier properties of the vapor deposition film. The inorganic vapor deposition layer (b) is provided on the base layer (a). The inorganic vapor deposition layer (b) may be provided either on both faces of the base layer (a), or on only one face of the base layer (a), but may be preferably provided on both faces of the base layer (a). By providing the inorganic vapor deposition layer (b) on both faces of the base layer (a), the gas barrier properties are more improved, and stability of the gas barrier can be attained. More specifically, even if a flaw is generated on one inorganic vapor deposition layer (b) resulting from physical impact or the like, gas barrier properties as a vapor deposition film would be suitably maintained due to another inorganic vapor deposition layer (b) maintaining the barrier properties.

The inorganic vapor deposition layer (b) can be formed by vapor-depositing an inorganic substance. As the inorganic substance, a metal (for example, aluminum), a metal oxide (for example, silicon oxide and aluminum oxide), a metal nitride (for example, silicon nitride), a metal oxide nitride (for example, silicon oxynitride), and a metal carbide nitride (for example, silicon carbonitride) may be exemplified. Of these, in light of industrial productivity, the inorganic vapor deposition layer (b) being formed from aluminum oxide, silicon oxide, magnesium oxide, or silicon nitride is preferred, and aluminum is more preferred.

It is to be noted that even in the case of the aluminum vapor deposition layer, oxidation may irreversibly occur, whereby aluminum oxide is contained in a part thereof. In the case in which the inorganic vapor deposition layer (b) contains aluminum oxide in a part thereof, a ratio (Oₘₒₗ/Alₘₒₗ) of a substance amount of oxygen atoms to the substance amount (Alₘₒₗ) of aluminum atoms constituting the inorganic vapor deposition layer (b) is preferably 0.5 or less, more preferably 0.3 or less, still more preferably 0.1 or less, and particularly preferably 0.05 or less.

The lower limit of the average thickness of the inorganic vapor deposition layer (b) is preferably 15 nm, more preferably 20 nm, still more preferably 30 nm, and particularly preferably 40 nm. The upper limit of the average thickness of the inorganic vapor deposition layer (b) is preferably 150 nm, more preferably 130 nm, and still more preferably 80 nm. When the average thickness of the inorganic vapor deposition layer (b) is more than or equal to the lower limit, the gas barrier properties and the like can be further improved. On the other hand, when the average thickness of the inorganic vapor deposition layer (b) is less than or equal to the upper limit, for example, a thermal bridge can be inhibited, and a heat insulation effect can be enhanced. It is to be noted that in a case in which the inorganic vapor deposition layer (b) is constituted from a plurality of layers, it is preferred that the average thickness of each layer falls within the above range. In a case in which the inorganic vapor deposition layer (b) is constituted from a plurality of layers, an overall thickness of the inorganic vapor deposition layer (b) is preferably 1 μm or less.

The lower limit of the average particle diameter of vapor deposition particles such as aluminum particles in the inorganic vapor deposition layer (b) is not particularly limited, and preferably 10 nm, more preferably 15 nm, and still more preferably 20 nm. On the other hand, the upper limit of the average particle diameter of the vapor deposition particles is preferably 150 nm, more preferably 125 nm, still more preferably 100 nm, particularly preferably 75 nm, and most preferably 50 nm. The average particle diameter of the vapor deposition particles as herein referred to means an averaged value obtained by observing the surface of the inorganic vapor deposition layer (b) with a scanning electron microscope, determining maximum diameters of a plurality of vapor deposition particles present along an identical direction (maximum diameter in a certain direction), and dividing the sum of the maximum diameters by the number of particles measured. In addition, in the case where the vapor deposition particles form particle aggregates, the average particle diameter means the particle size of the vapor deposition particles forming the particle aggregates (primary particle size).

In the case of forming the inorganic vapor deposition layer (b) on the base layer (a), it is possible to form the inorganic vapor deposition layer (b) having the average particle diameter of the vapor deposition particles of 150 nm or less by satisfying any one of the following requirements.
(1) The surface temperature of the base layer (a) in vapor deposition is kept at 60° C. or lower.
(2) The content of volatiles included in the base layer (a) before the vapor deposition is regulated to 1.1% by mass or less.
(3) The surface of the base layer (a) before the vapor deposition is modified by subjecting to a plasma treatment.

Of these, it is preferred that the requirement (1) is satisfied, and is more preferred that in addition to the requirement (1), at least one of the requirement (2) and the requirement (3) is satisfied.

The upper limit of the surface temperature of the base layer (a) in carrying out the vapor deposition is, as described above, preferably 60° C., more preferably 55° C., and still more preferably 50° C. In addition, the lower limit of the surface temperature of the base layer (a) in the vapor deposition is not particularly limited, but is preferably 0° C., more preferably 10° C., and still more preferably 20° C.

The lower limit of the content of the volatiles included in the base layer (a) before the vapor deposition is not particularly limited, and is preferably 0.01% by mass, more preferably 0.03% by mass, and still more preferably 0.05% by mass. The upper limit of the content of the volatiles is preferably 1.1% by mass, more preferably 0.5% by mass, and still more preferably 0.3% by mass. The content of the volatiles may be determined in a similar manner to the content of the volatiles in the vapor deposition film, to be described later, from a change in mass before and after drying at 105° C. for 3 hrs.

As the procedure for the plasma treatment of the surface of the base layer (a) before the vapor deposition, a well-known procedure can be used, and an atmospheric-pressure plasma treatment is preferred. In this atmospheric-pressure plasma treatment, examples of the discharge gas include a nitrogen gas, helium, neon, argon, krypton, xenon, radon, and the like. Of these, nitrogen, helium and argon are preferred, and in light of the cost reduction, nitrogen is more preferred.

### Adhesive Layer (c)

The vapor deposition film preferably further has the adhesive layer (c), and the thermoplastic resin layer (d) being laminated to this adhesive layer (c). The adhesive layer (c) is more preferably directly laminated to the base layer (a). More specifically, it is more preferable that the base layer (a), the adhesive layer (c), and the thermoplastic resin layer (d) are laminated in this order without having other layer(s) therebetween. Furthermore, at a time of recycling the vapor deposition film, when the adhesive layer (c) is present, compatibility between the EVOH (A) in the base layer (a) and the thermoplastic resin in the thermoplastic resin layer (d) can be improved, resulting in a tendency to improve recyclability; thus, in light of this point as well, the vapor deposition film preferably has the adhesive layer (c).

The adhesive layer (c) is preferably a layer formed from an adhesive resin. As the adhesive resin, using a polyolefin having a carboxy group, a carboxylic anhydride group, or an epoxy group is preferred. Such an adhesive resin is also superior in adhesiveness between the base layer (a) and the like, and the thermoplastic resin layer (d). Examples of the adhesive resin include those exemplified as the adhesive resin used in the optional adhesive resin layer which constitutes the multilayer structure of the present invention.

A melt flow rate (MFR) of the adhesive resin constituting the adhesive layer (c) at a temperature of 190° C. under a load of 2,160 g, measured in accordance with JIS K 7210: 2014, is preferably 0.1 g/10 min or more and 20.0 g/10 min or less, and more preferably 1.0 g/10 min or more and 10.0 g/10 min or less. When the MFR of the adhesive resin falls within the above range, film-forming stability during molding tends to be favorable.

In light of industrial productivity and quality stability, the average thickness of the adhesive layer (c) is preferably 0.5 μm or more and 20 μm or less, and more preferably 1 μm or more and 10 μm or less. In a case in which the vapor deposition film has a plurality of the base layer (a) and the thermoplastic resin layer (d), a case in which the vapor deposition film has an EVOH layer or the like which is different from the base layer (a), or the like, the adhesive layer (c) may be provided between each layer, and the number of layers of the adhesive layer (c) in the vapor deposition film is not particularly limited.

### Thermoplastic Resin Layer (d)

When the vapor deposition film contains the thermoplastic resin layer (d), mechanical strength can be improved. Furthermore, when film forming is performed in multiple layers with the base layer (a), there is a tendency to enable reducing a film thickness of the base layer (a), and consequently, recycling of the vapor deposition film tends to be easier. Moreover, characteristics such as heat sealing properties, mechanical strength, and the like can be imparted according to the type of the thermoplastic resin constituting the thermoplastic resin layer (d).

Examples of the thermoplastic resin used in the thermoplastic resin layer (d) include those exemplified as the thermoplastic resin used in the optional thermoplastic resin layer which constitutes the multilayer structure of the present invention, and the like.

A content of the thermoplastic resin in the thermoplastic resin layer (d) is preferably 80% by mass or more, more preferably 90% by mass or more, still more preferably 95% by mass or more, and particularly preferably 98% by mass or more, and the thermoplastic resin layer (d) may be constituted from substantially solely the thermoplastic resin, or may be constituted from solely the thermoplastic resin.

A melt flow rate (MFR) of the thermoplastic resin constituting the thermoplastic resin layer (d) at a temperature of 190° C. under a load of 2,160 g, measured in accordance with JIS K 7210: 2014, is preferably 0.10 g/10 min or more and 10.0 g/10 min or less, and more preferably 0.30 g/10 min or more and 5.0 g/10 min or less. When the MFR of the thermoplastic resin falls within the above range, film-forming stability tends to be favorable.

In light of industrial productivity and mechanical strength, the average thickness of the thermoplastic resin layer (d) is preferably 5 μm or more and 200 μm or less, more preferably 7 μm or more and 100 μm or less, and still more preferably 10 μm or more and 50 μm or less. It is to be noted that in a case of the vapor deposition film having a plurality of layers of the thermoplastic resin layer (d), a total of thicknesses thereof may preferably fall within the above range.

In the vapor deposition film, the thermoplastic resin layer (d) may be provided as one layer or a plurality of layers. As a method for providing the adhesive resin (c) and the thermoplastic resin layer (d) in the vapor deposition film, various well-known production methods may be employed, and a dry-laminating process, a sand-laminating process, an extrusion-laminating process, a coextrusion-laminating process, a solution-coating process, and/or the like may be adopted. Furthermore, the thermoplastic resin layer (d) may be a layer constituting the stretched or unstretched multilayer film, may be a layer produced separately from the multilayer film and laminated thereto, or may be both of these. Moreover, in the case of the vapor deposition film having a plurality of the thermoplastic resin layer (d), constitutions thereof may be the same or different, and both a stretched layer and an unstretched layer may be included.

### Resin Coating Layer (e)

The resin coating layer (e) is provided for inhibiting the damage of the inorganic vapor deposition layer (b) resulting from flexion and the like in the film processing such as lamination, for example, in the step following the production of the vapor deposition film. According to the vapor deposition film provided with such a resin coating layer (e), deterioration of the gas barrier properties can be inhibited. The resin coating layer (e) may contain, for example, a vinyl alcohol polymer (an ethylene-vinyl alcohol copolymer, polyvinyl alcohol, etc.), and as needed, a swellable inorganic layered silicate may be also contained.

The swellable inorganic layered silicate improves the strength of the resin coating layer (e). Examples of the swellable inorganic layered silicate include swellable montmorillonite, swellable synthetic smectite, swellable fluorinemica minerals, and the like. The lower limit of the content of the swellable inorganic layered silicate with respect to the vinyl alcohol polymer in the resin coating layer (e) is not particularly limited, and in terms of the solid content equivalent, the lower limit of the content is preferably 0.5% by mass, more preferably 1% by mass, still more preferably 3% by mass, and particularly preferably 5% by mass. On the other hand, the upper limit of the content of the swellable inorganic layered silicate with respect to the vinyl alcohol polymer in the resin coating layer (e) is not particularly limited, and in terms of the solid content equivalent, the upper limit of the content is preferably 55% by mass, more preferably 40% by mass, still more preferably 30% by mass, and particularly preferably 20% by mass. When the content of the swellable inorganic layered silicate is less than the lower limit, the strength of the resin coating layer (e) may not be sufficiently improved. On the other hand, when the content of the swellable inorganic layered silicate is more than the upper limit, flexibility of the resin coating layer (e) is impaired, and thus defects such as cracks may be likely to be generated.

The lower limit of the average thickness of the resin coating layer (e) is not particularly limited, but is preferably 0.001 μm in order to obtain effective gas barrier properties. On the other hand, the upper limit of the average thickness of the resin coating layer (e) is not particularly limited, but is preferably 10 μm, and more preferably 2 μm.

Although the procedure for laminating the resin coating layer (e) on the inorganic vapor deposition layer (b) is not particularly limited, a coating process, and a laminating process are preferred. Examples of the coating process include: a direct gravure process; a reverse gravure process; a micro gravure process; roll coating processes such as a two-roll bead coating process and a bottom feed three-roll reverse coating process; a doctor knife process; a die coating process; a dipping coating process; a bar coating process; a combination thereof; and the like. In addition, an interface between the inorganic vapor deposition layer (b) and the resin coating layer (e) may have undergone a corona treatment or a treatment with an anchor coating agent or the like.

### Other Layer(s), Etc.

The other layer(s) which may be included in the vapor deposition film is/are exemplified by a paper layer, a metal leaf layer, and the like. Furthermore, the vapor deposition film may have a vapor deposition layer other than the inorganic vapor deposition layer (b). The vapor deposition layer may, for example, be provided on the thermoplastic resin layer (d), with the thermoplastic resin layer (d) as a base. As component(s) constituting the vapor deposition layer, well-known components used as vapor deposition layers may be appropriately used.

Examples of a layer configuration of the vapor deposition film may include, e.g.:
(1) a/b;
(2) d/c/a/b;
(3) d/c/d/c/α/b;
(4) d/c/a/b/c/d;
(5) d/c/d/c/a/b/c/d;
(6) a/b/e;
(7) d/c/a/b/e;
(8) d/c/d/c/a/b/e;
(9) d/c/d/c/a/b/e/c/d;
(10) d/c/a/b/e/c/d; and
(11) a/b/c/d.

It is to be noted that a represents the base layer, b represents the inorganic vapor deposition layer, c represents the adhesive layer, d represents the thermoplastic resin layer, and e represents the resin coating layer.

For example, the portion having the layer configuration of “d/c/a” in (2) and the like above may be formed as a multilayer film (base film) such as that described above. The portion being the multilayer film may be stretched or unstretched. In the case in which the multilayer film consisting of the layer configuration of “d/c/a” is stretched, the portion having the layer configuration of “d/c/a” in the vapor deposition film is stretched as one body. Furthermore, for example, in (3) above, the portion having the layer configuration of “d/c/d/c/a” may be formed as a multilayer film, or may be a layer configuration in which only the portion having the layer configuration of “d/c/a” is formed as a multilayer film, and the thermoplastic resin layer (d) is further laminated thereon via the adhesive resin (c), being separate.

The average thickness of the vapor deposition film is not particularly limited, and the lower limit thereof may be, for example, 5 μm, 10 μm, 13 μm, or 15 μm. On the other hand, the upper limit of the average thickness may be, for example, 300 μm, 200 μm, 100 μm, or 50 μm. A shape of the vapor deposition film is not particularly limited as long as it has a laminated structure.

The upper limit of the oxygen transmission rate of the vapor deposition film measured at 40° C., with a humidity of 90% RH on the inorganic vapor deposition layer (b) side, and with a humidity of 0% RH on the base layer (a) side is preferably 5 mL/m² day·atm, more preferably 3 mL/m²·day·atm, still more preferably 2 mL/m²·day·atm, particularly preferably 1 mL/m² day·atm, and further particularly preferably 0.1 mL/m² day·atm. When the oxygen transmission rate is less than or equal to the upper limit, a time period during which a degree of vacuum can be maintained in the internal space of the container, etc., formed from the packaging material that includes the vapor deposition film can be prolonged. The term oxygen transmission rate (mL/m²·day·atm) as referred to herein means a value obtained by dividing the amount of oxygen (mL) that transmits the vapor deposition film, by: the vapor deposition film area (m²); the transmission time period (day(s)); and the difference (atm) between the oxygen gas pressure on one face side, and the oxygen gas pressure on the other face side of the vapor deposition film. Specifically, the oxygen transmission rate being, for example, “5 mL/m²·day·atm or less” indicates that under the difference in pressure of the oxygen gas of 1 atmospheric pressure, 5 mL of oxygen is transmitted per 1 m² of the film per day. In addition, in the case in which the inorganic vapor deposition layer (b) is provided on both faces of the base layer (a), the oxygen transmission rate is to be measured at 40° C., with a humidity of 90% RH on one inorganic vapor deposition layer (b) side, and a humidity of 0% RH on the other inorganic vapor deposition layer (b) side.

The lower limit of a content of volatiles included in the vapor deposition film is not particularly limited, and is preferably 0.01% by mass, more preferably 0.03% by mass, and still more preferably 0.05% by mass. The upper limit of the content of the volatiles is preferably 1.1% by mass, more preferably 0.5% by mass, and still more preferably 0.3% by mass.

However, in the case in which the vapor deposition film is applied to a vacuum insulator, the content of the volatiles in the vapor deposition film is preferably as low as possible. The reason for such a feature is that volatiles generated from the vapor deposition film penetrate into a vacuum area of the vacuum insulator, and consequently, the degree of vacuum inside the vacuum insulator decreases, whereby thermal insulation performance may deteriorate.

Herein, the content of the volatiles may be determined from a change of the mass before and after drying at 105° C. for 3 hrs, according to the following equation.

$$Content of volatiles ( \% by mass ) = [ ( ( mass before drying ) - ( mass after drying ) / ( mass after drying ) ] \times 100$$

The vapor deposition film preferably has a configuration which results in superiority in recyclability. In recent years, with the impetus of environmental issues and waste issues, demands for so-called post-consumer recycling, being the recovering and recycling of packaging materials that have been consumed on the market (hereinafter, may be simply abbreviated to “recycling”) has risen worldwide. In recycling, a process in which recovered packaging materials are cut and, as needed, sorted and washed, and then melted and mixed using an extruder is typically employed.

Here, polyester films, polyamide films, and the like are difficult to uniformly mix with other components in the melting and mixing process at the time of recovering and recycling, resulting in an obstacle to recycling. Therefore, in light of enhancing recyclability, polyesters and polyamides are preferably not substantially contained in the thermoplastic resin layer (d). Specifically, a content of polyesters and polyamides in the thermoplastic resin layer (d) is preferably 10% by mass or less, more preferably 1% by mass or less, and particularly preferably substantially 0%. Furthermore, a content of polyesters and polyamides in the vapor deposition film is preferably 10% by mass or less, more preferably 1% by mass or less, and particularly preferably substantially 0%.

Furthermore, in light of the recyclability, a proportion of the thermoplastic resin layer (d) accounted for by polyolefins such as polyethylene and polypropylene is preferably 80% by mass or more, more preferably 90% by mass or more, and still more preferably 99% by mass. Similarly, a proportion of the vapor deposition film accounted for by polyolefins is preferably 80% by mass or more, and more preferably 90% by mass or more. Moreover, a proportion of the vapor deposition film accounted for by EVOH is preferably 20% by mass or less, and more preferably 10% by mass or less. On the other hand, the proportion of the vapor deposition film accounted for by EVOH may be 0.1% by mass or more, or may be 1% by mass or more. When such a structure or constitution is adopted, the recyclability can increase, and furthermore, influences on mechanical properties of the composition after recycling tend to be lessened.

Due to the same reason of recyclability, in the vapor deposition film, when the thermoplastic resin layer (d) contains the polyolefins, an overall thickness of the thermoplastic resin layer (d) with respect to a thickness of total layers in the vapor deposition film may be preferably 50% or more, may be more preferably 80% or more, and may be still more preferably 90% or more. Furthermore, the overall thickness of the base layer (a) with respect to the thickness of the total layers in the vapor deposition film may be preferably 20% or less, and may be more preferably 10% or less. On the other hand, the overall thickness of the base layer with respect to the thickness of the total layers in the vapor deposition film may be, for example, 0.1% or more, or may be 1% or more.

Furthermore, due to the base layer (a) being formed from a certain resin composition, the recyclability of the vapor deposition film improves, and the appearance and the like of a molded product obtained through recycling is favorable. Although not necessarily clarified, the reason therefor is presumed to be that the resin composition, in which the neck-in and the die buildup are inhibited at the time of melt molding, has superior heat stability, whereby aggregates, streaks, and the like are unlikely to occur, even when melt molding is repeatedly performed for recycling.

The vapor deposition film has superior gas barrier property uniformity, few vapor deposition flaws, and superior adhesion strength of the inorganic vapor deposition layer, thereby having superior gas barrier properties. Thus, the vapor deposition film can be applied to various intended usages. Examples of intended usages of the vapor deposition film include: various packaging materials such as food packaging, medical drug packaging, industrial chemical packaging, and pesticide packaging; vacuum insulators; and the like.

### Packaging Material

The packaging material of one embodiment of the present invention includes the vapor deposition film. The packaging material may, for example, be formed by subjecting the vapor deposition film, a multilayer structure including the same, or the like to secondary processing. The packaging material is superior in gas barrier properties due to including the vapor deposition film.

The packaging material may be formed by, for example, providing at least one other layer on the vapor deposition film. Examples of the other layer include a polyester layer, a polyamide layer, a polyolefin layer, a paper layer, an inorganic vapor deposition film layer, an EVOH layer, an adhesive layer, and the like. The number of layers in the packaging material and an order of providing these is not particularly limited, but in a case of performing heat sealing, at least the outermost layer is heat sealable. It is to be noted that in a case in which the packaging material is configured as a laminate tube container, described later, or the like, the polyolefin layer may contain a pigment.

The packaging material of the present invention is used for packaging, for example, foods; beverages; chemicals such as pesticides and medical drugs; industrial materials such as medical equipment, machine parts, and precision materials; clothes; and the like. In particular, the packaging material is preferably used in an intended usage for which barrier properties against oxygen are necessary, and in an intended usage in which an interior of the packaging material will be replaced by various types of functional gas.

The packaging material is formed into a variety of shapes according to the intended usage, for example, into a vertical form fill seal pouch, a vacuum wrapping bag, a spout-attached pouch, a laminate tube container, a lid material for a container, and the like.

### Vertical Form Fill Seal Pouch

The vertical form fill seal pouch is used for wrapping a food, beverage, or the like being a liquid, viscous matter, powder, solid bulk, or a combination of the same, for example.

The vertical form fill seal pouch is formed by heat sealing the vapor deposition film. In the case of performing the heat sealing, typically, it is necessary to provide a heat-sealable layer as a layer situated on an inner side of the vertical form fill seal pouch, or both the layer situated on the inner side and a layer situated on the outer side of the vertical form fill seal pouch, of the vapor deposition film. In the case in which the heat sealable layer is situated only on the inner side of the vertical form fill seal pouch, typically, a body portion is sealed by lap sealing. In the case in which the heat sealable layer is situated on both the inner side and the outer side of the vertical form fill seal pouch, typically, the body portion is sealed by wrap sealing. The heat-sealable layer is preferably a polyolefin layer (hereinafter, may be also referred to as “PO layer”). It is to be noted that the PO layer is an example of a thermoplastic resin layer.

A layer configuration of the vertical form fill seal pouch is preferably: vapor deposition film/polyamide layer/PO layer; vapor deposition film/PO layer; or PO layer/vapor deposition film film/PO layer, and an adhesive layer may be provided between layers. Furthermore, in a case in which the vapor deposition film in which the inorganic vapor deposition layer (b) is formed only on one face of the base layer (a) is applied, the vapor deposition film may be either provided such that the inorganic vapor deposition layer (b) is arranged on an outer side with respect to the base layer (a), or may be provided such that the inorganic vapor deposition layer (b) is arranged on an inner side with respect to the base layer (a).

### Vacuum Wrapping Bag

The vacuum wrapping bag is used for intended usages in which wrapping in a vacuum state is desired, for example, storage of foods, beverages, and the like. The layer configuration of the vacuum wrapping bag is preferably: vapor deposition film/polyamide layer/PO layer; or polyamide layer/vapor deposition film/PO layer, and an adhesive layer may be provided between layers. By virtue of including the vapor deposition film, such a vacuum wrapping bag is particularly superior in gas barrier properties after vacuum wrapping, and after heat sterilization is performed following the vacuum wrapping.

### Spout-Attached Pouch

The spout-attached pouch is used for wrapping liquid substances, for example, liquid beverages such as cooling beverages, jelly beverages, yogurts, fruit sauces, seasonings, functional water, liquid foods, and the like. The layer configuration of the spout-attached pouch is preferably: vapor deposition film/polyamide layer/PO layer; or polyamide layer/vapor deposition film/PO layer, and an adhesive layer may be provided between layers. By virtue of including the vapor deposition film, such a spout-attached pouch is superior in gas barrier properties. Thus, the spout-attached pouch can prevent the contents from deteriorating even after transportation and/or after storage for a long time period.

### Laminate Tube Container

The laminate tube container is used for wrapping, for example, cosmetics, chemicals, medical drugs, foods, toothpastes, and the like. The layer configuration of the laminate tube container is preferably: PO layer/vapor deposition film/PO layer; or PO layer/pigment-containing PO layer/PO layer/vapor deposition film/PO layer, and an adhesive layer may be provided between layers. By virtue of including the vapor deposition film, such a laminate tube container is superior in gas barrier properties.

### Lid Material for Container

The lid material for a container is a lid material for a container in which a food such as processed meat, processed vegetables, processed seafood, fruit, or the like is to be packed. The layer configuration of the lid material for a container is preferably: vapor deposition film/polyamide layer/PO layer; or vapor deposition film/PO layer, and an adhesive layer may be provided between layers. By virtue of including the vapor deposition film, such a lid member for a container is superior in gas barrier properties, and a deterioration in quality of the foods as contents can be inhibited for a long time period.

### Vacuum Insulator

The vacuum insulator of one embodiment of the present invention includes the vapor deposition film. The vacuum insulator is used for intended usages in which cold keeping or warmth keeping is necessary. In an exemplary vacuum insulator, a core material such as polyurethane foam is charged in a vacuum state into an external packing material. The external packing material is formed by, for example, laminating the vapor deposition film with at least one other layer to form a pair of laminated films, and then performing heat sealing.

Examples of the other layer include a polyester layer, a polyamide layer, a polyolefin layer, an adhesive layer, and the like, and a polyolefin layer that is a heat-sealable layer is preferably included.

Although the number of layers and the order of lamination in the external packing material are not particularly limited, it is preferred that the heat sealable layer (for example, a polyolefin layer) is provided as the outermost layer. The layer configuration of the external packing material is preferably: vapor deposition film/polyamide layer/PO layer; or polyamide layer/vapor deposition film/PO layer, and an adhesive layer may be provided between layers. Furthermore, in a case in which the vapor deposition film in which the inorganic vapor deposition layer (b) is formed only on one face of the base layer (a) is applied, the vapor deposition film may be either provided such that the inorganic vapor deposition layer (b) is arranged on an outer side with respect to the base layer (a), or may be provided such that the inorganic vapor deposition layer (b) is arranged on an inner side with respect to the base layer (a).

By virtue of including the external packing material having the vapor deposition film, the vacuum insulator is superior in gas barrier properties. Thus, the vacuum insulator can retain a heat insulation effect for a long time period, and therefore can be used in: heat insulating materials for household electric appliances such as refrigerators, hot water supply equipment, and rice cookers; heat insulating materials for housing used in walls, ceilings, lofts, floors, etc.; vehicle roofing materials; thermal insulation panels of vending machines, etc., and the like.

### EXAMPLES

Hereinafter, the present invention is explained in further detail by way of Examples, but the present invention is not in any way limited to the Examples.

### Evaluation Methods

### (1) Measurements of Ethylene Unit Content and Degree of Saponification

A crude dry EVOH obtained was dried at 120° C. for 12 hrs with a vacuum-drying apparatus. The vacuum-dried EVOH was dissolved in dimethyl sulfoxide (DMSO)-d6 containing tetramethylsilane as an internal standard substance, and trifluoroacetic acid (TFA) as an additive, and measurement was conducted by using ¹H-NMR (“GX-500,” manufactured by JEOL, Ltd.) of 500 MHz at 80° C., to determine the ethylene unit content and the degree of saponification from a peak intensity ratio of the ethylene units, the vinyl alcohol units, and the vinyl ester units.

### (2) Sodium Ion Content, Phosphoric Acid Content, and Boric Acid Content

Into a Teflon (registered trademark) pressure container, 0.5 g of the dried resin composition pellets obtained was charged, and 5 mL of concentrated nitric acid was added thereto, whereby the dried resin composition pellets were decomposed at room temperature for 30 min. After a lapse of 30 min, the container was covered with a lid, and a heat treatment was carried out at 150° C. for 10 min and a subsequent heat treatment was carried out at 180° C. for 5 min, by using a wet degradation device (“MWS-2,” manufactured by Actac Project Service Corporation) to permit degradation, and then the mixture was cooled to room temperature. The treatment liquid thus obtained was transferred to a 50 mL volumetric flask (TPX (registered trademark)) and diluted with pure water. Metals contained in the solution were analyzed by using an ICP optical emission spectrophotometer (“OPTIMA4300DV,” manufactured by PerkinElmer Inc.), whereby the contents of the sodium ion (sodium element), the phosphoric acid, and the boric acid were measured. The content of the phosphoric acid in terms of a phosphate radical equivalent, and the content of the boric acid in terms of orthoboric acid were calculated. It is to be noted that in the quantitative determination, in each case, a calibration curve created by using a commercially available standard solution was used.

### (3) Acetic Acid Content

Into 100 mL of ion exchanged water was charged 20 g of the dried resin composition pellets obtained, followed by thermal extraction at 95° C. for 6 hrs. The extracted liquid was subjected to neutralization titration with 1/50 N NaOH using phenolphthalein as an indicator, whereby the content of acetic acid was quantitatively determined.

### (4) Melt Flow Rate (MFR)

The dry resin composition pellets obtained were packed into a cylinder of the melt indexer L244 (manufactured by Takara Kogyo Co., Ltd.), the cylinder having an inner diameter of 9.55 mm and a length of 162 mm; melting was performed at 210° C.; and then an even load was applied on the melted resin composition by using a plunger having a mass of 2,160 g and a diameter of 9.48 mm. An amount of the resin composition extruded from an orifice with a diameter of 2.1 mm provided in the center of the cylinder was measured per unit time (g/10 min), and this was defined as the MFR.

### (5) Quantitative Determination of Crotonaldehyde, 2,4-Hexadienal, and 2,4,6-Octatrienal

A sample obtained by freeze-grinding 0.50 g of the dried resin composition pellets was weighed out to 50.0 mg in a glass tube for a thermal desorption-gas chromatograph/mass spectrometer to produce a sample tube. Using the following thermal desorption-gas chromatograph/mass spectrometer, the sample was heated under the below conditions to adsorb a total amount of volatile gas once from the sample into an adsorption tube, and then gas re-discharged from the adsorption tube was separated into columns and peaks for each component were detected. Calibration curves were created from peak areas of standard samples of crotonaldehyde, 2,4-hexadienal, and 2,4,6-octatrienal, and quantitative determination was carried out for each by the absolute calibration curve method. It is to be noted that in measuring the standard samples, the standard samples were made to permeate into the adsorption tube (“Tenax” (registered trademark), manufactured by Carboxen (registered trademark)), and the absorption tube in which the standard samples had permeated was used in place of the sample tube to measure a temperature during the discharge after the sample adsorption by a method similar to that in the case of measuring the sample tubes, except that the sample tube temperature of 170° C. was changed to an adsorption tube temperature of 260° C.

### Thermal Desorption Portion

Apparatus: TurboMatrix-ATD (manufactured by PerkinElmer Japan Co., Ltd.)

Temperature when adsorbing sample into adsorption tube: 170° C. (sample tube), −30° C. (adsorption tube), 250° C. (bulb), 260° C. (transfer line)

Time period of adsorption into adsorption tube: 10 min

Temperature at time of discharge after sample adsorption: 170° C. (sample tube), 260° C. (adsorption tube), 250° C. (bulb), 260° C. (transfer line)

Time period of adsorption tube discharge: 35 min

Carrier gas: flow rate of carrier gas into helium column: 1.0 ml/min

Pressure: 120 kPa

Gas chromatography/mass spectrometry portion

Apparatus: 7890B GC System, 7977B MSD (Agilent Technologies)

Column: DB-WAX UI (length: 30 m; internal diameter: 0.25 mm; film thickness: 0.50 μm)

Column oven temperature: maintaining at 40° C. for 5 min, then temperature control to 240° C. at rate of temperature rise of 10° C./min and maintenance for 10 min (total measured temperature: 35 min)

Transfer line (connecting portion) temperature: 240° C.

Ionization condition: EI+

Detected ion mass range: m/z=29-600

Detection method: SCAN

Standard samples

Crotonaldehyde: manufactured by Aldrich

2,4-hexadienal: manufactured by Aldrich

2,4,6-octatrienal: manufactured by NARD Institute, Ltd.

### (6) Quantitative Determination of Sorbic Acid and Myrcene

The dried resin composition pellets obtained were subjected to freeze grinding, and then 22 g of a ground product was packed into a Soxhlet extractor, and extraction processing was performed for 16 hrs by using 100 mL of chloroform. Amounts of sorbic acid and myrcene in the chloroform extraction liquid obtained were quantitatively analyzed by high performance liquid chromatography to determine contents of sorbic acid and myrcene in the resin composition. It is to be noted that in the quantitative determination, calibration curves created by using authentic samples of sorbic acid and myrcene were used.

### (7) Evaluation of Die Buildup

The dried resin composition pellets obtained were discharged from an extruder under the following conditions, die buildup (die lip deposition) on a die periphery (die lip) after 60 min was visually confirmed, and an evaluation was performed in accordance with the following criteria. In the case of A to D, it was assessed that the die buildup was able to be inhibited.

### Extruder Conditions

Apparatus: 20 mmφ single-screw extruder (D2020, manufactured by Toyo Seiki Seisaku-sho, Ltd.)
L/D: 20
Screw: full flight
Screen mesh: 50 mesh/100 mesh/50 mesh
Die: φ 1 mm, 1 hole
Temperature settings: C1/C2/C3/D=180° C./220° C./220° C./220° C.
Discharge amount: 1.44 kg/h
Rotation speed: 100 rpm

### Evaluation: Assessment Criteria

A (favorable): Die lip deposition was not observed.
B (somewhat favorable): A very small amount of die lip deposition was observed.
C (fair): A small amount of die lip deposition was observed.
D (somewhat unfavorable): Die lip deposition was observed.
E (unfavorable): A large amount of die lip deposition was observed.

### (8) Evaluation of Hue

A yellowing index (YI) value of the dried resin composition pellets obtained was measured and calculated in accordance with JIS K7373: 2006 using LabScan XE, manufactured by Hunter Associates Laboratory, Inc. The numerical value being smaller indicates yellowing being inhibited, and was assessed as superiority in hue.

### (9) Evaluation of Neck-In Resistance During Film Formation

The dried resin composition pellets obtained were used to extrude the resin composition through a single-screw extruder under the following conditions, and then a width, at a position 100 mm from a lip (discharge opening of T-die), of a melted resin (melt curtain) discharged from the T-die 10 min after charging the dried resin composition pellets was measured. The width of the melted resin was evaluated in accordance with the following criteria. In the case of A to C, it was assessed that the neck-in was able to be inhibited.

### Extruder Conditions

Extruder: L/D=26; 40 mmφ single-screw extruder
Screw: full flight
Screw rotation speed: 50 rpm
Screw mesh: 50 mesh/100 mesh/50 mesh
Die shape: T shape, lip width 550 mm, lip interval 0.7 m
Preset temperature: C1/C2/C3/D=170° C./240° C./260° C./260° C.

### Evaluation: Assessment Criteria

A (favorable): 85% or more of lip width
B (somewhat favorable): 82.5% or more and less than 85% of lip width
C (somewhat unfavorable): 80% or more and less than 82.5% of lip width
D (unfavorable): less than 80% of lip width

### (10) Measurement of Melting Point

The crude dry EVOH obtained was dried at 120° C. for 12 hrs with a vacuum-drying apparatus. A melting point of the vacuum-dried EVOH was determined by using a differential scanning calorimeter, “Q2000,” manufactured by TA Instruments, Inc., based on a peak temperature measured by a secondary temperature elevation after elevating a temperature of the vacuum-dried EVOH from 30° C. to 250° C. at a rate of 10° C./min and cooling at 50° C./min.

### (11) Measurement of Oxygen Transmission Rate (OTR)

Using the dried resin composition pellets obtained, film formation was performed with D2020, a 20 mmφ single-screw extruder manufactured by Toyo Seiki Seisaku-sho, Ltd., under the following conditions to give a monolayer film having an average thickness of 20 μm.

### Extruder Conditions

L/D: 20
Screw: full flight
Die width: 30 cm
Temperature of drawing roll: 80° C.
Screw rotation speed: 40 rpm
Roll drawing speed: 3.0 to 3.5 m/min
Preset temperature: C1/C2/C3/D=170° C./230° C./230° C./230° C.

The monolayer film having the average thickness of 20 μm thus obtained was conditioned under conditions of 20° C. and 65% RH. Thereafter, an oxygen transmission rate at conditions of 20° C. and 65% RH was measured by using an oxygen transmission rate measurement device (“OX-Tran 2/20,” manufactured by Modern Controls. Inc.) in accordance with ISO 14663-2 annex C.

### (12) Evaluation of Thermoformability (A)

An appearance evaluation was performed on a bottom of a thermoformed container using the dried resin composition pellets obtained. By using the dried resin composition pellets as a resin composition material, “Novatec (registered trademark) PP EA7AD” polypropylene (PP) as an other thermoplastic resin material, and “Admer (registered trademark) QF500” acid-modified polypropylene as an adhesive layer, a multilayer structure of 5 layers selected from 3 types (PP/Adl/resin composition layer/Adl/PP=368 μm/16 μm/32 μm/16 μm/368 μm) was obtained under the following conditions. It is to be noted that as a film forming apparatus, after an extruder having a film forming die, the multilayer structure obtained was wound by a winding machine having a drawing roll which can control temperature.

### Film Forming Conditions

EVOH Extruder: single-screw extruder (ME-type CO-EXT extruder for laboratory use, manufactured by Toyo Seiki Seisaku Co., Ltd.)

Port diameter: 20 mmφ, L/D: 20, screw: full flight type

Feeding zone/compression zone/metering zone/die=175/210/220/230° C.

PP Extruder: single-screw extruder (GT-32-A, manufactured by Research Laboratory of Plastics Technology Co., Ltd.)

Port diameter: 32 mmφ, L/D: 28, screw: full flight type

Feeding zone/compression zone/metering zone/die=170/200/210/230° C.

Adl Extruder: single-screw extruder (SZW20GT-20MG-STD, manufactured by Technovel Corporation)

Port diameter: 20 mmφ, L/D: 20, screw: full flight type Feeding zone/compression zone/metering zone/die=150/200/230/230° C.

Die: 300 mm width coat hanger die (manufactured by Research Laboratory of Plastics Technology Co., Ltd.)

Temperature of drawing roll: 80° C.

A sheet for thermoforming was cut out to 80 mm², centered on a site 50 mm from an end of the multilayer structure obtained, and was used as a measurement sample for an end. Furthermore, a separate sheet for thermoforming was cut out such that a center of a sheet width was a center of the sample, and was used as a measurement sample for a central portion. Each measurement sample thus obtained was subjected to thermoforming (involving using compressed air: 5 kg/cm²; plug: 45 φ×65 mm; syntax form; die temperature: 40° C.) into a cup shape (die shape: 70 φ×70 mm; draw ratio S=1.0) using a thermoforming machine (FKS-0632-20 compact multifunction pressure and vacuum forming machine, manufactured by Asano Laboratories Co. Ltd.) at a sheet temperature of 150° C. to produce a thermoformed container. A bottom of each container produced was evaluated in accordance with the following criteria by visual inspection. Furthermore, in cases in which the evaluation of the end was poorer than the evaluation of the central portion, there was a tendency for the evaluation of neck-in resistance during film formation of the evaluation method (9) to be poor. Based on this tendency, it can be assessed that owing to the neck-in resistance of the dried resin composition pellets being inferior, the thermoformability of the end of the multilayer structure had deteriorated.

### Evaluation: Assessment Criteria

A: Uniform, with no unevenness observed
B: Streaky unevenness was slightly observed
C: Streaky unevenness was somewhat observed
D: Unevenness was severely observed

### (13) Measurement of Oxygen Transmission Rate (OTR) of Central Portion of Film Monolayer Film Production Conditions

A monolayer film having an average thickness of 20 μm was obtained by film forming the dried resin composition pellets obtained, under the following conditions.

### Extruder Conditions

L/D=26; 40 mmφ single-screw extruder
Screw: full flight
Screw rotation speed: 30 rpm
Screw mesh: 50 mesh/100 mesh/50 mesh
Die shape: T shape, lip width 550 mm, lip interval 0.7 mm
Preset temperature: C1/C2/C3/D=170° C./230° C./230° C./230° C.
Temperature of drawing roll: 80° C.
Speed of roll drawing: 10 to 11 m/min

### OTR (Oxygen Transmission Rate) Measurement

From the monolayer film having the average thickness of 20 μm thus obtained was cut out a sample having a circular shape and a diameter of 90 mm, with a center in a thickness direction being the center, and the sample was conditioned under conditions of 20° C. and 65% RH. Thereafter, the oxygen transmission rate at conditions of 20° C. and 65% RH was measured using an oxygen transmission rate measurement device (“OX-Tran 2/20,” manufactured by Modern Controls. Inc.) at a lower detection limit of 0.01 mL (m²·day·atm) in accordance with ISO 14663-2 annex C.

### (14) Width Direction Uniformity of OTR

From the monolayer film used in the measurement of (13) was cut out a sample having a circular shape and a diameter of 90 mm, centered on a site 70 mm from a film end, and the OTR was measured under the same conditions as in (13). A difference with respect to the OTR of the central portion sample was determined, and a magnitude of the difference was evaluated by the three levels of A to C.

### Evaluation: Assessment Criteria

A: difference being less than 10%
B: difference being 10% or more and less than 15%
C: difference being 15% or more

### (15) Measurement of Inorganic Vapor Deposition Layer Thickness

### (15-1) Production of Biaxially Stretched Film

The dried resin composition pellets obtained were melted at 240° C. with a single-screw extruder, and concurrently with extrusion on casting rolls from a die, air was blown at a rate of 30 m/sec by using an air knife to obtain an unstretched film having an average thickness of 170 μm. The unstretched film thus obtained was brought into contact with hot water at 80° C. for 10 sec, and by using a tenter-type simultaneous biaxial stretching machine, the film was stretched 3.2 times in the machine direction and 3.0 times in the width direction in an atmosphere of 90° C. Furthermore, the stretched film was subjected to a heat treatment in the tenter at 170° C. for 5 sec. Then the film edge was cut away to obtain a roll of biaxially stretched film (average thickness of 12 μm, width of 50 cm, roll length of 4,000 m).

### (15-2) Production of Vapor Deposition Film

A vapor deposition film was obtained by using batch-type vapor deposition equipment “EWA-105,” manufactured by ULVAC, Inc., on the biaxially stretched film obtained as described above to allow vapor deposition of aluminum on one side of the film, at a film surface temperature of 38° C. and a film traveling speed of 200 m/min.

### (15-3) Measurement of Inorganic Vapor Deposition Layer

The vapor deposition film was cut with a microtome to expose a cross section. This cross section was observed using “ZEISS ULTRA 55”, a scanning electron microscope (SEM) manufactured by SII Nano Technology, and the average thickness of the inorganic vapor deposition layer was measured by using a backscattered electron detector.

### (16) Evaluation of Vapor Deposition Flaw-Inhibiting Property

The roll of the vapor deposition film obtained as described above was applied to a slitter, and was unwound while illuminating with fluorescent light at 100 W from beneath the film. The number of vapor deposition flaws was counted at 10 different sites, each with an area having a width of 0.5 m and a length of 2 m, and the average value of the number of vapor deposition flaws per m² was determined. Based on the number of vapor deposition flaws, a vapor deposition flaw-inhibiting property was evaluated in accordance with the following criteria.

### Evaluation: Assessment Criteria

A: 0 to 50 flaws/m²
B: 51 to 100 flaws/m²
C: 100 or more flaws/m²

### (17) Measurement of Adhesion Strength (A)

The vapor deposition film obtained as described above was cut out to A4 size, on a surface of the inorganic vapor deposition layer side, coating with an adhesive for dry lamination (an ethyl acetate solution having a solid content concentration of 23% by mass, prepared by mixing “TAKELAC (registered trademark) A-385/TAKENATE (registered trademark) A-50,” manufactured by Mitsui Chemicals, Inc., in a mass ratio of δ/1) was performed by using a bar coater, and after hot-air drying at 50° C. for 5 min, lamination with a PET film (E5000, manufactured by Toyobo Co., Ltd.) was carried out with nip rolls which had been heated to 80° C. In this step, half of the film was provided with a part not being laminated, by sandwiching an aluminum foil between the inorganic vapor deposition layer and the PET film. Then, a laminated film was obtained after aging at 40° C. for 72 hours. The laminated film thus obtained was cut into a short strip of 100 mm×15 mm with the aluminum vapor deposition interface being at a center thereof. Of the short strip thus obtained, an end of the laminate and the PET film at a part which was not laminated was held, and a T-peel test was carried out 5 times by a tensile tester (“AUTOGRAPH AGS-H,” manufactured by Shimadzu Corporation) at a tensile rate of 10 mm/min. An average value of the resulting measurement values was defined as the adhesion strength, and an evaluation was performed in accordance with the following criteria.

### Evaluation: Assessment Criteria

A: 500 g/15 mm or more;
B: 350 g/15 mm or more and less than 500 g/15 mm;
C: less than 350 g/15 mm

### (18) Evaluation of Breakage Resistance

The biaxially stretched film (average thickness of 12 μm, width of 50 cm, roll length of 4,000 m) produced in the above evaluation method (15-1) was produced such that there were 100 rolls, and the biaxially stretched film thus obtained was applied to a slitter and wound while imparting a tension of 100 N/m to the film rolls. The breakage resistance was evaluated in accordance with the following criteria based on the number of times of breakage at this time.

### Evaluation: Assessment Criteria

A: 0 times to once/100 rolls;
B: twice to 4 times/100 rolls;
C: 5 to 7 times/100 rolls;
D: 8 to 10 times/100 rolls;
E: 11 times or more/100 rolls

### (19) Quantitative Determination of Nonionic Surfactant

The resin composition pellets thus obtained at a content of 10 g were dissolved in 1,1,1,3,3,3-hexafluoro-2-propanol, and then the solvent was added dropwise to methanol. This liquid was concentrated after filtering through a filter and removing deposited matter. The concentrated liquid thus obtained was measured using “UPLC H-Class,” manufactured by Waters Corporation, to determine a content of the nonionic surfactant (E) in the resin composition pellets. It is to be noted that in the quantitative determination, calibration curves produced using each nonionic surfactant were used.

### (20) Discharge Amount Evaluation Test

A monolayer film having an average thickness of 20 μm was obtained by subjecting the dried resin composition pellets obtained to film forming under the following conditions. A rate of production of the monolayer film per hour at this time was evaluated as the discharge amount of the resin composition.
Apparatus: 20 mmφ single-screw extruder (D2020, manufactured by Toyo Seiki Seisaku-sho, Ltd.)
L/D: 20
Screw: full flight
Die width: 30 cm
Temperature of drawing roll: 80° C.
Screw rotation speed: 40 rpm
Preset temperature: C1/C2/C3/D=160° C./180° C./210° C./210° C.

### (21) Oxidative Degradation Resistance

### Production of Monolayer Film

A monolayer film having an average thickness of 20 μm was obtained by subjecting the dried resin composition pellets obtained to film forming under the following conditions.
Apparatus: 20 mmφ single-screw extruder (D2020, manufactured by Toyo Seiki Seisaku-sho, Ltd.)
L/D: 20
Screw: full flight
Die width: 30 cm
Temperature of drawing roll: 80° C.
Screw rotation speed: 40 rpm
Speed of roll drawing: 3.0 to 3.5 m/min
Preset temperature: C1/C2/C3/D=180° C./210° C./210° C./210° C.

Each monolayer film obtained as described above was evaluated on change of tensile strength over time by measuring, under the following evaluation conditions, a plurality of samples in which heat treatment time periods were changed. The time period for the elongation at break to become ¼ of the sample in which heat treatment is not performed was determined and set as an indicator for oxidative degradation resistance.

### Evaluation Conditions:

The monolayer film was treated in a hot-air dryer for a predetermined time period and set to 140° C., and then removed. After that, the monolayer film was immersed in 20° C. water for 5 days, surface water was wiped away, the monolayer film was left to stand in a room at 20° C. and 65% RH for 2 weeks, and then the tensile strength was measured in accordance with the following conditions.

### Measurement Conditions:

Sample width: 15 mm
Interval between chucks: 30 mm
Tensile speed: 50 mm/min
Measurement atmosphere: 20° C., 65% RH

In the above evaluation, deterioration of the gas barrier properties of the EVOH layer owing to the generation of cracks due to oxidative deterioration becomes significant when the elongation at break becomes ¼ or lower; thus, the time period for the elongation at break to become ¼ can be considered as an indicator of lifespan due to oxidative degradation of the EVOH at a high temperature. The time period for the elongation at break to become ¼ shows an Arrhenius-type temperature dependency, and if the time period (lifespan) until the elongation at break becomes ¼ at 80° C. is assumed as 100 years or more, the time period until the elongation at break becomes ¼ at 140° C. must be set to 210 hrs or more.

### (22) Evaluation of Gas Barrier Properties of Pipe

### Production of Multilayer Pipe

High-density polyethylene (“Yukaron Hard BX-50,” manufactured by Mitsubishi Chemical Corporation; density of 0.952 g/cc, MFR of 0.5 g/10 min) at a content of 100 parts by mass, vinyltrimethoxysilane dissolved in acetone at a content of 2 parts by mass, and dicumylperoxide at a content of 0.2 parts by mass were mixed. The mixture was extruded in a strand shape at 230° C. with a single screw to give pellets of modified polyethylene having 1.5% by mass vinylsilane added. Next, a blend resulting from 5 parts by mass of the high-density polyethylene blended with 2% by mass dibutyltin dilaurate being blended with 100 parts by mass of these pellets was fed into a first extruder, each of the resin composition pellets obtained in the Examples or the Comparative Examples was fed into a second extruder, and furthermore, “Admer NF 408E,” manufactured by Mitsui Chemicals, Inc. Co. Ltd., as an adhesive resin was fed into a third extruder. By using a circular die for 3 layers each selected from 3 types, extrusion molding into a multilayer pipe having an external diameter of 20 mm was performed, followed by immediately thereafter, cooling to solidify through a cooling water bath which had been adjusted to 40° C. A layer configuration of the multilayer pipe included the resin composition layer as the outermost layer, with the resin composition layer/the adhesive resin layer/the high density polyethylene layer=100 μm/100 μm/2,000 μm. The multilayer pipe thus obtained was cut to 1 m and inserted into a hot-air dryer at 140° C. and heated for 10 min, and then subjected to a bending treatment in which a central region thereof was bent 90° along a stainless steel pipe having an external diameter of 150 mm and hardened for 5 min.

### Measurement of OTR (Oxygen Transmission Rate)

The oxygen transmission rate before a heat treatment was measured under conditions of 20° C. and 65% RH by using a silicone rubber plug and an adhesive to seal one end of the multilayer pipe produced, and connecting the other end to an oxygen transmission rate measurement device (“OX-Tran 10/50A,” manufactured by Modern Controls. Inc.)

Next, the multilayer pipe was inserted into a hot-air dryer at 100° C. and subjected to a heat treatment for 216 hrs. Using the multilayer pipe after the heat treatment, the oxygen transmission rate after the heat treatment was measured by the above-described method.

### (23) Evaluation of Pipe Die Buildup

Die buildup (die lip deposition) on a die periphery (die lip) after 60 min at the time of the multilayer pipe production in “(22) Evaluation of Gas Barrier Properties of Pipe”, described above, was visually confirmed, and an evaluation was performed in accordance with the following criteria. In the case of A to D, it was assessed that the die buildup was able to be inhibited.

### Evaluation: Assessment Criteria

A (favorable): Die lip deposition was not observed.

B (somewhat favorable): A very small amount of die lip deposition was observed.
C (fair): A small amount of die lip deposition was observed.
D (somewhat unfavorable): Die lip deposition was observed.
E (unfavorable): A large amount of die lip deposition was observed.

### (24) Evaluation of Thermoformability (B)

An appearance evaluation was performed on a bottom of each thermoformed container using the dried resin composition pellets obtained. First, a multilayer structure was obtained by the same procedure as that in “(12) Evaluation of Thermoformability (A)”, described above.

A sheet for thermoforming was cut out such that a center of a sheet width of the multilayer structure obtained was a center of the sample. Thermoforming (compressed air: 5 kg/cm²; plug: 45 φ×65 mm; syntax form; die temperature: 40° C.) into a cup shape ((a) die shape: 70 φ×35 mm; draw ratio S=0.5, or (b) die shape: 70 φ×70 mm; draw ratio S=1.0) using a thermoforming machine (FKS-0632-20 compact multifunction pressure and vacuum forming machine, manufactured by Asano Laboratories Co. Ltd.) at a sheet temperature of 150° C. to produce a thermoformed container. The bottom of each container produced was evaluated in accordance with the following criteria by visual inspection.

### Evaluation: Assessment Criteria

A: Uniform, with no unevenness observed
B: Streaky unevenness was slightly observed
C: Streaky unevenness was somewhat observed
D: Unevenness was severely observed

### (25) Evaluation of Appearance of Blow-Molded Container

By visual inspection, aggregates and die lines were confirmed on each tank obtained, and the appearance was evaluated in accordance with the following criteria.

### Evaluation: Assessment Criteria

A (favorable): no aggregates or die lines confirmed;
B (somewhat favorable): slight aggregates confirmed; no die lines confirmed;
C (unfavorable): many aggregates and die lines confirmed in bottle

### (26) Evaluation of Transportation of Blow-Molded Container

The tanks obtained were loaded into a cardboard box in an arrangement of 3 tanks vertically and 4 tanks horizontally, in an upright state. The cardboard box in which these tanks were loaded was transported a distance of 1,200 km by freight truck. The tanks after the transportation were packed with 0.45 L of propylene glycol, and the openings were heat-sealed with a film having a configuration of polyethylene 40 μm/aluminum foil 12 μm/polyethylene terephthalate 12 μm to give a lid. These tanks were cooled at −40° C. for 3 days, and then dropped from a height of 6 m such that the openings were up. The impact resistance was evaluated by the number of tanks which broke (n=10).

### Evaluation: Assessment Criteria

A (favorable): less than 3 tanks
B (somewhat favorable): 3 tanks or more and less than 6 tanks
C (unfavorable): 6 tanks or more

### (27) Evaluation of Impact Resistance of Blow-Molded Container

### Preparation of Recovered Resin

Four parts by mass of the dried resin composition pellets (resin composition) obtained, 86 parts by mass of a high-density polyethylene resin (“HZ8200B,” manufactured by Mitsui Petrochemical Industries, Inc., MFR=0.01 g/10 min at 190° C. under load of 2,160 g, solubility parameter=8.5), and 10 parts by mass of an adhesive resin (“ADMER GT-6A,” manufactured by Mitsui Chemicals, Inc., MFR=0.94 g/10 min at 190° C. under load of 2,160 g) were dry blended, and then a resulting mixture was extruded by using a twin-screw extruder (“2D25W,” manufactured by Toyo Seiki Seisaku-sho, Ltd.; 25 mmφ, die temperature: 220° C., screw rotation speed: 100 rpm) in a nitrogen atmosphere, whereby pellets were obtained. In order to obtain a model recovered resin, the extrusion pellets thus obtained were further subjected to extrusion with the same extruder under the same conditions to conduct pelletization. This operation was performed 4 times (blending in the extruder was repeated 5 times in total) to obtain the model recovered resin.

### Production of Blow-Molded Container Having EVOH as Innermost Layer

Using the dried resin composition pellets (resin composition) obtained, the high-density polyethylene resin, the adhesive resin, and the model recovered resin, blow-molded containers of 4 layers each selected from 4 types, each having a layer configuration of (inner side) resin composition (EVOH)/adhesive resin/recovered resin/high-density polyethylene (outer side) were produced with “MSD-C44A/43R-AP (C2),” a blow molding machine manufactured by Tahara Machinery Ltd at 210° C., and subjected to evaluation. It is to be noted that in the production of the blow-molded containers, a temperature in the die was set to 15° C. and cooling was performed for 20 sec to obtain 1 L tanks having an overall average thickness of 1,500 μm ((inner side) resin composition (EVOH)/adhesive resin/recovered resin/high-density polyethylene (outer side)=(inner side) 50/100/400/950 μm (outer side)). A diameter of a bottom of each tank obtained was 75 mm, and a height thereof was 200 mm.

The blow-molded 1 L tanks were packed with 0.95 L of propylene glycol, and the openings were heat-sealed with a film having a configuration of polyethylene 40 μm/aluminum foil 12 μm/polyethylene terephthalate 12 μm to give a lid. This tank was cooled at −40° C. for 3 days, and then dropped from a height of 6 m such that the opening was up. The impact resistance was evaluated by the number of tanks which broke (n=10).

### Evaluation: Assessment Criteria

A (favorable): less than 3 tanks
B (somewhat favorable): 3 tanks or more and less than 6 tanks
C (unfavorable): 6 tanks or more

### (28) Measurement of Adhesion Strength (B)

The vapor deposition films obtained were cut out to A4 size, on a surface of the inorganic vapor deposition layer side, coating with an adhesive for dry lamination (an ethyl acetate solution having a solid content concentration of 23% by mass, prepared by mixing “TAKELAC (registered trademark) A-385/TAKENATE (registered trademark) A-50,” manufactured by Mitsui Chemicals, Inc., in a mass ratio of δ/1) was performed by using a bar coater, and after hot-air drying at 50° C. for 5 min, lamination with a PET film (E5000, manufactured by Toyobo Co., Ltd.) was carried out with nip rolls which had been heated to 80° C. In this step, half of the film was provided with a part not being laminated, by sandwiching an aluminum foil between the inorganic vapor deposition layer and the PET film. Then, a laminated film was obtained after aging at 40° C. for 72 hours. The laminated film thus obtained was cut into a short strip of 100 mm×15 mm with the boundary with the aluminum vapor deposition being centered. Of the short strip thus obtained, an end of the laminate and the PET film at a part which was not laminated was gripped, and a T-peel test was carried out 5 times by a tensile tester (“AUTOGRAPH AGS-H,” manufactured by Shimadzu Corporation) at a tensile rate of 10 mm/min. An average value of the resulting measurement values was defined as the adhesion strength, and an evaluation was performed in accordance with the following criteria.

### Evaluation: Assessment Criteria

A: 400 g/15 mm or more;
B: 300 g/15 mm or more and less than 400 g/15 mm;
C: less than 300 g/15 mm

### (29) Measurement of OTR (Oxygen Transmission Rate) of Vapor Deposition Film

Using the vapor deposition films obtained, the oxygen transmission rate was measured with the inorganic vapor deposition layer (b) as an oxygen supply side, and the thermoplastic resin layer (d) as a carrier gas side. Specifically, using an oxygen transmission rate measurement device (“OX-Tran 2/21,” manufactured by Modern Controls. Inc.; lower detection limit of 0.01 mL/(m²·day·atm)), the oxygen transmission rate (unit: mL (m² day·atm)) was measured under conditions involving a temperature of 20° C., a humidity on the oxygen supply side of 65% RH, a humidity on the carrier gas side of 65% RH, oxygen pressure of 1 atmosphere, and carrier gas pressure of 1 atmosphere. As the carrier gas, nitrogen gas containing 2% by volume hydrogen gas was used. The results were evaluated by the following three levels of A to C.

### Evaluation: Assessment Criteria

A: less than 0.10 mL/(m²·day·atm)
B: 0.10 mL/(m²·day·atm) or more and less than 0.50 mL/(m²·day·atm)
C: 0.50 mL/(m²·day·atm) or more and less than 2.0 mL/(m²·day·atm)

### (30) Evaluation of Recyclability

The multilayer structures obtained were pulverized to a size of 4 mm² or less and made into a monolayer film under the extrusion conditions described below to obtain monolayer films having an average thickness of 20 μm.

### Extrusion Conditions

Extruder: single-screw extruder, manufactured by Toyo Seiki Seisaku-sho, Ltd.

Screw diameter: 20 mmφ (L/D=20, compression ratio=3.5, full flight type)

Extrusion temperature: C1/C2/C3/D=190° C./230° C./230° C./230° C.

Temperature of drawing roll: 80° C.

The monolayer films obtained were confirmed by visual inspection and evaluated on the recyclability in accordance with the following criteria.

### Evaluation: Assessment Criteria

A: no aggregates or streaks confirmed;
B: small aggregates and/or slight streaks confirmed;
C: a large amount of aggregates and/or clear streaks confirmed

### Synthesis Example 1

Into a 200 L pressurized reactor equipped with a jacket, a stirrer, a nitrogen-feeding port, an ethylene-feeding port, and an initiator addition port, 75.0 kg of vinyl acetate (hereinafter, may be also referred to as VAc) and 7.2 kg of methanol (hereinafter, may be also referred to as MeOH) were charged, and the reaction liquid was bubbled with a nitrogen gas for 30 min so as to execute nitrogen replacement inside the reactor. Then, the temperature in the reactor was regulated to 65° C., ethylene was introduced into the reactor so as to give a reactor pressure (ethylene pressure) of 4.13 MPa, and 9.4 g of 2,2′-azobis(2,4-dimethylvaleronitrile) (“V-65,” manufactured by FUJIFILM Wako Pure Chemical Corporation) as a polymerization initiator was added to start polymerization. During the polymerization, the ethylene pressure was maintained at 4.13 MPa and the polymerization temperature was maintained at 65° C. Four hrs later, when the conversion (rate of polymerization) of VAc reached 49.7%, cooling was performed, and a solution in which 0.2 g of copper acetate was dissolved in 20 kg of methanol was charged into the reactor to stop the polymerization. The reactor was opened to evacuate ethylene, and then a nitrogen gas was bubbled into the reaction liquid to completely remove ethylene. Next, the polymerization liquid was removed from the reactor, and diluted with 20 L of MeOH. This liquid was fed from a top of a column-shaped container and MeOH vapor was fed from the bottom of the column, whereby an unreacted monomer that remained in the polymerization liquid was eliminated with the MeOH vapor, to give an MeOH solution of an ethylene-vinyl acetate copolymer (hereinafter, may be also referred to as EVAc).

Next, into a 300 L reactor equipped with a jacket, a stirrer, a nitrogen-feeding port, a reflux condenser, and a solution addition port, 150 kg of a 20% by mass MeOH solution of EVAc was charged. A temperature of the solution was raised to 60° C. while bubbling nitrogen gas thereinto, and a MeOH solution having a sodium hydroxide concentration of 2 N was added for 2 hrs at a rate of 450 mL/min. After completion of adding the MeOH sodium hydroxide solution, a saponification reaction proceeded by stirring for 2 hrs while keeping the temperature in the system at 60° C. and draining MeOH and methyl acetate generated by the saponification reaction outside the reactor. Thereafter, 8.7 kg of acetic acid was added to terminate the saponification reaction.

Thereafter, MeOH was allowed to flow outside the reactor by adding 120 L of ion exchanged water while the mixture was heated at 80° C. with stirring, whereby precipitation of the EVOH was permitted. The EVOH precipitated by decantation was collected, and ground with a grinder. The EVOH powder obtained was charged into a 1 g/L aqueous acetic acid solution (bath ratio of 20:proportion of 1 kg of the powder to 20 L of the aqueous solution), and was washed for 2 hrs with stirring. This was deliquored, and further charged into a 1 g/L aqueous acetic acid solution (bath ratio of 20), and washed for 2 hrs with stirring. An operation of charging this, having been deliquored, in ion exchanged water (bath ratio of 20) and stirring and washing for 2 hrs, and then deliquoring, was carried out 3 times to perform refinement. An electrical conductivity of the washing liquid was 3 μs/cm (measured with “CM-30ET,” manufactured by DKK-TOA Corporation). Next, the refined substance obtained was immersed for 4 hrs in 250 L of an aqueous solution containing 0.5 g/L of acetic acid and 0.1 g/L of sodium acetate with stirring and then deliquored, followed by drying at 60° C. for 16 hrs to give 16.1 kg of crude dry EVOH.

The operation related to the above-described EVOH synthesis was repeated to give 15.9 kg of crude dry EVOH, whereby a total of 32.0 kg of crude dry EVOH (A1) was obtained. An ethylene unit content, a degree of saponification, and a melting point of the crude dry product of the EVOH (A1) were measured in accordance with the procedures described in the evaluation methods (1) and (10) above. The results are shown in Table 2.

### Synthesis Examples 2 to 8

Crude dry products of each of EVOH (A2) to EVOH (A8) were obtained by a similar operation to that of Synthesis Example 1, except that the size of the pressurized reactor tank, the charging amount of VAc and MeOH, the ethylene pressure, the amount of addition of the polymerization initiator, the temperature inside the reactor tank (the temperature during the polymerization), the polymerization time period, the conversion rate of VAc, the charging amount of the MeOH solution of EVAc in the saponification step, and the rate of addition of the MeOH solution of sodium hydroxide were as shown in Table 1, and each synthesis was performed only once. The ethylene unit content, the degree of saponification, and the melting point of the crude dry products of each of the EVOH (A2) to EVOH (A8) were measured in accordance with the procedures described in the evaluation methods (1) and (10) above. The results are shown in Table 2.

### Synthesis Example 9

EVOH (A9) pellets were produced by using an apparatus disclosed in paragraph [0158] and FIG. 1 of Japanese Unexamined Patent Application, Publication No. 2003-231715, according to the following procedure. TEM-35BS, an extruder manufactured by Toshiba Machine Co., Ltd. (37 mmφ, L/D=52.5), was used, barrel C1 was water cooled, the temperature of barrels C2 to C3 was set to 200° C., and the temperature of barrels C4 to C15 was set to 240° C., and the operation was performed with a screw rotation speed of 400 rpm. After dried resin composition pellets obtained in Example 1-38, described later, were fed from the resin feed port of C1, water and oxygen were eliminated from the vent 1, and epoxypropane as a modifying agent 2 was fed from a liquid pressure inlet of C9. Thereafter, unreacted epoxypropane was eliminated from the vent 2 and pelletized, and then hot-air dried at 80° C. for 2 hrs to give 8 mol % modified EVOH (A9) pellets. The ethylene unit content, the degree of saponification, the degree of modification by the epoxypropane (the amount with respect to total vinyl alcohol units), and the melting point of the EVOH (A9) pellets obtained were measured in accordance with the procedures described in evaluation methods (1) and (10) above. The results for the ethylene unit content, the degree of saponification, and the melting point are shown in Table 2. Furthermore, the degree of modification by the epoxypropane (the percentage content of the structural unit (x) with respect to the total vinyl alcohol units) was 8 mol %.

### Synthesis Example 10

EVOH (A10) pellets having a degree of modification of 8 mol % were obtained by following a similar operation to that of Synthesis Example 9, except that as the raw material, the dried resin composition pellets which were fed were changed to the dried resin composition pellets obtained in Example 1-43, and then pelletization was performed. The ethylene unit content, the degree of saponification, the degree of modification by the epoxypropane (the amount with respect to the total vinyl alcohol units), and the melting point of the EVOH (A10) pellets obtained were measured in accordance with the procedures described in evaluation methods (1) and (10) above. The results for the ethylene unit content, the degree of saponification, and the melting point are shown in Table 2. Furthermore, the degree of modification by the epoxypropane (the percentage content of the structural unit (x) with respect to the total vinyl alcohol units) was 8 mol %.

TABLE 1

| | Synthesis | | Synthesis | | Synthesis | | Synthesis | |
|---|---|---|---|---|---|---|---|---|
| | Example 1 | | Example 2 | | Example 3 | | Example 4 | |
| EVOH | EVOH (A1) | | EVOH (A2) | | EVOH (A3) | | EVOH (A4) | |
| Pressurized reactor | 200 | L | 100 | L | 100 | L | 100 | L |
| VAc | 75.0 | kg | 40.0 | kg | 40.0 | kg | 40.0 | kg |
| MeOH | 7.2 | kg | 12.3 | kg | 9.8 | kg | 1.9 | kg |
| Ethylene pressure | 4.13 | MPa | 3.67 | MPa | 2.80 | MPa | 5.84 | MPa |
| Polymerization initiator | 9.4 | g | 6.4 | g | 8.8 | g | 9.2 | g |
| addition amount | | | | | | | | |
| Temperature inside reactor | 65° | C. | 65° | C. | 60° | C. | 65° | C. |
| Reaction time period | 4 | hrs | 3 | hrs | 4 | hrs | 4 | hrs |
| VAc conversion | 49.7% | | 45.2% | | 49.8% | | 55.2% | |
| Charging amount | 150 | kg | 100 | kg | 100 | kg | 100 | kg |
| in saponification | | | | | | | | |
| Addition rate of | 450 | mL/min | 300 | mL/min | 300 | mL/min | 300 | mL/min |
| NaOH MeOH solution | | | | | | | | |
| Times of synthesis | twice | | once | | once | | once | |
| | Synthesis | | Synthesis | | Synthesis | | Synthesis | |
| | Example 5 | | Example 6 | | Example 7 | | Example 8 | |
| EVOH | EVOH (A5) | | EVOH (A6) | | EVOH (A7) | | EVOH (A8) | |
| Pressurized reactor | 100 | L | 100 | L | 100 | L | 100 | L |
| VAc | 40.0 | kg | 40.0 | kg | 40.0 | kg | 40.0 | kg |
| MeOH | 7.5 | kg | 17.4 | kg | 6.8 | kg | 2.0 | kg |
| Ethylene pressure | 3.28 | MPa | 2.87 | MPa | 5.97 | MPa | 6.83 | MPa |
| Polymerization initiator | 9.4 | g | 13.2 | g | 23.2 | g | 36.0 | g |
| addition amount | | | | | | | | |
| Temperature inside reactor | 60° | C. | 60° | C. | 60° | C. | 60° | C. |
| Reaction time period | 4 | hrs | 3 | hrs | 4 | hrs | 4 | hrs |
| VAc conversion | 50.1% | | 44.9% | | 54.7% | | 59.4% | |
| Charging amount | 100 | kg | 100 | kg | 100 | kg | 100 | kg |
| in saponification | | | | | | | | |
| Addition rate of | 300 | mL/min | 300 | mL/min | 300 | mL/min | 300 | mL/min |

| | | | | |
|---|---|---|---|---|
| NaOH MeOH solution | | | | |
| Times of synthesis | once | once | once | once |

TABLE 2

| | | Degree of | Melting |
|---|---|---|---|
| | Ethylene unit | saponification | point |
| | content (mol %) | (mol %) | (° C.) |
| EVOH (A1) | 32.12 | 99.78 | 183 |
| EVOH (A2) | 31.87 | 99.85 | 183 |
| EVOH (A3) | 24.16 | 99.99 | 195 |
| EVOH (A4) | 44.28 | 99.89 | 165 |
| EVOH (A5) | 27.32 | 99.99 | 190 |
| EVOH (A6) | 27.24 | 99.98 | 190 |
| EVOH (A7) | 47.88 | 99.99 | 157 |
| EVOH (A8) | 52.14 | 99.99 | 152 |
| EVOH (A9) | 44.28 | 99.89 | 106 |
| EVOH (A10) | 27.32 | 99.99 | 125 |

### Example 1-1

Into a 60 L stirring tank equipped with a jacket, a stirrer, and a reflux condenser were charged 2 kg of the crude dry EVOH (A1) obtained in Synthesis Example 1, 0.8 kg of water, and 2.2 kg of MeOH, and the mixture was completely dissolved by stirring at 60° C. for 5 hrs. To the thus obtained solution were added sorbic acid, crotonaldehyde, 2,4-hexadienal, and 2,4,6-octatrienal. This solution was extruded through a die plate with a diameter of 4 mm in a mixed liquid of water/MeOH in a ratio of 90/10 cooled to −5° C. to permit deposition into a strand form, and the strand was cut into a pellet form with a strand cutter to give hydrous EVOH pellets. A moisture content of the hydrous EVOH pellets thus obtained was measured with “HR73,” a halogen moisture analyzer manufactured by Mettler-Toledo International Inc., and was 52% by mass.

The hydrous EVOH pellets thus obtained were charged into a 1 g/L aqueous acetic acid solution (bath ratio of 20) and washed for 2 hrs with stirring. The washed hydrous EVOH pellets were deliquored, and further charged into a 1 g/L aqueous acetic acid solution (bath ratio of 20), and washed for 2 hrs with stirring. After the deliquoring, the aqueous acetic acid solution was renewed, and the same operation was repeated. An operation in which the hydrous EVOH pellets, having been washed with the aqueous acetic acid solution and then deliquored, were charged into ion exchanged water (bath ratio of 20), washed for 2 hrs with stirring, and deliquored was carried out 3 times, and purification was carried out until an electrical conductivity of the washing liquid became 3 μs/cm or less (measured with “CM-30ET,” manufactured by DKK-TOA Corporation) to give hydrous EVOH pellets from which catalyst residue generated in the saponification reaction was eliminated.

The hydrous pellets were charged into an aqueous solution (bath ratio of 20) in which a concentration of sodium acetate was 0.510 g/L, a concentration of acetic acid was 0.8 g/L, and a concentration of phosphoric acid was 0.04 g/L, and the mixture was immersed for 4 hrs with stirring at regular intervals to perform a chemical treatment. The pellets were deliquored and then dried at 80° C. for 3 hrs and 105° C. for 16 hrs in a nitrogen atmosphere with an oxygen concentration of 1% by volume or less to give dried resin composition pellets having a circular cylindrical shape (average diameter of 2.8 mm, average length of 3.2 mm), and containing the EVOH (A1), acetic acid, phosphoric acid, a sodium ion (sodium salt), crotonaldehyde, 2,4-hexadienal, 2,4,6-octatrienal, and sorbic acid. The dried resin composition pellets obtained were evaluated in accordance with the procedures described in evaluation methods (2) to (9) above. In the dried resin composition pellets, a sodium ion content was 100 ppm, a phosphoric acid content in terms of a phosphate radical equivalent was 40 ppm, and an acetic acid content was 200 ppm. Contents of the components other than EVOH are each amounts with respect to the content of EVOH. The other evaluation results are shown in Tables 3 and 4. It is to be noted that the amount of addition of each component of crotonaldehyde, 2,4-hexadienal, 2,4,6-octatrienal, and sorbic acid was adjusted such that a content of each was as shown in Table 3.

### Examples 1-2 to 1-61, and Comparative Examples 1-1 to 1-4 and 1-6 to 1-24

Dried resin composition pellets were produced by a similar operation to that of Example 1-1, except that the type of the EVOH (A), the type and content of the unsaturated aliphatic aldehyde (B), the type and content of the conjugated polyene compound (C), and the content of boric acid were as shown in Tables 3, 5, 7, 9, 11, 13, 15, and 17, and evaluations were performed. It is to be noted that in the case of containing boric acid, an aqueous solution adjusted such that the aqueous solution containing sodium acetate and/or the like (bath ratio of 20) had a boric acid concentration of 0.25 g/L was used. In the EVOH of each of the dried resin composition pellets, the sodium ion content was 100 ppm, the phosphoric acid content in terms of a phosphate radical equivalent was 40 ppm, and the acetic acid content was 200 ppm. The other evaluation results are shown in Tables 3 to 18. Contents of the components other than EVOH are each amounts with respect to the content of EVOH.

### Comparative Example 1-5

Dried resin composition pellets were produced by a similar operation to that of Example 1-1, except that crotonaldehyde, 2,4-hexadienal, and 2,4,6-octatrienal were not added, and an operation was added in which: an operation in which hydrous EVOH pellets from which a catalyst residue generated in the saponification reaction was removed were charged into methanol (bath ratio of 10), washed with stirring for 2 hours, and subjected to deliquoring was performed twice; and an operation in which the pellets thus obtained were charged into ion exchanged water (bath ratio of 20), washed with stirring for 2 hrs, and subjected to deliquoring was performed 3 times, and evaluations were performed. In the dried resin composition pellets, the sodium ion content was 100 ppm, the phosphoric acid content in terms of a phosphate radical equivalent was 40 ppm, and the acetic acid content was 200 ppm. Contents of the components other than EVOH are each amounts with respect to the content of EVOH. The other evaluation results are shown in Tables 3 and 4. It is to be noted that the contents of each of the components of crotonaldehyde, 2,4-hexadienal, 2,4,6-octatrienal, and sorbic acid were less than or equal to the lower detection limit.

TABLE 3

| | EVOH (A) | | Unsaturated aliphatic aldehyde (B) | | | | | |
|---|---|---|---|---|---|---|---|---|
| | | ethylene | | 2,4- | 2,4,6- | Conjugated polyene (C) | | Boric |
| | | unit | crotonaldehyde | hexadienal | octatrienal | | content | acid |
| | type | content | content b₁ | content b₂ | content b₃ | type | c | content |
| | — | mol % | ppm | ppm | ppm | — | ppm | ppm |
| Example 1-1 | A1 | 32.12 | 0.50 | 0.12 | 0.08 | sorbic acid | 5 | 0 |
| Example 1-2 | A1 | 32.12 | 0.50 | 0.05 | 0.04 | sorbic acid | 5 | 0 |
| Example 1-3 | A1 | 32.12 | 0.50 | 0.09 | 0.00 | sorbic acid | 5 | 0 |
| Example 1-4 | A1 | 32.12 | 0.50 | 0.03 | 0.03 | sorbic acid | 5 | 0 |
| Example 1-5 | A1 | 32.12 | 0.50 | 0.03 | 0.02 | sorbic acid | 5 | 0 |
| Example 1-6 | A1 | 32.12 | 0.50 | 0.03 | 0.00 | sorbic acid | 5 | 0 |
| Example 1-7 | A1 | 32.12 | 0.50 | 0.01 | 0.01 | sorbic acid | 5 | 0 |
| Example 1-8 | A1 | 32.12 | 0.50 | 0.01 | 0.00 | sorbic acid | 5 | 0 |
| Example 1-9 | A1 | 32.12 | 0.50 | 0.03 | 0.00 | sorbic acid | 50 | 0 |
| Example 1-10 | A1 | 32.12 | 0.50 | 0.03 | 0.00 | sorbic acid | 95 | 0 |
| Example 1-11 | A1 | 32.12 | 0.50 | 0.03 | 0.00 | sorbic acid | 150 | 0 |
| Example 1-12 | A1 | 32.12 | 1.00 | 0.10 | 0.09 | sorbic acid | 5 | 0 |
| Example 1-13 | A1 | 32.12 | 1.00 | 0.07 | 0.05 | sorbic acid | 5 | 0 |
| Example 1-14 | A1 | 32.12 | 1.00 | 0.05 | 0.05 | sorbic acid | 5 | 0 |
| Example 1-15 | A1 | 32.12 | 1.00 | 0.01 | 0.01 | sorbic acid | 5 | 0 |
| Example 1-16 | A1 | 32.12 | 1.00 | 0.01 | 0.00 | sorbic acid | 5 | 0 |
| Example 1-17 | A1 | 32.12 | 1.30 | 0.01 | 0.00 | sorbic acid | 5 | 0 |
| Example 1-18 | A1 | 32.12 | 2.00 | 0.12 | 0.24 | sorbic acid | 5 | 0 |
| Example 1-19 | A1 | 32.12 | 2.00 | 0.01 | 0.01 | sorbic acid | 5 | 0 |
| Example 1-20 | A1 | 32.12 | 2.60 | 0.01 | 0.01 | sorbic acid | 5 | 0 |
| Example 1-21 | A1 | 32.12 | 3.00 | 0.12 | 0.24 | sorbic acid | 5 | 0 |
| Example 1-22 | A1 | 32.12 | 3.00 | 0.02 | 0.01 | sorbic acid | 5 | 0 |
| Example 1-23 | A1 | 32.12 | 3.90 | 0.03 | 0.00 | sorbic acid | 5 | 0 |
| Example 1-24 | A1 | 32.12 | 3.90 | 0.12 | 0.24 | sorbic acid | 5 | 0 |
| Example 1-25 | A1 | 32.12 | 0.50 | 0.03 | 0.00 | — | 0 | 0 |
| Example 1-26 | A1 | 32.12 | 0.50 | 0.03 | 0.00 | myrcene | 5 | 0 |
| Comparative | A1 | 32.12 | 0.50 | 0.00 | 0.00 | sorbic acid | 100 | 0 |
| Example 1-1 | | | | | | | | |
| Comparative | A1 | 32.12 | 0.30 | 0.00 | 0.00 | sorbic acid | 200 | 0 |
| Example 1-2 | | | | | | | | |
| Comparative | A1 | 32.12 | 0.50 | 0.00 | 0.00 | sorbic acid | 5 | 0 |
| Example 1-3 | | | | | | | | |
| Comparative | A1 | 32.12 | 4.10 | 0.50 | 0.10 | sorbic acid | 5 | 0 |
| Example 1-4 | | | | | | | | |
| Comparative | A1 | 32.12 | 0.00 | 0.00 | 0.00 | sorbic acid | 5 | 0 |
| Example 1-5 | | | | | | | | |
| Comparative | A1 | 32.12 | 0.00 | 0.30 | 0.00 | sorbic acid | 200 | 0 |
| Example 1-6 | | | | | | | | |
| Comparative | A1 | 32.12 | 0.00 | 0.00 | 0.30 | sorbic acid | 200 | 0 |
| Example 1-7 | | | | | | | | |
| Comparative | A1 | 32.12 | 0.00 | 0.03 | 0.00 | sorbic acid | 5 | 0 |
| Example 1-8 | | | | | | | | |
| Comparative | A1 | 32.12 | 0.00 | 0.00 | 0.02 | sorbic acid | 5 | 0 |
| Example 1-9 | | | | | | | | |
| Comparative | A1 | 32.12 | 0.50 | 0.15 | 0.12 | sorbic acid | 5 | 0 |
| Example 1-10 | | | | | | | | |

TABLE 4

| | MFR | | | | | | |
|---|---|---|---|---|---|---|---|
| | 210° C., | | | | Evaluation results | | |
| | 2,160 g | b₁/(b₂ + b₃) | b₁ + b₂ + b₃ | b₂ + 2b₃ | die | | neck-in |
| | g/10 min | — | ppm | ppm | buildup | YI | resistance |
| Example 1-1 | 3.8 | 2.5 | 0.70 | 0.28 | B | 14 | C |
| Example 1-2 | 3.8 | 5.6 | 0.59 | 0.13 | B | 13 | B |
| Example 1-3 | 3.8 | 5.6 | 0.59 | 0.09 | A | 13 | B |
| Example 1-4 | 3.8 | 8.4 | 0.56 | 0.09 | A | 13 | A |
| Example 1-5 | 3.8 | 10.0 | 0.55 | 0.07 | A | 12 | A |
| Example 1-6 | 3.8 | 16.7 | 0.53 | 0.03 | A | 12 | B |
| Example 1-7 | 3.8 | 25.0 | 0.52 | 0.03 | A | 11 | B |
| Example 1-8 | 3.8 | 50.0 | 0.51 | 0.01 | A | 10 | B |
| Example 1-9 | 3.8 | 16.7 | 0.53 | 0.03 | A | 13 | B |
| Example 1-10 | 3.8 | 16.7 | 0.53 | 0.03 | A | 17 | B |
| Example 1-11 | 3.8 | 16.7 | 0.53 | 0.03 | A | 19 | B |
| Example 1-12 | 3.8 | 5.3 | 1.19 | 0.28 | B | 22 | B |
| Example 1-13 | 3.8 | 8.3 | 1.12 | 0.17 | B | 21 | A |
| Example 1-14 | 3.8 | 10.0 | 1.10 | 0.15 | B | 20 | A |
| Example 1-15 | 3.8 | 50.0 | 1.02 | 0.03 | A | 18 | B |
| Example 1-16 | 3.8 | 100.0 | 1.01 | 0.01 | A | 18 | C |
| Example 1-17 | 3.8 | 130.0 | 1.31 | 0.01 | A | 22 | C |
| Example 1-18 | 3.8 | 5.6 | 2.36 | 0.60 | D | 26 | B |
| Example 1-19 | 3.8 | 100.0 | 2.02 | 0.03 | A | 24 | C |
| Example 1-20 | 3.8 | 130.0 | 2.62 | 0.03 | A | 27 | C |
| Example 1-21 | 3.8 | 8.3 | 3.36 | 0.60 | D | 30 | A |
| Example 1-22 | 3.8 | 100.0 | 3.03 | 0.04 | A | 28 | C |
| Example 1-23 | 3.8 | 130.0 | 3.93 | 0.03 | A | 34 | C |
| Example 1-24 | 3.8 | 10.8 | 4.26 | 0.60 | D | 36 | A |
| Example 1-25 | 3.8 | 16.7 | 0.53 | 0.03 | A | 13 | B |
| Example 1-26 | 3.8 | 16.7 | 0.53 | 0.03 | A | 12 | B |
| Comparative | 3.8 | — | 0.50 | 0.00 | A | 17 | D |
| Example 1-1 | | | | | | | |
| Comparative | 3.8 | — | 0.30 | 0.00 | A | 19 | D |
| Example 1-2 | | | | | | | |
| Comparative | 3.8 | — | 0.50 | 0.00 | A | 11 | D |
| Example 1-3 | | | | | | | |
| Comparative | 3.8 | 6.8 | 4.70 | 0.70 | E | 42 | B |
| Example 1-4 | | | | | | | |
| Comparative | 3.8 | — | 0.00 | 0.00 | A | 9 | D |
| Example 1-5 | | | | | | | |
| Comparative | 3.8 | 0 | 0.30 | 0.30 | C | 22 | D |
| Example 1-6 | | | | | | | |
| Comparative | 3.8 | 0 | 0.30 | 0.60 | D | 22 | D |
| Example 1-7 | | | | | | | |
| Comparative | 3.8 | 0 | 0.03 | 0.03 | A | 9 | D |
| Example 1-8 | | | | | | | |
| Comparative | 3.8 | 0 | 0.02 | 0.04 | A | 9 | D |
| Example 1-9 | | | | | | | |
| Comparative | 3.8 | 1.9 | 0.77 | 0.39 | C | 15 | D |
| Example 1-10 | | | | | | | |

TABLE 5

| | EVOH (A) | | Unsaturated aliphatic aldehyde (B) | | | | | |
|---|---|---|---|---|---|---|---|---|
| | | ethylene | | 2,4- | 2,4,6- | | | Boric |
| | | unit | crotonaldehyde | hexadienal | octatrienal | Conjugated polyene (C) | | acid |
| | type | content | content b₁ | content b₂ | content b₃ | type | content c | content |
| | — | mol % | ppm | ppm | ppm | — | ppm | ppm |
| Example 1-27 | A2 | 31.87 | 0.50 | 0.12 | 0.08 | sorbic acid | 5 | 800 |
| Example 1-28 | A2 | 31.87 | 0.50 | 0.03 | 0.02 | sorbic acid | 5 | 800 |
| Example 1-29 | A2 | 31.87 | 0.50 | 0.01 | 0.00 | sorbic acid | 5 | 800 |
| Example 1-30 | A2 | 31.87 | 3.90 | 0.12 | 0.24 | sorbic acid | 5 | 800 |
| Example 1-31 | A2 | 31.87 | 3.90 | 0.03 | 0.00 | sorbic acid | 5 | 800 |
| Comparative | A2 | 31.87 | 0.50 | 0.00 | 0.00 | sorbic acid | 5 | 800 |
| Example 1-11 | | | | | | | | |
| Comparative | A2 | 31.87 | 4.10 | 0.50 | 0.10 | sorbic acid | 5 | 800 |
| Example 1-12 | | | | | | | | |

TABLE 6

| | MFR | | | | | | |
|---|---|---|---|---|---|---|---|
| | 210° C., | | b₁ + | | Evaluation results | | |
| | 2,160 g | b₁/(b₂ + b₃) | b₂ + b₃ | b₂ + 2b₃ | die | | neck-in |
| | g/10 min | — | ppm | ppm | buildup | YI | resistance |
| Example 1-27 | 3.7 | 2.5 | 0.70 | 0.28 | B | 14 | C |
| Example 1-28 | 3.7 | 10.0 | 0.55 | 0.07 | A | 12 | A |
| Example 1-29 | 3.7 | 50.0 | 0.51 | 0.01 | A | 10 | B |
| Example 1-30 | 3.7 | 10.8 | 4.26 | 0.60 | D | 36 | A |
| Example 1-31 | 3.7 | 130.0 | 3.93 | 0.03 | A | 34 | C |
| Comparative | 3.7 | — | 0.50 | 0.00 | A | 17 | D |
| Example 1-11 | | | | | | | |
| Comparative | 3.7 | 6.8 | 4.70 | 0.70 | E | 42 | B |
| Example 1-12 | | | | | | | |

TABLE 7

| | EVOH (A) | | Unsaturated aliphatic aldehyde (B) | | | | | |
|---|---|---|---|---|---|---|---|---|
| | | ethylene | | 2,4- | 2,4,6- | | | Boric |
| | | unit | crotonaldehyde | hexadienal | octatrienal | Conjugated polyene (C) | | acid |
| | type | content | content b₁ | content b₂ | content b₃ | type | content c | content |
| | — | mol % | ppm | ppm | ppm | — | ppm | ppm |
| Example 1-32 | A3 | 24.16 | 0.50 | 0.12 | 0.08 | sorbic acid | 5 | 0 |
| Example 1-33 | A3 | 24.16 | 0.50 | 0.03 | 0.02 | sorbic acid | 5 | 0 |
| Example 1-34 | A3 | 24.16 | 0.50 | 0.01 | 0.00 | sorbic acid | 5 | 0 |
| Example 1-35 | A3 | 24.16 | 3.90 | 0.12 | 0.24 | sorbic acid | 5 | 0 |
| Example 1-36 | A3 | 24.16 | 3.90 | 0.03 | 0.00 | sorbic acid | 5 | 0 |
| Comparative | A3 | 24.16 | 0.50 | 0.00 | 0.00 | sorbic acid | 5 | 0 |
| Example 1-13 | | | | | | | | |
| Comparative | A3 | 24.16 | 4.10 | 0.50 | 0.10 | sorbic acid | 5 | 0 |
| Example 1-14 | | | | | | | | |

TABLE 8

| | MFR | | | | | | |
|---|---|---|---|---|---|---|---|
| | 210° C., | | b₁ + | | Evaluation results | | |
| | 2,160 g | b₁/(b₂ + b₃) | b₂ + b₃ | b₂ + 2b₃ | die | | neck-in |
| | g/10 min | — | ppm | ppm | buildup | YI | resistance |
| Example 1-32 | 2.2 | 2.5 | 0.70 | 0.28 | B | 15 | C |
| Example 1-33 | 2.2 | 10.0 | 0.55 | 0.07 | A | 13 | A |
| Example 1-34 | 2.2 | 50.0 | 0.51 | 0.01 | A | 11 | B |
| Example 1-35 | 2.2 | 10.8 | 4.26 | 0.60 | D | 38 | A |
| Example 1-36 | 2.2 | 130.0 | 3.93 | 0.03 | A | 36 | C |
| Comparative | 2.2 | — | 0.50 | 0.00 | A | 18 | D |
| Example 1-13 | | | | | | | |
| Comparative | 2.2 | 6.8 | 4.70 | 0.70 | E | 44 | B |
| Example 1-14 | | | | | | | |

TABLE 9

| | EVOH (A) | | Unsaturated aliphatic aldehyde (B) | | | | | |
|---|---|---|---|---|---|---|---|---|
| | | ethylene | | 2,4- | 2,4,6- | | | Boric |
| | | unit | crotonaldehyde | hexadienal | octatrienal | Conjugated polyene (C) | | acid |
| | type | content | content b₁ | content b₂ | content b₃ | type | content c | content |
| | — | mol % | ppm | ppm | ppm | — | ppm | ppm |
| Example 1-37 | A4 | 44.28 | 0.50 | 0.12 | 0.08 | sorbic acid | 5 | 0 |
| Example 1-38 | A4 | 44.28 | 0.50 | 0.03 | 0.02 | sorbic acid | 5 | 0 |
| Example 1-39 | A4 | 44.28 | 0.50 | 0.01 | 0.00 | sorbic acid | 5 | 0 |
| Example 1-40 | A4 | 44.28 | 3.90 | 0.12 | 0.24 | sorbic acid | 5 | 0 |
| Example 1-41 | A4 | 44.28 | 3.90 | 0.03 | 0.00 | sorbic acid | 5 | 0 |
| Comparative | A4 | 44.28 | 0.50 | 0.00 | 0.00 | sorbic acid | 5 | 0 |
| Example 1-15 | | | | | | | | |
| Comparative | A4 | 44.28 | 4.10 | 0.50 | 0.10 | sorbic acid | 5 | 0 |
| Example 1-16 | | | | | | | | |

TABLE 10

| | MFR | | | | | | |
|---|---|---|---|---|---|---|---|
| | 210° C., | | b₁ + | | Evaluation results | | |
| | 2,160 g | b₁/(b₂ + b₃) | b₂ + b₃ | b₂ + 2b₃ | die | | neck-in |
| | g/10 min | — | ppm | ppm | buildup | YI | resistance |
| Example 1-37 | 13 | 2.5 | 0.70 | 0.28 | B | 13 | C |
| Example 1-38 | 13 | 10.0 | 0.55 | 0.07 | A | 10 | B |
| Example 1-39 | 13 | 50.0 | 0.51 | 0.01 | A | 9 | C |
| Example 1-40 | 13 | 10.8 | 4.26 | 0.60 | D | 34 | B |
| Example 1-41 | 13 | 130.0 | 3.93 | 0.03 | A | 32 | C |
| Comparative | 13 | — | 0.50 | 0.00 | A | 16 | D |
| Example 1-15 | | | | | | | |
| Comparative | 13 | 6.8 | 4.70 | 0.70 | E | 40 | C |
| Example 1-16 | | | | | | | |

TABLE 11

| | EVOH (A) | | Unsaturated aliphatic aldehyde (B) | | | | | |
|---|---|---|---|---|---|---|---|---|
| | | ethylene | | 2,4- | 2,4,6- | | | Boric |
| | | unit | crotonaldehyde | hexadienal | octatrienal | Conjugated polyene (C) | | acid |
| | type | content | content b₁ | content b₂ | content b₃ | type | content c | content |
| | — | mol % | ppm | ppm | ppm | — | ppm | ppm |
| Example 1-42 | A5 | 27.32 | 0.50 | 0.12 | 0.08 | sorbic acid | 5 | 0 |
| Example 1-43 | A5 | 27.32 | 0.50 | 0.03 | 0.02 | sorbic acid | 5 | 0 |
| Example 1-44 | A5 | 27.32 | 0.50 | 0.01 | 0.00 | sorbic acid | 5 | 0 |
| Example 1-45 | A5 | 27.32 | 3.90 | 0.12 | 0.24 | sorbic acid | 5 | 0 |
| Example 1-46 | A5 | 27.32 | 3.90 | 0.03 | 0.00 | sorbic acid | 5 | 0 |
| Comparative | A5 | 27.32 | 0.50 | 0.00 | 0.00 | sorbic acid | 5 | 0 |
| Example 1-17 | | | | | | | | |
| Comparative | A5 | 27.32 | 4.10 | 0.50 | 0.10 | sorbic acid | 5 | 0 |
| Example 1-18 | | | | | | | | |

TABLE 12

| | MFR | | | | | | |
|---|---|---|---|---|---|---|---|
| | 210° C., | | b₁ + | | Evaluation results | | |
| | 2,160 g | b₁/(b₂ + b₃) | b₂ + b₃ | b₂ + 2b₃ | die | | neck-in |
| | g/10 min | — | ppm | ppm | buildup | YI | resistance |
| Example 1-42 | 8.9 | 2.5 | 0.70 | 0.28 | B | 15 | C |
| Example 1-43 | 8.9 | 10.0 | 0.55 | 0.07 | A | 13 | B |
| Example 1-44 | 8.9 | 50.0 | 0.51 | 0.01 | A | 11 | B |
| Example 1-45 | 8.9 | 10.8 | 4.26 | 0.60 | D | 38 | B |
| Example 1-46 | 8.9 | 130.0 | 3.93 | 0.03 | A | 36 | C |
| Comparative | 8.9 | — | 0.50 | 0.00 | A | 18 | D |
| Example 1-17 | | | | | | | |
| Comparative | 8.9 | 6.8 | 4.70 | 0.70 | E | 44 | B |
| Example 1-18 | | | | | | | |

TABLE 13

| | EVOH (A) | | Unsaturated aliphatic aldehyde (B) | | | | | |
|---|---|---|---|---|---|---|---|---|
| | | ethylene | | 2,4- | 2,4,6- | | | Boric |
| | | unit | crotonaldehyde | hexadienal | octatrienal | Conjugated polyene (C) | | acid |
| | type | content | content b₁ | content b₂ | content b₃ | type | content c | content |
| | — | mol % | ppm | ppm | ppm | — | ppm | ppm |
| Example 1-47 | A6 | 27.24 | 0.50 | 0.12 | 0.08 | sorbic acid | 5 | 800 |
| Example 1-48 | A6 | 27.24 | 0.50 | 0.03 | 0.02 | sorbic acid | 5 | 800 |
| Example 1-49 | A6 | 27.24 | 0.50 | 0.01 | 0.00 | sorbic acid | 5 | 800 |
| Example 1-50 | A6 | 27.24 | 3.90 | 0.12 | 0.24 | sorbic acid | 5 | 800 |
| Example 1-51 | A6 | 27.24 | 3.90 | 0.03 | 0.00 | sorbic acid | 5 | 800 |
| Comparative | A6 | 27.24 | 0.50 | 0.00 | 0.00 | sorbic acid | 5 | 800 |
| Example 1-19 | | | | | | | | |
| Comparative | A6 | 27.24 | 4.10 | 0.50 | 0.10 | sorbic acid | 5 | 800 |
| Example 1-20 | | | | | | | | |

TABLE 14

| | MFR | | | | | | |
|---|---|---|---|---|---|---|---|
| | 210° C., | | b₁ + | | Evaluation results | | |
| | 2,160 g | b₁/(b₂ + b₃) | b₂ + b₃ | b₂ + 2b₃ | die | | neck-in |
| | g/10 min | — | ppm | ppm | buildup | YI | resistance |
| Example 1-47 | 4.0 | 2.5 | 0.70 | 0.28 | B | 15 | C |
| Example 1-48 | 4.0 | 10.0 | 0.55 | 0.07 | A | 13 | A |
| Example 1-49 | 4.0 | 50.0 | 0.51 | 0.01 | A | 11 | B |
| Example 1-50 | 4.0 | 10.8 | 4.26 | 0.60 | D | 38 | A |
| Example 1-51 | 4.0 | 130.0 | 3.93 | 0.03 | A | 36 | C |
| Comparative | 4.0 | — | 0.50 | 0.00 | A | 18 | D |
| Example 1-19 | | | | | | | |
| Comparative | 4.0 | 6.8 | 4.70 | 0.70 | E | 44 | B |
| Example 1-20 | | | | | | | |

TABLE 15

| | EVOH (A) | | Unsaturated aliphatic aldehyde (B) | | | | | |
|---|---|---|---|---|---|---|---|---|
| | | ethylene | | 2,4- | 2,4,6- | | | Boric |
| | | unit | crotonaldehyde | hexadienal | octatrienal | Conjugated polyene (C) | | acid |
| | type | content | content b₁ | content b₂ | content b₃ | type | content c | content |
| | — | mol % | ppm | ppm | ppm | — | ppm | ppm |
| Example 1-52 | A7 | 47.88 | 0.50 | 0.12 | 0.08 | sorbic acid | 5 | 800 |
| Example 1-53 | A7 | 47.88 | 0.50 | 0.03 | 0.02 | sorbic acid | 5 | 800 |
| Example 1-54 | A7 | 47.88 | 0.50 | 0.01 | 0.00 | sorbic acid | 5 | 800 |
| Example 1-55 | A7 | 47.88 | 3.90 | 0.12 | 0.24 | sorbic acid | 5 | 800 |
| Example 1-56 | A7 | 47.88 | 3.90 | 0.03 | 0.00 | sorbic acid | 5 | 800 |
| Comparative | A7 | 47.88 | 0.50 | 0.00 | 0.00 | sorbic acid | 5 | 800 |
| Example 1-21 | | | | | | | | |
| Comparative | A7 | 47.88 | 4.10 | 0.50 | 0.10 | sorbic acid | 5 | 800 |
| Example 1-22 | | | | | | | | |

TABLE 16

| | MFR | | | | | | |
|---|---|---|---|---|---|---|---|
| | 210° C., | | b₁ + | | Evaluation results | | |
| | 2,160 g | b₁/(b₂ + b₃) | b₂ + b₃ | b₂ + 2b₃ | die | | neck-in |
| | g/10 min | — | ppm | ppm | buildup | YI | resistance |
| Example 1-52 | 15 | 2.5 | 0.70 | 0.28 | B | 12 | C |
| Example 1-53 | 15 | 10.0 | 0.55 | 0.07 | A | 9 | B |
| Example 1-54 | 15 | 50.0 | 0.51 | 0.01 | A | 8 | C |
| Example 1-55 | 15 | 10.8 | 4.26 | 0.60 | D | 33 | B |
| Example 1-56 | 15 | 130.0 | 3.93 | 0.03 | A | 31 | C |
| Comparative | 15 | — | 0.50 | 0.00 | A | 15 | D |
| Example 1-21 | | | | | | | |
| Comparative | 15 | 6.8 | 4.70 | 0.70 | E | 39 | C |
| Example 1-22 | | | | | | | |

TABLE 17

| | EVOH (A) | | Unsaturated aliphatic aldehyde (B) | | | | | |
|---|---|---|---|---|---|---|---|---|
| | | ethylene | | 2,4- | 2,4,6- | | | Boric |
| | | unit | crotonaldehyde | hexadienal | octatrienal | Conjugated polyene (C) | | acid |
| | type | content | content b₁ | content b₂ | content b₃ | type | content c | content |
| | — | mol % | ppm | ppm | ppm | — | ppm | ppm |
| Example 1-57 | A8 | 52.14 | 0.50 | 0.12 | 0.08 | sorbic acid | 5 | 1,800 |
| Example 1-58 | A8 | 52.14 | 0.50 | 0.03 | 0.02 | sorbic acid | 5 | 1,800 |
| Example 1-59 | A8 | 52.14 | 0.50 | 0.01 | 0.00 | sorbic acid | 5 | 1,800 |
| Example 1-60 | A8 | 52.14 | 3.90 | 0.12 | 0.24 | sorbic acid | 5 | 1,800 |
| Example 1-61 | A8 | 52.14 | 3.90 | 0.03 | 0.00 | sorbic acid | 5 | 1,800 |
| Comparative | A8 | 52.14 | 0.50 | 0.00 | 0.00 | sorbic acid | 5 | 1,800 |
| Example 1-23 | | | | | | | | |
| Comparative | A8 | 52.14 | 4.10 | 0.50 | 0.10 | sorbic acid | 5 | 1,800 |
| Example 1-24 | | | | | | | | |

TABLE 18

| | MFR | | | | | | |
|---|---|---|---|---|---|---|---|
| | 210° C., | | b₁ + | | Evaluation results | | |
| | 2,160 g | b₁/(b₂ + b₃) | b₂ + b₃ | b₂ + 2b₃ | die | | neck-in |
| | g/10 min | — | ppm | ppm | buildup | YI | resistance |
| Example 1-57 | 2.2 | 2.5 | 0.70 | 0.28 | B | 11 | C |
| Example 1-58 | 2.2 | 10.0 | 0.55 | 0.07 | A | 8 | A |
| Example 1-59 | 2.2 | 50.0 | 0.51 | 0.01 | A | 7 | B |
| Example 1-60 | 2.2 | 10.8 | 4.26 | 0.60 | D | 32 | A |
| Example 1-61 | 2.2 | 130.0 | 3.93 | 0.03 | A | 30 | C |
| Comparative | 2.2 | — | 0.50 | 0.00 | A | 14 | D |
| Example 1-23 | | | | | | | |
| Comparative | 2.2 | 6.8 | 4.70 | 0.70 | E | 38 | B |
| Example 1-24 | | | | | | | |

### Example 1-62

A multilayer structure (resin composition layer/adhesive resin layer/linear low-density polyethylene layer/adhesive resin layer/resin composition layer=20/10/50/10/20 (μm)) was obtained under the following conditions by using linear low-density polyethylene (“ULTZEX (registered trademark) 3520L,” manufactured by Prime Polymer Co., Ltd.), anhydrous maleic acid-modified PE (“Admer (registered trademark) NF528,” manufactured by Mitsui Chemicals, Inc.) as the adhesive resin, and the dried resin composition pellets of Example 1-5.

### Film Forming Conditions

Extruder for resin composition: single-screw extruder (ME model CO-EXT, manufactured by Toyo Seiki Seisaku-sho, Ltd.)

Port diameter: 20 mmφ, L/D: 20, screw: full flight type

Feeding zone/compression zone/metering zone/die=175/210/220/230° C.

Extruder for LLDPE: single-screw extruder (GT-32-A, manufactured by Research Laboratory of Plastics Technology Co., Ltd.)

Port diameter: 32 mmφ, L/D: 28, screw: full flight type Feeding zone/compression zone/metering zone/die=150/210/220/230° C.

Extruder for adhesive resin: single-screw extruder (SZW20GT-20MG-STD, manufactured by Technovel Corporation)

Port diameter: 20 mmφ, L/D: 20, screw: full flight type

Feeding zone/compression zone/metering zone/die=150/210/220/230° C.

Die: 300 mm width coat hanger die (manufactured by Research Laboratory of Plastics Technology Co., Ltd.)

Temperature of drawing roll: 80° C.

The neck-in and the die buildup at the time of producing the multilayer structure were inhibited, and the target multilayer structure was able to be formed without issue.

From the Examples and the Comparative Examples, it is revealed that: when b₁/(b₂+b₃) is 2.0 or more and less than 150.0, the neck-in inhibition is favorable; as b₁+b₂+b₃ becomes lower, the YI becomes lower; when the content c of the conjugated polyene compound (C) is low, the YI is low; and when b₂+2b₃ is 0.65 ppm or less, the die buildup is inhibited.

Detailed considerations based on Tables 3 and 4 are as follows. In Comparative Example 1-5, which did not contain the unsaturated aliphatic aldehyde (B), and Comparative Examples 1-1 to 1-3 and 1-6 to 1-9, which contained each type of the unsaturated aliphatic aldehyde (B) independently, the neck-in was not inhibited. Furthermore, the neck-in was also not inhibited in Comparative Example 1-10, in which the value of b₁/(b₂+b₃) was less than 2.0. On the other hand, as revealed from the Examples, when the value of b₁/(b₂+b₃) fell within the range of 2.0 or more and less than 150.0, the neck-in was inhibited, and in particular, when the value of b₁/(b₂+b₃) was near 10 (for example, 8.0 or more and 13.0 or less), as in Examples 1-4, 1-5, 1-13, 1-14, 1-21, and 1-24, the neck-in was most inhibited. Furthermore, in Comparative Example 1-4, in which b₂+2b₃ was more than 0.65 ppm, the die buildup was not inhibited; however, as revealed from the Examples, in the case in which b₂+2b₃ was 0.65 ppm or less, the die buildup was inhibited, and in particular, in the case in which b₂+2b₃ was 0.10 ppm or less, the die buildup was further inhibited. Furthermore, with regard to the total content b₁+b₂+b₃ of crotonaldehyde (B1), 2,4-hexadienal (B2), and 2,4,6-octatrienal (B3), as can be seen from Comparative Example 1-4, Examples 1-1 to 1-7, 1-12 to 1-26, and the like, it is revealed that the total content being lower leads to superiority in hue. Moreover, it is revealed from Examples 1-6 and 1-9 to 1-11 that the content of the conjugated polyene compound being lower leads to superiority in hue.

### Example 2-1

Into a 60 L stirring tank equipped with a jacket, a stirrer, and a reflux condenser were charged 1.6 kg of the crude dry EVOH (A1) obtained in Synthesis Example 1, 0.4 kg of the crude dry EVOH (A7) obtained in Synthesis Example 7, 0.8 kg of water, and 2.2 kg of MeOH, and a resulting mixture was completely dissolved by stirring at 60° C. for 5 hrs. To a thus obtained solution were added sorbic acid, crotonaldehyde, 2,4-hexadienal, and 2,4,6-octatrienal. This solution was extruded through a die plate with a diameter of 4 mm in a mixed liquid of water/MeOH in a ratio of 90/10 cooled to −5° C. to permit deposition into a strand form, and the strand was cut into a pellet form with a strand cutter to give hydrous EVOH pellets. A moisture content of the hydrous pellets of EVOH thus obtained was measured with “HR73,” a halogen moisture analyzer manufactured by Mettler-Toledo International Inc., and was 52% by mass.

The hydrous EVOH pellets thus obtained were charged into a 1 g/L aqueous acetic acid solution (bath ratio of 20) and washed for 2 hrs with stirring. The washed hydrous EVOH pellets were deliquored, and further charged into a 1 g/L aqueous acetic acid solution (bath ratio of 20), and washed for 2 hrs with stirring. After the deliquoring, the aqueous acetic acid solution was renewed, and the same operation was repeated. An operation in which the hydrous EVOH pellets, having been washed with the aqueous acetic acid solution and then deliquored, were charged into ion exchanged water (bath ratio of 20), washed for 2 hrs with stirring, and deliquored was carried out 3 times, and purification was carried out until an electrical conductivity of the washing liquid became 3 μs/cm or less (measured with “CM-30ET,” manufactured by DKK-TOA Corporation) to give hydrous EVOH pellets from which catalyst residue generated in the saponification reaction was eliminated.

The hydrous pellets thus obtained were charged into an aqueous solution (bath ratio of 20) in which a concentration of sodium acetate was 0.510 g/L, a concentration of acetic acid was 0.8 g/L, a concentration of phosphoric acid was 0.04 g/L, and a concentration of boric acid was 0.05 g/L, and the mixture was immersed for 4 hrs with stirring at regular intervals to perform a chemical treatment. The pellets were deliquored and then dried at 80° C. for 3 hrs and 105° C. for 16 hrs in a nitrogen atmosphere with an oxygen concentration of 1% by volume or less to give dried resin composition pellets having a circular cylindrical shape (average diameter of 2.8 mm, average length of 3.2 mm), and containing the EVOH (A1), the EVOH (A7), acetic acid, phosphoric acid, boric acid, a sodium ion (sodium salt), crotonaldehyde, 2,4-hexadienal, 2,4,6-octatrienal, and sorbic acid. The dried resin composition pellets thus obtained were evaluated in accordance with the procedures described in the evaluation methods (2), (3), (5) to (9), (11), and (12). In the dried resin composition pellets, the sodium ion content was 100 ppm, the phosphoric acid content in terms of a phosphate radical equivalent was 40 ppm, and the acetic acid content was 200 ppm. Contents of the components other than EVOH are each amounts with respect to the content of EVOH. The other evaluation results are shown in Tables 19 to 21. It is to be noted that the added amounts of each of the components of crotonaldehyde, 2,4-hexadienal, 2,4,6-octatrienal, and sorbic acid were adjusted such that a content of each was as shown in Table 20.

### Examples 2-2 to 2-10, 2-13, 2-14, and 2-16, and Comparative Examples 2-1 and 2-2

Dried resin composition pellets were produced by a similar operation to that of Example 2-1, except that the type of the EVOH (Aa), the type of the EVOH (Ab), the mass ratio (Aa)/(Ab), the boric acid content, the content of the unsaturated aldehyde (B), and the content of the conjugated polyene (C) were changed as described in Tables 19 and 20. In the dried resin composition pellets, the sodium ion content was 100 ppm, the phosphoric acid content in terms of a phosphate radical equivalent was 40 ppm, and the acetic acid content was 200 ppm. Contents of the components other than EVOH are each amounts with respect to the content of EVOH. The other evaluation results are shown in Tables 19 to 21. It is to be noted that the boric acid concentration of the aqueous solution to be used in the chemical treatment was appropriately adjusted such that the boric acid content in the dried resin composition pellets obtained was as shown in Table 19.

### Example 2-11

A group of dried resin composition pellets was obtained by dry-blending 80 parts by mass of the dried resin composition pellets obtained in Example 1-5 with 20 parts by mass of the dried resin composition pellets obtained in Example 1-53. The group of dried resin composition pellets thus obtained was evaluated in accordance with the procedures described in the evaluation methods (2), (3), (5) to (9), (11), and (12). The evaluation results are shown in Tables 19 to 21.

### Example 2-12

A group of dried resin composition pellets was obtained by dry-blending 80 parts by mass of the dried resin composition pellets obtained in Example 1-5 with 20 parts by mass of the dried resin composition pellets obtained in Example 1-53. Resin composition pellets were obtained by extruding the group of dried resin composition pellets using a 30 mmφ twin-screw extruder (“TEX-30SS-30CRW-2V,” manufactured by The Japan Steel Works, Ltd.) under conditions involving an extruding temperature of 200° C., a screw rotation speed of 300 rpm, and a resin extrusion amount of 25 kg/hr, performing pelletizing, and then performing hot-air drying at 80° C. for 2 hrs. The dried resin composition pellets thus obtained were evaluated in accordance with the procedures described in the evaluation methods (2), (3), (5) to (9), (11), and (12). The evaluation results are shown in Tables 19 to 21.

### Example 2-15

The dried resin composition pellets obtained in Example 1-48 were evaluated in accordance with the procedures described in the evaluation methods (2), (3), (5) to (9), (11), and (12). The evaluation results are shown in Tables 19 to 21.

TABLE 19

| | EVOH (Aa) | | | EVOH (Ab) | | | | Ethylene unit | | |
|---|---|---|---|---|---|---|---|---|---|---|
| | | ethylene | | | ethylene | | Mass | content | Melting | Boric |
| | | unit | melting | | unit | melting | ratio | difference | point | acid |
| | | content | point | | content | point | (Aa/Ab) | (Ab − Aa) | difference | content |
| | type | (mol %) | (° C.) | type | (mol %) | (° C.) | — | mol % | ° C. | ppm |
| Example 2-1 | A1 | 32.12 | 183 | A7 | 47.88 | 157 | 80/20 | 15.76 | 26 | 160 |
| Example 2-2 | A1 | 32.12 | 183 | A7 | 47.88 | 157 | 75/25 | 15.76 | 26 | 200 |
| Example 2-3 | A1 | 32.12 | 183 | A7 | 47.88 | 157 | 70/30 | 15.76 | 26 | 240 |
| Example 2-4 | A1 | 32.12 | 183 | A7 | 47.88 | 157 | 83/17 | 15.76 | 26 | 136 |
| Example 2-5 | A2 | 31.87 | 183 | A4 | 44.28 | 165 | 80/20 | 12.41 | 25 | 640 |
| Example 2-6 | A6 | 27.24 | 190 | A4 | 44.28 | 165 | 65/35 | 17.04 | 25 | 520 |
| Example 2-7 | A6 | 27.24 | 190 | A9 | 44.28 | 106 | 90/10 | 17.04 | 84 | 720 |
| Example 2-8 | A2 | 31.87 | 183 | A9 | 44.28 | 106 | 75/25 | 12.41 | 77 | 600 |
| Example 2-9 | A6 | 27.24 | 190 | A1 | 32.12 | 183 | 60/40 | 4.88 | 7 | 480 |
| Example 2-10 | A1 | 32.12 | 183 | A7 | 47.88 | 157 | 80/20 | 15.76 | 26 | 160 |
| Example 2-11 | Example | 32.12 | 183 | Example | 47.88 | 157 | 80/20 | 15.76 | 26 | 160 |
| | 1-5 | | | 1-53 | | | | | | |
| Example 2-12 | Example | 32.12 | 183 | Example | 47.88 | 157 | 80/20 | 15.76 | 26 | 160 |
| | 1-5 | | | 1-53 | | | | | | |
| Example 2-13 | A1 | 32.12 | 183 | A7 | 47.88 | 157 | 80/20 | 15.76 | 26 | 160 |
| Example 2-14 | A1 | 32.12 | 183 | A7 | 47.88 | 157 | 80/20 | 15.76 | 26 | 160 |
| Example 2-15 | Example | 27.24 | 190 | — | — | — | 100/0 | — | — | 800 |
| | 1-48 | | | | | | | | | |
| Example 2-16 | A1 | 32.12 | 183 | A7 | 47.88 | 157 | 50/50 | 15.76 | 26 | 400 |
| Comparative | A1 | 32.12 | 183 | A7 | 47.88 | 157 | 80/20 | 15.76 | 26 | 160 |
| Example 2-1 | | | | | | | | | | |
| Comparative | A1 | 32.12 | 183 | A7 | 47.88 | 157 | 80/20 | 15.76 | 26 | 160 |
| Example 2-2 | | | | | | | | | | |

TABLE 20

| | Unsaturated aliphatic aldehyde (B) | | | | | | | |
|---|---|---|---|---|---|---|---|---|
| | | 2,4- | 2,4,6- | | | | | |
| | crotonaldehyde | hexadienal | octatrienal | Conjugated polyene (C) | | b₁/(b₂ + | b₁ + | b₂ + |
| | content b₁ | content b₂ | content b₃ | type | content c | b₃) | b₂ + b₃ | 2b₃ |
| | ppm | ppm | ppm | — | ppm | — | ppm | ppm |
| Example | 0.50 | 0.03 | 0.02 | sorbic | 5 | 10.0 | 0.55 | 0.07 |
| 2-1 | | | | acid | | | | |
| Example | 0.50 | 0.03 | 0.02 | sorbic | 5 | 10.0 | 0.55 | 0.07 |
| 2-2 | | | | acid | | | | |
| Example | 0.50 | 0.03 | 0.02 | sorbic | 5 | 10.0 | 0.55 | 0.07 |
| 2-3 | | | | acid | | | | |
| Example | 0.50 | 0.03 | 0.02 | sorbic | 5 | 10.0 | 0.55 | 0.07 |
| 2-4 | | | | acid | | | | |
| Example | 0.50 | 0.03 | 0.02 | sorbic | 5 | 10.0 | 0.55 | 0.07 |
| 2-5 | | | | acid | | | | |
| Example | 0.50 | 0.03 | 0.02 | sorbic | 5 | 10.0 | 0.55 | 0.07 |
| 2-6 | | | | acid | | | | |
| Example | 0.50 | 0.03 | 0.02 | sorbic | 5 | 10.0 | 0.55 | 0.07 |
| 2-7 | | | | acid | | | | |
| Example | 0.50 | 0.03 | 0.02 | sorbic | 5 | 10.0 | 0.55 | 0.07 |
| 2-8 | | | | acid | | | | |
| Example | 0.50 | 0.03 | 0.02 | sorbic | 5 | 10.0 | 0.55 | 0.07 |
| 2-9 | | | | acid | | | | |
| Example | 0.50 | 0.03 | 0.02 | sorbic | 150 | 10.0 | 0.55 | 0.07 |
| 2-10 | | | | acid | | | | |
| Example | 0.50 | 0.03 | 0.02 | sorbic | 5 | 10.0 | 0.55 | 0.07 |
| 2-11 | | | | acid | | | | |
| Example | 0.50 | 0.03 | 0.02 | sorbic | 5 | 10.0 | 0.55 | 0.07 |
| 2-12 | | | | acid | | | | |
| Example | 0.50 | 0.05 | 0.04 | sorbic | 5 | 5.6 | 0.59 | 0.13 |
| 2-13 | | | | acid | | | | |
| Example | 0.50 | 0.01 | 0.01 | sorbic | 5 | 25.0 | 0.52 | 0.03 |
| 2-14 | | | | acid | | | | |
| Example | 0.50 | 0.03 | 0.02 | sorbic | 5 | 10.0 | 0.55 | 0.07 |
| 2-15 | | | | acid | | | | |
| Example | 0.50 | 0.03 | 0.02 | sorbic | 5 | 10.0 | 0.55 | 0.07 |
| 2-16 | | | | acid | | | | |
| Comparative | 4.00 | 0.50 | 0.10 | sorbic | 5 | 6.7 | 4.60 | 0.70 |
| Example | | | | acid | | | | |
| 2-1 | | | | | | | | |
| Comparative | 0.50 | 0.00 | 0.00 | sorbic | 5 | — | 0.50 | 0.00 |
| Example | | | | acid | | | | |
| 2-2 | | | | | | | | |

TABLE 21

| | Evaluation results | | | | | |
|---|---|---|---|---|---|---|
| | | | | OTR | | |
| | | | | cm³/m² · | | |
| | die | | neck-in | day · atm | melt moldability | |
| | buildup | YI | resistance | 20° C. | | central |
| | — | — | — | 65% RH | end | portion |
| Example | A | 11 | A | 0.4 | A | A |
| 2-1 | | | | | | |
| Example | A | 11 | A | 0.5 | A | A |
| 2-2 | | | | | | |
| Example | A | 11 | A | 0.6 | A | A |
| 2-3 | | | | | | |
| Example | A | 12 | A | 0.4 | A | A |
| 2-4 | | | | | | |
| Example | A | 12 | A | 0.4 | A | A |
| 2-5 | | | | | | |
| Example | A | 12 | A | 0.3 | A | A |
| 2-6 | | | | | | |
| Example | A | 13 | A | 0.1 | A | A |
| 2-7 | | | | | | |
| Example | A | 11 | A | 0.6 | A | A |
| 2-8 | | | | | | |
| Example | A | 13 | A | 0.2 | B | B |
| 2-9 | | | | | | |
| Example | A | 19 | A | 0.4 | A | A |
| 2-10 | | | | | | |
| Example | A | 11 | A | 0.4 | A | A |
| 2-11 | | | | | | |
| Example | A | 15 | A | 0.4 | A | A |
| 2-12 | | | | | | |
| Example | B | 13 | B | 0.4 | C | B |
| 2-13 | | | | | | |
| Example | A | 11 | B | 0.4 | B | A |
| 2-14 | | | | | | |
| Example | A | 13 | A | 0.1 | D | D |
| 2-15 | | | | | | |
| Example | A | 10 | A | 1.0 | A | A |
| 2-16 | | | | | | |
| Comparative | E | 40 | B | 0.4 | C | B |
| Example | | | | | | |
| 2-1 | | | | | | |
| Comparative | A | 11 | D | 0.4 | D | A |
| Example | | | | | | |
| 2-2 | | | | | | |

### Example 2-2

From the Examples and the Comparative Examples in Tables 19 to 21, it is revealed that: when b₁/(b₂+b₃) is 2.0 or more and less than 150.0, the neck-in inhibition is favorable; as b₁+b₂+b₃ becomes lower, the YI becomes lower; and when b₂+2b₃ is 0.65 ppm or less, the die buildup is inhibited. Furthermore, it is revealed that in the case in which two types of EVOH having different ethylene unit contents are contained in a certain mass ratio, the gas barrier properties and the thermoformability are improved.

### Example 2-17

A multilayer film having a circular elliptical shape was produced under the following conditions using the dried resin composition pellets obtained in Example 2-1, and an inflation extrusion molding machine. It is to be noted that the thermoplastic resin layer, described later, was laminated in 3 layers each having an average thickness of 30 μm, resulting in the thermoplastic resin layer having an average thickness of 90 μm being one layer.

### Multilayer Film Production Conditions

Multilayer film layer configuration: [outer face side] thermoplastic resin layer/adhesive resin layer/resin composition layer [inner face side]=90 μm/20 μm/20 μm (overall thickness: 130 μm)

Thermoplastic resin layer: metallocene polyethylene (“LUMICENE SUPERTOUGH 40ST05,” manufactured by Total)

Adhesive resin layer: acid-modified linear low-density polyethylene (“Admer NF528,” manufactured by Mitsui Chemicals, Inc.)

Resin composition layer: dried resin composition pellets obtained in Example 2-1

Apparatus: inflation extrusion molding machine for 5 layers each selected from 5 types (manufactured by Dr. Collin)

Die temperature: 220° C.

Blow-up ratio: 2.7

Drawing speed: 4 m/min

Film-folding diameter width: 25 cm

### Conditions for Thermoplastic Resin Layer Extruder 1

Extruder: 30 φ single-screw extruder (manufactured by Dr. Collins)

Rotation speed: 60 rpm;

Extrusion temperature: feeding zone/compression zone/metering zone=170° C./190° C./220° C.

### Conditions for Thermoplastic Resin Layer Extruder 2

Extruder: 20 φ single-screw extruder (manufactured by Dr. Collins); Rotation speed: 70 rpm;

Extrusion temperature: feeding zone/compression zone/metering zone=170° C./190° C./220° C.

### Conditions for Thermoplastic Resin Layer Extruder 3

Extruder: 20 φ single-screw extruder (manufactured by Dr. Collins);

Rotation speed: 70 rpm;

Extrusion temperature: feeding zone/compression zone/metering zone=170° C./190° C./220° C.

### Conditions for Adhesive Resin Layer Extruder

Extruder: 20 φ single-screw extruder (manufactured by Dr. Collins); Rotation speed: 70 rpm;

Extrusion temperature: feeding zone/compression zone/metering zone=170° C./190° C./220° C.

### Conditions for Resin Composition Layer Extruder

Extruder: 30 φ single-screw extruder (manufactured by Dr. Collins);

Rotation speed: 24 rpm

Extrusion temperature: feeding zone/compression zone/metering zone=190° C./220° C./220° C.

The multilayer film having the circular elliptical shape thus obtained was folded such that the resin composition layer overlapped, and was subjected to 6φ monoaxial stretching in a vertical direction (MD direction) at 120° C. using a stretching apparatus (SDR-506WK) manufactured by ETO Co., Ltd. to give a stretched multilayer film (thermoplastic resin layer/adhesive resin layer/resin composition layer=15 μm/3.3 μm/3.3 μm. A state of the film appearance of the stretched multilayer film obtained was confirmed by visual observation, and no appearance abnormalities such as stretching unevenness or the like were confirmed.

### Example 2-18

A coextruded multilayer film was produced under the following conditions using the dried resin composition pellets obtained in Example 2-8.

### Multilayer Film Production Conditions

Multilayer film layer configuration: resin composition layer/polypropylene adhesive resin layer/polypropylene resin layer=27 μm/27 μm/243 μm

Polypropylene resin layer: “Novatec PP EA7 AD,” manufactured by Japan Polypropylene Corporation (density: 0.90 g/cc; MFR (at 230° C., under load of 2.16 kg): 1.4 g/10 min)

Polypropylene adhesive resin layer: “Admer QF500,” manufactured by Mitsui Chemicals, Etc. (MFR (at 230° C., under load of 2.16 kg): 3.0 g/10 min)

Resin composition layer: dried resin composition pellets obtained in Example 2-8

Resin composition layer extrusion conditions

Extruder: single-screw extruder (ME-type CO-EXT extruder for laboratory use, manufactured by Toyo Seiki Seisaku Co., Ltd.)

Screw: port diameter 20 mmφ, L/D 20, full flight screw Extrusion temperature: feeding zone/compression zone/metering zone/die=175/210/220/230° C.

Polypropylene adhesive resin layer extrusion conditions

Extruder: single-screw extruder (SZW20GT-20MG-STD, manufactured by Technovel Corporation)

Screw: port diameter 20 mmφ, L/D 20, full flight screw

Extrusion temperature: feeding zone/compression zone/metering zone/die=150/200/220/230° C.

### Polypropylene Resin Layer Extrusion Conditions

Extruder: single-screw extruder (GT-32-A, manufactured by Research Laboratory of Plastics Technology Co., Ltd.)

Screw: port diameter 32 mmφ, L/D 28, full flight screw Extrusion temperature: feeding zone/compression zone/metering zone/die=170/220/230/230° C.

### Die

300 mm width coat hanger die for 3 layers each selected from 3 types (manufactured by Research Laboratory of Plastics Technology Co., Ltd.)

Die temperature: 230° C.

A biaxially stretched coextruded film of 3 layers each selected from 3 types (resin composition layer/polypropylene adhesive resin layer/polypropylene resin layer=6.8 μm/6.8 μm/60.8 μm) was obtained by stretching the coextruded multilayer film obtained 2 times in a vertical direction and 2 times in a horizontal direction at a temperature of 160° C. and a stretching speed of 8 m/min by using a tenter-type simultaneous biaxial stretching machine. A state of the film appearance of the biaxially stretched coextruded film obtained was confirmed by visual observation, and no appearance abnormalities such as perforation, stretching unevenness, or the like were confirmed.

### Preparation of Inorganic Particles (D)

Synthetic silica, being “Sylysia (registered trademark) 380” (average particle diameter: 9.0 μm) or “Sylysia (registered trademark) 310P” (average particle diameter: 2.7 μm), each manufactured by Fuji Silysia Chemical Ltd., was ground and classified by a sieve to produce inorganic particles having average grain diameters of 1.6 μm and 4.9 μm. Furthermore, as inorganic particles having an average particle size of 2.7 μm, the “Sylysia (registered trademark) 310P” was used. All of these average particle sizes are values measured with a laser procedure.

### Example 3-1

To the dried resin composition pellets obtained in Example 1-5, the inorganic particles (D) having an average particle diameter of 2.7 μm were added such that a content became 300 ppm with respect to the content of the EVOH (A), and dry blending was performed using a tumbler. This dry-blended matter was extruded using a 30 mmφ twin-screw extruder (“TEX-30SS-30CRW-2V,” manufactured by The Japan Steel Works, Ltd.) at an extrusion temperature of 220° C. in a nitrogen atmosphere to give dried resin composition pellets containing the inorganic particles. The dried resin composition pellets containing the inorganic particles thus obtained were evaluated in accordance with the procedures described in the evaluation methods (5) to (9) and (13) to (18). The evaluation results are shown in Tables 22 and 23.

### Examples 3-2 to 3-12 and Comparative Examples 3-1 and 3-2

Dried resin composition pellets containing inorganic particles were obtained by a similar operation to that of Example 3-1, except that the dried resin composition pellets of each Example or Comparative Example used and the contents and average particle diameters of the inorganic particles were changed to be as shown in Table 22, and evaluations were performed. The results are shown in Tables 22 and 23.

TABLE 22

| | Dried | EVOH (A) | | | Unsaturated aliphatic aldehyde (B) | | | |
|---|---|---|---|---|---|---|---|---|
| | resin | | ethylene | | | 2,4- | 2,4,6- | Conjugated |
| | composition | | unit | melting | crotonaldehyde | hexadienal | octatrienal | polyene (C) |
| | pellets | | content | point | content b₁ | content b₂ | content b₃ | type |
| | used | type | (mol %) | (° C.) | ppm | ppm | ppm | — |
| Example | Example | A1 | 32.12 | 183 | 0.50 | 0.03 | 0.02 | sorbic |
| 3-1 | 1-5 | | | | | | | acid |
| Example | Example | A2 | 31.87 | 183 | 0.50 | 0.03 | 0.02 | sorbic |
| 3-2 | 1-28 | | | | | | | acid |
| Example | Example | A4 | 44.28 | 165 | 0.50 | 0.03 | 0.02 | sorbic |
| 3-3 | 1-38 | | | | | | | acid |
| Example | Example | A5 | 27.32 | 190 | 0.50 | 0.03 | 0.02 | sorbic |
| 3-4 | 1-43 | | | | | | | acid |
| Example | Example | A6 | 27.24 | 190 | 0.50 | 0.03 | 0.02 | sorbic |
| 3-5 | 1-48 | | | | | | | acid |
| Example | Example | A1 | 32.12 | 183 | 0.50 | 0.03 | 0.02 | sorbic |
| 3-6 | 1-5 | | | | | | | acid |
| Example | Example | A1 | 32.12 | 183 | 0.50 | 0.03 | 0.02 | sorbic |
| 3-7 | 1-5 | | | | | | | acid |
| Example | Example | A1 | 32.12 | 183 | 0.50 | 0.03 | 0.02 | sorbic |
| 3-8 | 1-5 | | | | | | | acid |
| Example | Example | A1 | 32.12 | 183 | 0.50 | 0.03 | 0.02 | sorbic |
| 3-9 | 1-5 | | | | | | | acid |
| Example | Example | A1 | 32.12 | 183 | 0.50 | 0.05 | 0.04 | sorbic |
| 3-10 | 1-2 | | | | | | | acid |
| Example | Example | A1 | 32.12 | 183 | 0.50 | 0.01 | 0.01 | sorbic |
| 3-11 | 1-7 | | | | | | | acid |
| Example | Example | A1 | 32.12 | 183 | 0.50 | 0.03 | 0.02 | sorbic |
| 3-12 | 1-5 | | | | | | | acid |
| Comparative | Comparative | A1 | 32.12 | 183 | 4.10 | 0.50 | 0.10 | sorbic |
| Example | Example | | | | | | | acid |
| 3-1 | 1-4 | | | | | | | |
| Comparative | Comparative | A1 | 32.12 | 183 | 0.50 | 0.00 | 0.00 | sorbic |
| Example | Example | | | | | | | acid |
| 3-2 | 1-3 | | | | | | | |

| | | | | | Inorganic particles | |
|---|---|---|---|---|---|---|
| | Conjugated | | | | (D) | |
| | polyene (C) | | b₁ + | | | average |
| | content | b₁/(b₂ + | b₂ + | b₂ + | content | particle |
| | c | b₃) | b₃ | 2b₃ | d | diameter |
| | ppm | — | ppm | ppm | ppm | μm |
| Example | 5 | 10.0 | 0.55 | 0.07 | 300 | 2.7 |
| 3-1 | | | | | | |
| Example | 5 | 10.0 | 0.55 | 0.07 | 300 | 2.7 |
| 3-2 | | | | | | |
| Example | 5 | 10.0 | 0.55 | 0.07 | 300 | 2.7 |
| 3-3 | | | | | | |
| Example | 5 | 10.0 | 0.55 | 0.07 | 300 | 2.7 |
| 3-4 | | | | | | |
| Example | 5 | 10.0 | 0.55 | 0.07 | 300 | 2.7 |
| 3-5 | | | | | | |
| Example | 5 | 10.0 | 0.55 | 0.07 | 100 | 2.7 |
| 3-6 | | | | | | |
| Example | 5 | 10.0 | 0.55 | 0.07 | 300 | 4.9 |
| 3-7 | | | | | | |
| Example | 5 | 10.0 | 0.55 | 0.07 | 300 | 1.6 |
| 3-8 | | | | | | |
| Example | 5 | 10.0 | 0.55 | 0.07 | 3,900 | 2.7 |
| 3-9 | | | | | | |
| Example | 5 | 5.6 | 0.59 | 0.13 | 300 | 2.7 |
| 3-10 | | | | | | |
| Example | 5 | 25.0 | 0.52 | 0.03 | 300 | 2.7 |
| 3-11 | | | | | | |
| Example | 5 | 10.0 | 0.55 | 0.07 | 0 | — |
| 3-12 | | | | | | |
| Comparative | 5 | 6.8 | 4.60 | 0.70 | 300 | 2.7 |
| Example | | | | | | |
| 3-1 | | | | | | |
| Comparative | 5 | — | 0.50 | 0.00 | 300 | 2.7 |
| Example | | | | | | |
| 3-2 | | | | | | |

TABLE 23

| | Evaluation results | | | | | | | | |
|---|---|---|---|---|---|---|---|---|---|
| | | | | OTR of | | | vapor deposition | | |
| | | | | central | | | film evaluation | | |
| | | | | portion | | breakage | inorganic | | |
| | | | | of film | width | resistance | vapor | vapor | |
| | | | | mL/m² · | direction | of | deposition | deposition | |
| | die | | neck-in | day · atm | uniformity | monolayer | layer | flaw- | |
| | buildup | YI | resistance | 20° C. | of OTR | film | thickness | inhibiting | adhesion |
| | — | — | — | 65% RH | — | — | (nm) | property | strength |
| Example | A | 12 | A | 0.30 | A | A | 50 | A | A |
| 3-1 | | | | | | | | | |
| Example | A | 12 | A | 0.29 | A | A | 50 | A | A |
| 3-2 | | | | | | | | | |
| Example | A | 10 | A | 2.23 | A | A | 50 | A | A |
| 3-3 | | | | | | | | | |
| Example | A | 13 | A | 0.15 | A | A | 50 | A | A |
| 3-4 | | | | | | | | | |
| Example | A | 13 | A | 0.14 | A | A | 50 | A | A |
| 3-5 | | | | | | | | | |
| Example | A | 12 | A | 0.30 | A | C | 50 | A | B |
| 3-6 | | | | | | | | | |
| Example | A | 12 | A | 0.30 | A | A | 50 | A | A |
| 3-7 | | | | | | | | | |
| Example | A | 12 | A | 0.30 | A | B | 50 | A | B |
| 3-8 | | | | | | | | | |
| Example | A | 12 | A | 0.30 | A | C | 50 | A | A |
| 3-9 | | | | | | | | | |
| Example | B | 13 | B | 0.30 | B | C | 50 | B | B |
| 3-10 | | | | | | | | | |
| Example | A | 11 | B | 0.30 | B | B | 50 | A | A |
| 3-11 | | | | | | | | | |
| Example | A | 12 | A | 0.30 | A | E | 50 | C | E |
| 3-12 | | | | | | | | | |
| Comparative | E | 42 | B | 0.30 | A | D | 50 | C | C |
| Example | | | | | | | | | |
| 3-1 | | | | | | | | | |
| Comparative | A | 11 | D | 0.30 | C | C | 50 | A | A |
| Example | | | | | | | | | |
| 3-2 | | | | | | | | | |

### Example 3-13

Into a 60 L stirring tank equipped with a jacket, a stirrer, and a reflux condenser were charged 1.6 kg of the crude dry EVOH (A1) obtained in Synthesis Example 1, 0.4 kg of the crude dry EVOH (A7) obtained in Synthesis Example 7, 0.8 kg of water, and 2.2 kg of MeOH, and a resulting mixture was completely dissolved by stirring at 60° C. for 5 hrs. To a thus obtained solution were added sorbic acid, crotonaldehyde, 2,4-hexadienal, and 2,4,6-octatrienal. This solution was extruded through a die plate with a diameter of 4 mm in a mixed liquid of water/MeOH in a ratio of 90/10 cooled to −5° C. to permit deposition into a strand form, and the strand was cut into a pellet form with a strand cutter to give hydrous EVOH pellets. A moisture content of the hydrous pellets of EVOH thus obtained was measured with “HR73,” a halogen moisture analyzer manufactured by Mettler-Toledo International Inc., and was 52% by mass.

The hydrous EVOH pellets thus obtained were charged into a 1 g/L aqueous acetic acid solution (bath ratio of 20) and washed for 2 hrs with stirring. The washed hydrous EVOH pellets were deliquored, and further charged into a 1 g/L aqueous acetic acid solution (bath ratio of 20), and washed for 2 hrs with stirring. After the deliquoring, the aqueous acetic acid solution was renewed, and the same operation was repeated. An operation in which the hydrous EVOH pellets, having been washed with the aqueous acetic acid solution and then deliquored, were charged into ion exchanged water (bath ratio of 20), washed for 2 hrs with stirring, and deliquored was carried out 3 times, and purification was carried out until an electrical conductivity of the washing liquid became 3 μs/cm or less (measured with “CM-30ET,” manufactured by DKK-TOA Corporation) to give hydrous EVOH pellets from which catalyst residue generated in the saponification reaction was eliminated.

The hydrous pellets thus obtained were charged into an aqueous solution (bath ratio of 20) in which a concentration of sodium acetate was 0.510 g/L, a concentration of acetic acid was 0.8 g/L, a concentration of phosphoric acid was 0.04 g/L, and a concentration of boric acid was 0.05 g/L, and the mixture was immersed for 4 hrs with stirring at regular intervals to perform a chemical treatment. The pellets were deliquored and then dried at 80° C. for 3 hrs and 105° C. for 16 hrs in a nitrogen atmosphere with an oxygen concentration of 1% by volume or less to give dried resin composition pellets having a circular cylindrical shape (average diameter of 2.8 mm, average length of 3.2 mm), and containing the EVOHs (A1 and A7), acetic acid, phosphoric acid, a sodium ion (sodium salt), crotonaldehyde, 2,4-hexadienal, 2,4,6-octatrienal, and sorbic acid. The dried resin composition pellets and the inorganic particles (D) were blended by a procedure similar to that of Example 3-1 to give dried resin composition pellets containing the inorganic particles (D) having an average particle diameter of 2.7 μm at a content of 300 ppm with respect to the content of the EVOH (A). The dried resin composition pellets thus obtained were evaluated in accordance with the procedures described in the evaluation methods (2), (3), (5) to (9), and (13) to (18). In the dried resin composition pellets containing the inorganic particles, the sodium ion content was 100 ppm, the phosphoric acid content in terms of a phosphate radical equivalent was 40 ppm, and the acetic acid content was 200 ppm. Contents of the components other than EVOH are each amounts with respect to the content of EVOH. The other evaluation results are shown in Tables 24 to 26. It is to be noted that the added amounts of each of the components of crotonaldehyde, 2,4-hexadienal, 2,4,6-octatrienal, and sorbic acid were adjusted such that a content of each was as shown in Table 25.

### Examples 3-15, 3-17, and 3-18, and Comparative Example 3-3 and 3-4

Dried resin composition pellets containing inorganic particles were produced by a similar operation to that of Example 3-13, except that the type of the EVOH (Aa), the type of the EVOH (Ab), the mass ratio (Aa)/(Ab), the boric acid content, and the content of the unsaturated aldehyde (B) were changed as described in Tables 24 and 25. In the dried resin composition pellets containing the inorganic particles, the sodium ion content was 100 ppm, the phosphoric acid content in terms of a phosphate radical equivalent was 40 ppm, and the acetic acid content was 200 ppm. Contents of the components other than EVOH are each amounts with respect to the content of EVOH. The other evaluation results are shown in Tables 24 to 26. It is to be noted that the boric acid concentration of the aqueous solution to be used in the chemical treatment was appropriately adjusted such that the boric acid content in the dried resin composition pellets containing the inorganic particles obtained was as shown in Table 24.

### Example 3-14

A group of dried resin composition pellets was obtained by dry-blending 80 parts by mass of the dried resin composition pellets obtained in Example 1-5 with 20 parts by mass of the dried resin composition pellets obtained in Example 1-53. Resin composition pellets were obtained by extruding the group of dried resin composition pellets using a 30 mmφ twin-screw extruder (“TEX-30SS-30CRW-2V,” manufactured by The Japan Steel Works, Ltd.) under conditions involving an extruding temperature of 200° C., a screw rotation speed of 300 rpm, and a resin extrusion amount of 25 kg/hr, performing pelletizing, and then performing hot-air drying at 80° C. for 2 hrs. The dried resin composition pellets and the inorganic particles (D) were blended by a procedure similar to that of Example 3-1 to give dried resin composition pellets containing the inorganic particles (D) having an average particle diameter of 2.7 μm at a content of 300 ppm with respect to the content of the EVOH (A). The dried resin composition pellets thus obtained were evaluated in accordance with the procedures described in the evaluation methods (2), (3), (5) to (9), and (13) to (18). In the dried resin composition pellets containing the inorganic particles, the sodium ion content was 100 ppm, the phosphoric acid content in terms of a phosphate radical equivalent was 40 ppm, and the acetic acid content was 200 ppm. Contents of the components other than EVOH are each amounts with respect to the content of EVOH. The other evaluation results are shown in Tables 24 to 26.

### Example 3-16

A group of dried resin composition pellets was obtained by dry-blending 90 parts by mass of the dried resin composition pellets obtained in Example 1-48 with 10 parts by mass of the EVOH (A9) pellets obtained in Synthesis Example 9. Resin composition pellets were obtained by extruding the group of dried resin composition pellets using a 30 mmφ twin-screw extruder (“TEX-30SS-30CRW-2V,” manufactured by The Japan Steel Works, Ltd.) under conditions involving an extruding temperature of 200° C., a screw rotation speed of 300 rpm, and a resin extrusion amount of 25 kg/hr, performing pelletizing, and then performing hot-air drying at 80° C. for 2 hrs. The dried resin composition pellets and the inorganic particles (D) were blended by a procedure similar to that of Example 3-1 to give dried resin composition pellets containing the inorganic particles (D) having an average particle diameter of 2.7 μm at a content of 300 ppm with respect to the content of the EVOH (A). The dried resin composition pellets thus obtained were evaluated in accordance with the procedures described in the evaluation methods (2), (3), (5) to (9), and (13) to (18). In the dried resin composition pellets containing the inorganic particles, the sodium ion content was 100 ppm, the phosphoric acid content in terms of a phosphate radical equivalent was 40 ppm, and the acetic acid content was 200 ppm. Contents of the components other than EVOH are each amounts with respect to the content of EVOH. The other evaluation results are shown in Tables 24 to 26.

TABLE 24

| | EVOH (Aa) | | | EVOH (Ab) | | | Mass | Ethylene | | |
|---|---|---|---|---|---|---|---|---|---|---|
| | | ethylene | | | ethylene | | ratio | unit | Melting | Boric |
| | | unit | melting | | unit | melting | (Aa/Ab) | content | point | acid |
| | | content | point | | content | point | (parts | difference | difference | content |
| | type | (mol %) | (° C.) | type | (mol %) | (° C.) | by mass) | (Ab-Aa) | ° C. | ppm |
| Example | A1 | 32.12 | 183 | A7 | 47.88 | 157 | 80/20 | 16 | 26 | 160 |
| 3-13 | | | | | | | | | | |
| Example | Example | 32.12 | 183 | Example | 47.88 | 157 | 80/20 | 16 | 26 | 160 |
| 3-14 | 1-5 | | | 1-53 | | | | | | |
| Example | A5 | 27.24 | 190 | A7 | 47.88 | 157 | 80/20 | 20 | 33 | 800 |
| 3-15 | | | | | | | | | | |
| Example | Example | 27.24 | 190 | A9 | 44.28 | 106 | 90/10 | 17 | 84 | 720 |
| 3-16 | 1-48 | | | | | | | | | |
| Example | A1 | 32.12 | 183 | A7 | 47.88 | 157 | 80/20 | 16 | 26 | 160 |
| 3-17 | | | | | | | | | | |
| Example | A1 | 32.12 | 183 | A7 | 47.88 | 157 | 80/20 | 16 | 26 | 160 |
| 3-18 | | | | | | | | | | |
| Comparative | A1 | 32.12 | 183 | A7 | 47.88 | 157 | 80/20 | 16 | 26 | 160 |
| Example | | | | | | | | | | |
| 3-3 | | | | | | | | | | |
| Comparative | A1 | 32.12 | 183 | A7 | 47.88 | 157 | 80/20 | 16 | 26 | 160 |
| Example | | | | | | | | | | |
| 3-4 | | | | | | | | | | |

TABLE 25

| | | | | | | | | | Inorganic particles | |
|---|---|---|---|---|---|---|---|---|---|---|
| | | | | Conjugated | | | | | (D) | |
| | Unsaturated aliphatic aldehyde (B) | | | polyene (C) | | | b₁ + | | | average |
| | crotonaldehyde | 2,4-hexadienal | 2,4,6-octatrienal | | content | b₁/(b₂ + | b₂ + | b₂ + | | particle |
| | content b₁ | content b₂ | content b₃ | type | c | b₃) | b₃ | 2b₃ | content d | diameter |
| | ppm | ppm | ppm | — | ppm | — | ppm | ppm | ppm | μm |
| Example | 0.50 | 0.03 | 0.02 | sorbic | 5 | 10.0 | 0.55 | 0.07 | 300 | 2.7 |
| 3-13 | | | | acid | | | | | | |
| Example | 0.50 | 0.03 | 0.02 | sorbic | 5 | 10.0 | 0.55 | 0.07 | 300 | 2.7 |
| 3-14 | | | | acid | | | | | | |
| Example | 0.50 | 0.03 | 0.02 | sorbic | 5 | 10.0 | 0.55 | 0.07 | 300 | 2.7 |
| 3-15 | | | | acid | | | | | | |
| Example | 0.50 | 0.03 | 0.02 | sorbic | 5 | 10.0 | 0.55 | 0.07 | 300 | 2.7 |
| 3-16 | | | | acid | | | | | | |
| Example | 0.50 | 0.05 | 0.04 | sorbic | 5 | 5.6 | 0.59 | 0.13 | 300 | 2.7 |
| 3-17 | | | | acid | | | | | | |
| Example | 0.50 | 0.01 | 0.01 | sorbic | 5 | 25.0 | 0.52 | 0.03 | 300 | 2.7 |
| 3-18 | | | | acid | | | | | | |
| Comparative | 4.10 | 0.50 | 0.10 | sorbic | 5 | 6.8 | 4.60 | 0.70 | 300 | 2.7 |
| Example | | | | acid | | | | | | |
| 3-3 | | | | | | | | | | |
| Comparative | 0.50 | 0.00 | 0.00 | sorbic | in 5 | 1 | 0.50 | 0.00 | 300 | 2.7 |
| Example | | | | acid | | | | | | |
| 3-4 | | | | | | | | | | |

TABLE 26

| | Evaluation results | | | | | | | | |
|---|---|---|---|---|---|---|---|---|---|
| | | | | OTR of | | | vapor deposition film | | |
| | | | | central | | | evaluation | | |
| | | | | portion | | breakage | inorganic | | |
| | | | | of film | width | resistance | vapor | | |
| | | | | mL/m² · | direction | of | deposition | vapor | |
| | die | | neck-in | day · atm | uniformity | monolayer | layer | deposition | |
| | buildup | YI | resistance | 20° C. | of OTR | film | thickness | flaw-inhibiting | adhesion |
| | — | — | — | 65% RH | — | — | (nm) | property | strength |
| Example | A | 13 | A | 0.36 | A | A | 50 | A | A |
| 3-13 | | | | | | | | | |
| Example | A | 18 | A | 0.36 | A | A | 50 | A | A |
| 3-14 | | | | | | | | | |
| Example | A | 11 | A | 0.16 | A | A | 50 | A | A |
| 3-15 | | | | | | | | | |
| Example | A | 20 | A | 0.20 | A | A | 50 | A | A |
| 3-16 | | | | | | | | | |
| Example | B | 13 | B | 0.36 | B | B | 50 | B | B |
| 3-17 | | | | | | | | | |
| Example | A | 11 | B | 0.36 | B | A | 50 | A | A |
| 3-18 | | | | | | | | | |
| Comparative | E | 42 | B | 0.36 | A | C | 50 | C | C |
| Example | | | | | | | | | |
| 3-3 | | | | | | | | | |
| Comparative | A | 11 | D | 0.36 | C | A | 50 | A | A |
| Example | | | | | | | | | |
| 3-4 | | | | | | | | | |

As shown in Tables 22 to 26, the resin compositions of each of Examples 3-1 to 3-18 resulted in the neck-in and the die buildup being inhibited. Furthermore, in the vapor deposition film of each of Comparative Examples 3-1 and 3-3, in which the resin compositions which are susceptible to die buildup were used, there were numerous vapor deposition flaws, and the adhesion strength of the inorganic vapor deposition layer was low. Moreover, in the vapor deposition film of each of Comparative Examples 3-2 and 3-4, in which the resin compositions which are susceptible to neck-in were used, the width direction uniformity of the OTR was low. Among the Examples, in each of Examples 3-1 to 3-11 and 3-13 to 3-18, in which the resin compositions containing the inorganic particles were used, vapor deposition flaws were inhibited, the vapor deposition film was obtained having an inorganic vapor deposition layer with high adhesion strength, and the width direction uniformity of the OTR in the monolayer film was able to be improved.

### Example 4-1

An aqueous dispersion (content of nonionic surfactant: 10.0 g/L) was prepared, having dispersed therein the resin composition pellets containing the EVOH (A1) obtained in Example 1-5 and polyoxyethylene (7) stearyl ether as the nonionic surfactant (E) (the parenthesized numeral in the compound name of the nonionic surfactant (E) represents a degree of condensation of the polyoxyethylene unit; the same applies hereafter). Blending of 100 parts by mass of the resin composition pellets with 1 part by mass of the aqueous dispersion was performed. Melt kneading of a mixture thus obtained was performed under the following conditions, followed by pelletization and then drying to give resin composition pellets containing the nonionic surfactant.

Apparatus: 25 mmφ double-screw extruder (“Labo Plastomill 4C150,” manufactured by Toyo Seiki Seisaku-sho, Ltd.)

L/D: 25

Screw: fully intermeshing co-rotation type

Number of die holes: 2 holes (3 mmφ)

Extrusion temperature: C1=200° C., C2 to C5=220° C., die=220° C.

Drying: vacuum drying at 90° C., 20 hrs

The dried resin composition pellets thus obtained were evaluated in accordance with the procedures described in the evaluation methods (5) to (9), (19), and (20). The results are shown in Tables 27 to 29.

### Examples 4-2 to 4-14, and Comparative Examples 4-1 and 4-2

Resin composition pellets containing a nonionic surfactant were obtained by a similar operation to that of Example 4-1, except that the dried resin composition pellets and the nonionic surfactant (E) shown in Tables 27 and 28 were used, and the content of the nonionic surfactant (E) was changed. It is to be noted that the content of the nonionic surfactant in the aqueous dispersion was appropriately changed so as to be the content of the nonionic surfactant (E) described in Table 28. In all cases, the nonionic surfactant (E) used was a commercially available product. Furthermore, in Example 4-13, melt-kneading was performed again without blending the nonionic surfactant (E) to give the resin composition pellets. The resin composition pellets thus obtained were evaluated by similar procedures to those of Example 4-1. The evaluation results are shown in Tables 27 to 29.

TABLE 27

| | Dried | EVOH (A) | | | | | Conjugated | |
|---|---|---|---|---|---|---|---|---|
| | resin | | ethylene | Unsaturated aliphatic aldehyde (B) | | | polyene (C) | |
| | composition | | unit | crotonaldehyde | 2,4-hexadienal | 2,4,6-octatrienal | | content |
| | pellet | | content | content b₁ | content b₂ | content b₃ | type | c |
| | used | type | (mol %) | ppm | ppm | ppm | — | ppm |
| Example | Example | A1 | 32.12 | 0.50 | 0.03 | 0.02 | sorbic | 5 |
| 4-1 | 1-5 | | | | | | acid | |
| Example | Example | A1 | 32.12 | 0.50 | 0.03 | 0.02 | sorbic | 5 |
| 4-2 | 1-5 | | | | | | acid | |
| Example | Example | A1 | 32.12 | 0.50 | 0.03 | 0.02 | sorbic | 5 |
| 4-3 | 1-5 | | | | | | acid | |
| Example | Example | A1 | 32.12 | 0.50 | 0.03 | 0.02 | sorbic | 5 |
| 4-4 | 1-5 | | | | | | acid | |
| Example | Example | A1 | 32.12 | 0.50 | 0.03 | 0.02 | sorbic | 5 |
| 4-5 | 1-5 | | | | | | acid | |
| Example | Example | A1 | 32.12 | 0.50 | 0.03 | 0.02 | sorbic | 5 |
| 4-6 | 1-5 | | | | | | acid | |
| Example | Example | A1 | 32.12 | 0.50 | 0.03 | 0.02 | sorbic | 5 |
| 4-7 | 1-5 | | | | | | acid | |
| Example | Example | A1 | 32.12 | 0.50 | 0.03 | 0.02 | sorbic | 5 |
| 4-8 | 1-5 | | | | | | acid | |
| Example | Example | A3 | 24.16 | 0.50 | 0.03 | 0.02 | sorbic | 5 |
| 4-9 | 1-33 | | | | | | acid | |
| Example | Example | A4 | 44.28 | 0.50 | 0.03 | 0.02 | sorbic | 5 |
| 4-10 | 1-38 | | | | | | acid | |
| Example | Example | A1 | 32.12 | 0.50 | 0.05 | 0.04 | sorbic | 5 |
| 4-11 | 1-2 | | | | | | acid | |
| Example | Example | A1 | 32.12 | 0.50 | 0.01 | 0.01 | sorbic | 5 |
| 4-12 | 1-7 | | | | | | acid | |
| Example | Example | A1 | 32.12 | 0.50 | 0.03 | 0.02 | sorbic | 5 |
| 4-13 | 1-5 | | | | | | acid | |
| Example | Example | A1 | 32.12 | 0.50 | 0.03 | 0.02 | sorbic | 5 |
| 4-14 | 1-5 | | | | | | acid | |
| Comparative | Comparative | A1 | 32.12 | 4.10 | 0.50 | 0.10 | sorbic | 5 |
| Example | Example | | | | | | acid | |
| 4-1 | 1-4 | | | | | | | |
| Comparative | Comparative | A1 | 32.12 | 0.50 | 0.00 | 0.00 | sorbic | 5 |
| Example | Example | | | | | | acid | |
| 4-2 | 1-3 | | | | | | | |

TABLE 28

| | Nonionic surfactant (E) | | | | |
|---|---|---|---|---|---|
| | type | content e | b₁/(b₂ + b₃) | b₁ + b₂ + b₃ | b₂ + 2b₃ |
| | — | ppm | — | ppm | ppm |
| Example 4-1 | polyoxyethylene (7) | 100 | 10.0 | 0.55 | 0.07 |
| | stearyl ether | | | | |
| Example 4-2 | polyoxyethylene (7) | 3 | 10.0 | 0.55 | 0.07 |
| | stearyl ether | | | | |
| Example 4-3 | polyoxyethylene (7) | 15 | 10.0 | 0.55 | 0.07 |
| | stearyl ether | | | | |
| Example 4-4 | polyoxyethylene (7) | 400 | 10.0 | 0.55 | 0.07 |
| | stearyl ether | | | | |
| Example 4-5 | polyoxyethylene (2) | 100 | 10.0 | 0.55 | 0.07 |
| | oleyl ether | | | | |
| Example 4-6 | polyoxypropylene | 100 | 10.0 | 0.55 | 0.07 |
| | stearyl ether | | | | |
| Example 4-7 | polyoxyethylene | 100 | 10.0 | 0.55 | 0.07 |
| | stearylamine | | | | |
| Example 4-8 | polyoxyethylene- | 100 | 10.0 | 0.55 | 0.07 |
| | polyoxypropylene- | | | | |
| | laurylamine | | | | |
| Example 4-9 | polyoxyethylene (7) | 100 | 10.0 | 0.55 | 0.07 |
| | stearyl ether | | | | |
| Example 4-10 | polyoxyethylene (7) | 100 | 10.0 | 0.55 | 0.07 |
| | stearyl ether | | | | |
| Example 4-11 | polyoxyethylene (7) | 100 | 5.6 | 0.59 | 0.13 |
| | stearyl ether | | | | |
| Example 4-12 | polyoxyethylene (7) | 100 | 25.0 | 0.52 | 0.03 |
| | stearyl ether | | | | |
| Example 4-13 | — | 0 | 10.0 | 0.55 | 0.07 |
| Example 4-14 | polyoxyethylene (7) | 1,600 | 10.0 | 0.55 | 0.07 |
| | stearyl ether | | | | |
| Comparative | polyoxyethylene (7) | 100 | 6.8 | 4.60 | 0.70 |
| Example 4-1 | stearyl ether | | | | |
| Comparative | polyoxyethylene (7) | 100 | — | 0.50 | 0.00 |
| Example 4-2 | stearyl ether | | | | |

TABLE 29

| | Evaluation results | | | |
|---|---|---|---|---|
| | die buildup | YI | neck-in resistance | discharge amount |
| | — | — | — | kg/hr |
| Example 4-1 | A | 10 | A | 1.6 |
| Example 4-2 | A | 14 | A | 1.0 |
| Example 4-3 | A | 12 | A | 1.3 |
| Example 4-4 | A | 9 | A | 0.7 |
| Example 4-5 | A | 13 | A | 1.2 |
| Example 4-6 | A | 10 | A | 0.6 |
| Example 4-7 | A | 16 | A | 1.5 |
| Example 4-8 | A | 16 | A | 1.5 |
| Example 4-9 | A | 11 | A | 1.3 |
| Example 4-10 | A | 9 | A | 1.7 |
| Example 4-11 | B | 13 | B | 1.6 |
| Example 4-12 | A | 11 | B | 1.6 |
| Example 4-13 | A | 18 | A | 0.1 |
| Example 4-14 | A | 8 | A | 0.4 |
| Comparative | E | 34 | B | 1.6 |
| Example 4-1 | | | | |
| Comparative | A | 11 | D | 1.6 |
| Example 4-2 | | | | |

As shown in Tables 27 to 29, the resin compositions of Examples 4-1 to 4-4 resulted in neck-in and die buildup being inhibited, and of these, the resin compositions of Examples 4-1 to 4-12, which contain the nonionic surfactant in an appropriate amount, resulted in a large discharge amount. Furthermore, in the case in which the nonionic surfactant is contained, coloring tends to be inhibited, and of these, in the case in which the etheric nonionic surfactant (E) is contained, as in Examples 4-1 to 4-6, 4-9 to 4-12, and 4-14, it is revealed that coloring is further inhibited.

### Example 4-15

A multilayer structure (resin composition layer/adhesive resin layer/linear low-density polyethylene layer/adhesive resin layer/resin composition layer=20/10/50/10/20 (μm)) was obtained under the following conditions by using linear low-density polyethylene (“ULTZEX (registered trademark) 3520L”, manufactured by Prime Polymer Co., Ltd.), anhydrous maleic acid-modified polyethylene (“Admer (registered trademark) NF528”, manufactured by Mitsui Chemicals, Inc.) as the adhesive resin, and the dried resin composition pellets of Example 4-1.

### Film Forming Conditions

Extruder for resin composition: single-screw extruder (ME model CO-EXT, manufactured by Toyo Seiki Seisaku-sho, Ltd.)

Port diameter: 20 mmφ, L/D: 20, screw: full flight type

Feeding zone/compression zone/metering zone/die=175/210/220/230° C.

Extruder for LLDPE: single-screw extruder (GT-32-A, manufactured by Research Laboratory of Plastics Technology Co., Ltd.)

Port diameter: 32 mmφ, L/D: 28, screw: full flight type

Feeding zone/compression zone/metering zone/die=150/210/220/230° C.

Extruder for adhesive resin: single-screw extruder (SZW20GT-20MG-STD, manufactured by Technovel Corporation)

Port diameter: 20 mmφ, L/D: 20, screw: full flight type

Feeding zone/compression zone/metering zone/die=150/210/220/230° C.

Die: 300 mm width coat hanger die (manufactured by Research Laboratory of Plastics Technology Co., Ltd.)

Temperature of drawing roll: 80° C.

The neck-in and the die buildup at the time of producing the multilayer structure were inhibited, and the target multilayer structure was able to be formed without issue.

### Example 5-1

Resin compositions were obtained by dry-blending 0.5 parts by mass of N,N′-(hexane-1,6-diyl) bis[3-(3,5-di-tert-butyl-4-hydroxyphenyl) propionamide](“Irganox 1098,” manufactured by BASF Japan Ltd.; molecular weight: 637) as an antioxidant, with 100 parts by mass of the dried resin composition pellets obtained in Example 1-5, and extruding a resulting mixture in a nitrogen atmosphere at an extrusion temperature of 220° C. by using a 30 mmφ co-rotation twin screw extruder (“TEX-30N,” manufactured by The Japan Steel Works, Ltd.).

### Examples 5-2 and 5-4 to 5-8, and Comparative Examples 5-1 and 5-2

Resin composition pellets of each of Examples 5-2 and 5-4 to 5-8 and Comparative Examples 5-1 and 5-2 were obtained by a similar operation to that of Example 5-1, except that the dried resin composition pellets used and the blending amount of the antioxidant were as shown in Tables 30 and 31.

### Example 5-3

Resin composition pellets were obtained by dry-blending 90 parts by mass of the dried resin composition pellets obtained in Example 5-48 with 10 parts by mass of “TAFMER (registered trademark) MH 7020” (manufactured by Mitsui Chemicals, Inc., maleic anhydride-modified ethylene-butene copolymer) as the thermoplastic elastomer (F-1) and 0.5 parts by mass of the antioxidant (Irganox 1098), and then extruding a resulting mixture under the following conditions.

### Extruder Conditions

Apparatus: 30 mmφ twin-screw extruder
L/D: 45.5
Screw: fully intermeshing co-rotation type
Extrusion temperature (° C.): 220° C.
Rotation speed: 200 rpm
Discharge amount: 20 kg/hr

The dried resin composition pellets obtained in each of the Examples and the Comparative Examples were evaluated in accordance with the procedures described in the evaluation methods (5) to (9) and (21) to (23). The evaluation results are shown in Tables 30 to 32.

TABLE 30

| | Dried | EVOH (A) | | | | | Conjugated | |
|---|---|---|---|---|---|---|---|---|
| | resin | | ethylene | Unsaturated aliphatic aldehyde (B) | | | polyene (C) | |
| | composition | | unit | crotonaldehyde | 2,4-hexadienal | 2,4,6-octatrienal | | content |
| | pellets | | content | content b₁ | content b₂ | content b₃ | type | c |
| | used | type | (mol %) | ppm | ppm | ppm | — | ppm |
| Example | Example | A1 | 32.12 | 0.50 | 0.03 | 0.02 | sorbic | 5 |
| 5-1 | 1-5 | | | | | | acid | |
| Example | Example | A6 | 27.24 | 0.50 | 0.03 | 0.02 | sorbic | 5 |
| 5-2 | 1-48 | | | | | | acid | |
| Example | Example | A6 | 27.24 | 0.50 | 0.03 | 0.02 | sorbic | 5 |
| 5-3 | 1-48 | | | | | | acid | |
| Example | Example | A6 | 27.24 | 0.50 | 0.03 | 0.02 | sorbic | 5 |
| 5-4 | 1-48 | | | | | | acid | |
| Example | Example | A4 | 44.28 | 0.50 | 0.03 | 0.02 | sorbic | 5 |
| 5-5 | 1-38 | | | | | | acid | |
| Example | Example | A1 | 32.12 | 0.50 | 0.05 | 0.04 | sorbic | 5 |
| 5-6 | 1-2 | | | | | | acid | |
| Example | Example | A1 | 32.12 | 0.50 | 0.01 | 0.01 | sorbic | 5 |
| 5-7 | 1-7 | | | | | | acid | |
| Example | Example | A1 | 32.12 | 0.50 | 0.03 | 0.02 | sorbic | 5 |
| 5-8 | 1-5 | | | | | | acid | |
| Comparative | Comparative | A1 | 32.12 | 4.10 | 0.50 | 0.10 | sorbic | 5 |
| Example | Example | | | | | | acid | |
| 5-1 | 1-4 | | | | | | | |
| Comparative | Comparative | A1 | 32.12 | 0.50 | 0.00 | 0.00 | sorbic | 5 |
| Example | Example | | | | | | acid | |
| 5-2 | 1-3 | | | | | | | |

TABLE 31

| | | | | Antioxidant (F) | | | |
|---|---|---|---|---|---|---|---|
| | | | | | blending | | Blending |
| | | b₁ + | | | amount | Thermoplastic | proportion |
| | b₁/(b₂ + | b₂ + | b₂ + | | parts | elastomer | (G/A) |
| | b₃) | b₃ | 2b₃ | type | by | (G) | (parts |
| | — | ppm | ppm | — | mass | type | by mass) |
| Example | 10.0 | 0.55 | 0.07 | Irganox 1098 | 0.5 | — | 0/100 |
| 5-1 | | | | | | | |
| Example | 10.0 | 0.55 | 0.07 | Irganox 1098 | 1.0 | — | 0/100 |
| 5-2 | | | | | | | |
| Example | 10.0 | 0.55 | 0.07 | Irganox 1098 | 0.5 | F-1 | 10/90 |
| 5-3 | | | | | | | |
| Example | 10.0 | 0.55 | 0.07 | Irganox 1098 | 0.5 | — | 0/100 |
| 5-4 | | | | | | | |
| Example | 10.0 | 0.55 | 0.07 | Irganox 1098 | 0.5 | — | 0/100 |
| 5-5 | | | | | | | |
| Example | 5.6 | 0.59 | 0.13 | Irganox 1098 | 0.5 | — | 0/100 |
| 5-6 | | | | | | | |
| Example | 25.0 | 0.52 | 0.03 | Irganox 1098 | 0.5 | — | 0/100 |
| 5-7 | | | | | | | |
| Example | 10.0 | 0.55 | 0.07 | — | 0 | — | 0/100 |
| 5-8 | | | | | | | |
| Comparative | 6.8 | 4.60 | 0.70 | Irganox 1098 | 0.5 | — | 0/100 |
| Example | | | | | | | |
| 5-1 | | | | | | | |
| Comparative | — | 0.50 | 0.00 | Irganox 1098 | 0.5 | — | 0/100 |
| Example | | | | | | | |
| 5-2 | | | | | | | |

TABLE 32

| | Evaluation results | | | | | | |
|---|---|---|---|---|---|---|---|
| | | | | oxidative | pipe gas barrier properties | | |
| | die | | neck-in | degradation | before heat treatment | after heat treatment | pipe die |
| | buildup | YI | resistance | resistance | cm³/m² · day · atm | | buildup |
| | — | — | — | hr | 20° C. 65% RH | | — |
| Example 5-1 | A | 10 | A | 245 | 0.052 | 0.066 | A |
| Example 5-2 | A | 13 | A | 285 | 0.032 | 0.038 | A |
| Example 5-3 | A | 13 | A | 230 | 0.049 | 0.050 | A |
| Example 5-4 | A | 13 | A | 240 | 0.032 | 0.042 | A |
| Example 5-5 | A | 9 | A | 238 | 0.335 | 0.380 | A |
| Example 5-6 | B | 13 | B | 229 | 0.052 | 0.068 | B |
| Example 5-7 | A | 11 | B | 242 | 0.053 | 0.064 | A |
| Example 5-8 | A | 18 | A | 75 | 0.052 | 4.23 | A |
| Comparative Example 5-1 | E | 34 | B | 223 | 0.066 | 0.078 | E |
| Comparative Example 5-2 | A | 11 | D | 234 | 0.082 | 0.097 | A |

As shown in Tables 30 to 32, the resin compositions of each of Examples 5-1 to 5-8 resulted in the neck-in and the die buildup being inhibited. The molded products obtained from the resin compositions of each of Examples 5-1 to 5-7, which contained the antioxidant, were superior in oxidative degradation resistance. From the resin compositions of each of Examples 5-1 to 5-7, it was confirmed that molded products and the like which can be used over a long time period at a high temperature can be obtained.

### Examples 6-1 to 6-7 and Comparative Examples 6-1 and 6-2

The dried resin composition pellets obtained in each of Examples 1-5, 1-28, 1-38, 1-43, 1-48, 1-2, and 1-7, and Comparative Examples 1-4 and 1-3, were evaluated in accordance with the procedures described in evaluation methods (13), (14), and 24). In (24) Evaluation of Thermoformability (B), the die of (a) was used. The evaluation results are shown in Table 33. Furthermore, in Table 33, the results of the evaluations described in evaluation methods (7) to (9) for each of these dried resin composition pellets is reshown.

TABLE 33

| | Evaluation results | | | | | |
|---|---|---|---|---|---|---|
| | | | | | width | melt-molded |
| | | | | OTR of central | direction | container |
| | die | | neck-in | portion of film | uniformity of | bottom |
| | buildup | YI | resistance | mL/m2 · day · atm | OTR | appearance |
| | — | — | — | 20° C. 65% RH | — | — |
| Example 6-1 | A | 12 | A | 0.30 | A | A |
| (Example 1-5)* | | | | | | |
| Example 6-2 | A | 12 | A | 0.29 | A | A |
| (Example 1-28)* | | | | | | |
| Example 6-3 | A | 10 | B | 2.23 | A | A |
| (Example 1-38)* | | | | | | |
| Example 6-4 | A | 13 | B | 0.15 | A | B |
| (Example 1-43)* | | | | | | |
| Example 6-5 | A | 13 | A | 0.14 | A | B |
| (Example 1-48)* | | | | | | |
| Example 6-6 | B | 13 | B | 0.30 | B | C |
| (Example 1-2)* | | | | | | |
| Example 6-7 | A | 11 | B | 0.30 | B | B |
| (Example 1-7)* | | | | | | |
| Comparative Example 6-1 | E | 42 | B | 0.30 | A | D |
| (Comparative Example 1-4)* | | | | | | |
| Comparative Example 6-2 | A | 11 | D | 0.30 | C | A |
| (Comparative Example 1-3)* | | | | | | |

*Example 1-5 and the like, being parenthesized, indicate the type of the resin composition used. In other words, the resin composition of Example 6-1 is that prepared in Example 1-5.

### Example 6-8

Into a 60 L stirring tank equipped with a jacket, a stirrer, and a reflux condenser were charged 1.6 kg of the crude dry EVOH (A1) obtained in Synthesis Example 1, 0.4 kg of the crude dry EVOH (A7) obtained in Synthesis Example 7, 0.8 kg of water, and 2.2 kg of MeOH, and a resulting mixture was completely dissolved by stirring at 60° C. for 5 hrs. To a thus obtained solution were added sorbic acid, crotonaldehyde, 2,4-hexadienal, and 2,4,6-octatrienal. This solution was extruded through a die plate with a diameter of 4 mm in a mixed liquid of water/MeOH in a ratio of 90/10 cooled to −5° C. to permit deposition into a strand form, and the strand was cut into a pellet form with a strand cutter to give hydrous EVOH pellets. A moisture content of the hydrous pellets of EVOH thus obtained was measured with “HR73,” a halogen moisture analyzer manufactured by Mettler-Toledo International Inc., and was 52% by mass.

The hydrous EVOH pellets thus obtained were charged into a 1 g/L aqueous acetic acid solution (bath ratio of 20) and washed for 2 hrs with stirring. The washed hydrous EVOH pellets were deliquored, and further charged into a 1 g/L aqueous acetic acid solution (bath ratio of 20), and washed for 2 hrs with stirring. After the deliquoring, the aqueous acetic acid solution was renewed, and the same operation was repeated. An operation in which the hydrous EVOH pellets, having been washed with the aqueous acetic acid solution and then deliquored, were charged into ion exchanged water (bath ratio of 20), washed for 2 hrs with stirring, and deliquored was carried out 3 times, and purification was carried out until an electrical conductivity of the washing liquid became 3 μs/cm or less (measured with “CM-30ET,” manufactured by DKK-TOA Corporation) to give hydrous EVOH pellets from which catalyst residue generated in the saponification reaction was eliminated.

The hydrous pellets thus obtained were charged into an aqueous solution (bath ratio of 20) in which a concentration of sodium acetate was 0.510 g/L, a concentration of acetic acid was 0.8 g/L, a concentration of phosphoric acid was 0.04 g/L, and a concentration of boric acid was 0.05 g/L, and the mixture was immersed for 4 hrs with stirring at regular intervals to perform a chemical treatment. The pellets were deliquored and then dried at 80° C. for 3 hrs and 105° C. for 16 hrs in a nitrogen atmosphere with an oxygen concentration of 1% by volume or less to give dried resin composition pellets having a circular cylindrical shape (average diameter of 2.8 mm, average length of 3.2 mm), and containing the EVOHs (A1) and (A7), acetic acid, phosphoric acid, boric acid, a sodium ion (sodium salt), crotonaldehyde, 2,4-hexadienal, 2,4,6-octatrienal, and sorbic acid. The dried resin composition pellets thus obtained were evaluated in accordance with the procedures described in the evaluation methods (2), (3), (5) to (7), (9), (13), 14), and (24). In (24) Evaluation of Thermoformability (B), the die of (b) was used. In the dried resin composition pellets, the sodium ion content was 100 ppm, the phosphoric acid content in terms of a phosphate radical equivalent was 40 ppm, and the acetic acid content was 200 ppm. Contents of the components other than EVOH are each amounts with respect to the content of EVOH. The other evaluation results are shown in Tables 34 to 36. It is to be noted that the added amounts of each of the components of crotonaldehyde, 2,4-hexadienal, 2,4,6-octatrienal, and sorbic acid were adjusted such that a content of each was as described in Table 35.

### Examples 6-10, 6-12, and 6-13, and Comparative Examples 6-3 and 6-4

Dried resin composition pellets were produced by a similar operation to that of Example 6-8, except that the type of the EVOH (Aa), the type of the EVOH (Ab), the mass ratio (Aa)/(Ab), the boric acid content, and the content of the unsaturated aldehyde (B) were changed as described in Tables 34 and 35. In the dried resin composition pellets, the sodium ion content was 100 ppm, the phosphoric acid content in terms of a phosphate radical equivalent was 40 ppm, and the acetic acid content was 200 ppm. Contents of the components other than EVOH are each amounts with respect to the content of EVOH. The other evaluation results are shown in Tables 34 to 36. It is to be noted that the boric acid concentration of the aqueous solution to be used in the chemical treatment was appropriately adjusted such that the boric acid content in the dried resin composition pellets obtained was as shown in Table 34.

### Example 6-9

A group of dried resin composition pellets was obtained by dry-blending 80 parts by mass of the dried resin composition pellets obtained in Example 1-5 with 20 parts by mass of the dried resin composition pellets obtained in Example 1-53. Resin composition pellets were obtained by extruding the group of dried resin composition pellets using a 30 mmφ double screw extruder (“TEX-30SS-30CRW-2V,” manufactured by The Japan Steel Works, Ltd.) under conditions involving an extruding temperature of 200° C., a screw rotation speed of 300 rpm, and a resin extrusion amount of 25 kg/hr, performing pelletizing, and then performing hot-air drying at 80° C. for 2 hrs. The dried resin composition pellets thus obtained were evaluated in accordance with the procedures described in the evaluation methods (2), (3), (5) to (7), (9), (13), (14), and (24). In (24) Evaluation of Thermoformability (B), the die of (b) was used. The results are shown in Tables 34 to 36.

### Example 6-11

A group of dried resin composition pellets was obtained by dry-blending 90 parts by mass of the dried resin composition pellets obtained in Example 1-48 with 10 parts by mass of the EVOH (A9) obtained in Synthesis Example 9. Resin composition pellets were obtained by extruding the group of dried resin composition pellets using a 30 mmφ double screw extruder (“TEX-30SS-30CRW-2V,” manufactured by The Japan Steel Works, Ltd.) under conditions involving an extruding temperature of 200° C., a screw rotation speed of 300 rpm, and a resin extrusion amount of 25 kg/hr, performing pelletizing, and then performing hot-air drying at 80° C. for 2 hrs. The dried resin composition pellets thus obtained were evaluated in accordance with the procedures described in the evaluation methods (2), (3), (5) to (7), (9), (13), (14), and (24). In (24) Evaluation of Thermoformability (B), the die of (b) was used. The results are shown in Tables 34 to 36.

TABLE 34

| | EVOH (Aa) | | | EVOH (Ab) | | | Mass ratio | Ethylene unit | Melting | Boric |
|---|---|---|---|---|---|---|---|---|---|---|
| | | ethylene unit | melting | | ethylene unit | melting | (Aa/Ab) | content | point | acid |
| | | content | point | | content | point | (parts by | difference | difference | content |
| | type | (mol %) | (° C.) | type | (mol %) | (° C.) | mass) | (Ab − Aa) | ° C. | ppm |
| Example 6-8 | A1 | 32.12 | 183 | A7 | 47.88 | 157 | 80/20 | 16 | 26 | 160 |
| Example 6-9 | Example | 32.12 | 183 | Example | 47.88 | 157 | 80/20 | 16 | 26 | 160 |
| | 1-5 | | | 1-53 | | | | | | |
| Example 6-10 | A6 | 27.24 | 190 | A7 | 47.88 | 157 | 80/20 | 21 | 33 | 800 |
| Example 6-11 | Example | 27.24 | 190 | A9 | 44.28 | 106 | 90/10 | 17 | 84 | 720 |
| | 1-48 | | | | | | | | | |
| Example 6-12 | A1 | 32.12 | 183 | A7 | 47.88 | 157 | 80/20 | 16 | 26 | 160 |
| Example 6-13 | A1 | 32.12 | 183 | A7 | 47.88 | 157 | 80/20 | 16 | 26 | 160 |
| Comparative | A1 | 32.12 | 183 | A7 | 47.88 | 157 | 80/20 | 16 | 26 | 160 |
| Example 6-3 | | | | | | | | | | |
| Comparative | A1 | 32.12 | 183 | A7 | 47.88 | 157 | 80/20 | 16 | 26 | 160 |
| Example 6-4 | | | | | | | | | | |

TABLE 35

| | Unsaturated aliphatic aldehyde (B) | | | | | | | |
|---|---|---|---|---|---|---|---|---|
| | crotonaldehyde | 2,4-hexadienal | 2,4,6-octatrienal | Conjugated polyene (C) | | | | |
| | content b₁ | content b₂ | content b₃ | type | content c | b₁/(b₂ + b₃) | b₁ + b₂ + b₃ | b₂ + 2b₃ |
| | ppm | ppm | ppm | — | ppm | — | ppm | ppm |
| Example 6-8 | 0.50 | 0.03 | 0.02 | sorbic acid | 5 | 10.0 | 0.55 | 0.07 |
| Example 6-9 | 0.50 | 0.03 | 0.02 | sorbic acid | 5 | 10.0 | 0.55 | 0.07 |
| Example 6-10 | 0.50 | 0.03 | 0.02 | sorbic acid | 5 | 10.0 | 0.55 | 0.07 |
| Example 6-11 | 0.50 | 0.03 | 0.02 | sorbic acid | 5 | 10.0 | 0.55 | 0.07 |
| Example 6-12 | 0.50 | 0.05 | 0.04 | sorbic acid | 5 | 5.6 | 0.59 | 0.13 |
| Example 6-13 | 0.50 | 0.01 | 0.01 | sorbic acid | 5 | 25 | 0.52 | 0.03 |
| Comparative | 4.10 | 0.50 | 0.10 | sorbic acid | 5 | 6.8 | 4.60 | 0.70 |
| Example 6-3 | | | | | | | | |
| Comparative | 0.50 | 0.00 | 0.00 | sorbic acid | 5 | — | 0.50 | 0.00 |
| Example 6-4 | | | | | | | | |

TABLE 36

| | Evaluation results | | | | |
|---|---|---|---|---|---|
| | | | OTR of | | |
| | | | central | | |
| | | | portion | | |
| | | | of film | width | melt-molded |
| | die | | mL/m² · | direction | container |
| | build- | neck-in | day · atm | uniformity | bottom |
| | up | resistance | 20° C. | of OTR | appearance |
| | — | — | 65% RH | — | — |
| Example 6-8 | A | A | 0.36 | A | A |
| Example 6-9 | A | A | 0.36 | A | A |
| Example 6-10 | A | A | 0.16 | A | A |
| Example 6-11 | A | A | 0.20 | A | A |
| Example 6-12 | B | B | 0.36 | B | C |
| Example 6-13 | A | B | 0.36 | B | B |
| Comparative | E | B | 0.36 | A | D |
| Example 6-3 | | | | | |
| Comparative | A | D | 0.36 | C | A |
| Example 6-4 | | | | | |

As shown in Tables 33 to 36, in the thermoformed containers of each of Comparative Examples 6-1 and 6-3, in which the resin compositions which are susceptible to die buildup were used, the appearance of the bottom was unfavorable. Moreover, in the vapor deposition film of each of Comparative Examples 6-2 and 6-4, in which the resin compositions which are susceptible to neck-in were used, the width direction uniformity of the OTR was low. In contrast, Examples 6-1 to 6-13, in which the resin compositions which inhibited die buildup and neck-in were used, enabled improving the OTR at the center, the appearance of the bottom, and the width direction uniformity of the OTR. It is revealed that according to the resin compositions used in Examples 6-1 to 6-13, a thermoformed container having superior gas barrier uniformity and favorable appearance can be obtained.

### Examples 7-1 to 7-7 and Comparative Examples 7-1 and 7-2

### Production of Blow-Molded Container Having EVOH as Outermost Layer

Using the dried resin composition pellets (resin compositions) obtained in Examples 1-5, 1-28, 1-38, 1-43, 1-48, 1-2, and 1-7, and Comparative Examples 1-4 and 1-3, polypropylene (“Novatec PP EA7 AD,” manufactured by Japan Polypropylene Corporation; MFR at 190° C., under load of 2,160 g=1.5 g/10 min; meltability parameter=9.1), and an adhesive resin (“Admer QF500,” manufactured by Mitsui Chemicals, Etc.; MFR at 190° C., under load of 2,160 g=1.10 g/10 min), blow-molded containers having 4 layers each selected from 3 types, having the layer configuration of (inner side) polypropylene/polypropylene/adhesive resin/resin composition (EVOH) (outer side), were produced with “MSD-C44A/43R-AP (C2)”, a blow molding machine manufactured by Tahara Machinery Ltd, and subjected to evaluation. It is to be noted that in the production of the blow-molded containers, a temperature in the die was set to 15° C. and cooling was performed for 20 sec to obtain a 0.5 L tank having an overall average thickness of 1,300 μm ((inner side) polypropylene/polypropylene/adhesive resin/resin composition (EVOH) (outer side)=(inner side) 200/1,000/40/60 μm (outer side)). A diameter of a bottom of the tank obtained was 45 mm, and a height thereof was 120 mm. The blow-molded container (tank) thus obtained was evaluated in accordance with the procedures described in the evaluation methods (25 to (27). The results are shown in Table 37. Furthermore, in Table 37, the results of the evaluations described in evaluation methods (7) to (9) for each of the dried resin composition pellets used is reshown.

TABLE 37

| | | | | Blow-molded container evaluation results | | |
|---|---|---|---|---|---|---|
| | | | | | | innermost |
| | | | | outermost layer | | layer |
| | Resin composition evaluation results | | | EVOH | | EVOH |
| | | | neck-in | | transportation | impact |
| | die buildup | YI | resistance | appearance | evaluation | resistance |
| Example 7-1 | A | 12 | A | A | A | A |
| (Example 1-5)* | | | | | | |
| Example 7-2 | A | 12 | A | A | A | A |
| (Example 1-28)* | | | | | | |
| Example 7-3 | A | 10 | B | A | A | A |
| (Example 1-38)* | | | | | | |
| Example 7-4 | A | 13 | B | A | A | B |
| (Example 1-43)* | | | | | | |
| Example 7-5 | A | 13 | A | A | A | B |
| (Example 1-48)* | | | | | | |
| Example 7-6 | B | 13 | B | B | B | B |
| (Example 1-2)* | | | | | | |
| Example 7-7 | A | 11 | B | A | A | A |
| (Example 1-7)* | | | | | | |
| Comparative Example 7-1 | E | 42 | B | C | C | C |
| (Comparative Example 1-4)* | | | | | | |
| Comparative Example 7-2 | A | 11 | D | C | C | C |
| (Comparative Example 1-3)* | | | | | | |

*Example 1-2 and the like, being parenthesized, indicate the type of the resin composition used. In other words, the resin composition of Example 7-1 is that prepared in Example 1-5.

As shown in Table 37, in the blow-molded containers of each of Comparative Examples 7-1 and 7-2, in which the resin compositions of Comparative Examples 1-4 and 1-3, which are susceptible to neck-in and die buildup, were used, the appearance, the transportation evaluation, and the impact resistance were unfavorable. In contrast, the blow-molded containers of Examples 7-1 to 7-7, in which the resin compositions of Examples 1-5, 1-28, 1-38, 1-43, 1-48, 1-2, and 1-7, which inhibited the neck-in and die buildup, were used, enabled improving the appearance, the transportation evaluation, and the impact resistance.

### Example 8-1

Production of Vapor Deposition Film in which Monolayer Film is Used

The dried resin composition pellets (resin composition) obtained in Example 1-5 were melted at 240° C. using a single-screw extruder, and simultaneously with extrusion onto casting rollers from the die, air was blown at a velocity of 30 m/sec by using an air knife to give an unstretched film (monolayer) having a thickness of 170 in. The unstretched film thus obtained was brought into contact with hot water at 80° C. for 10 sec, and by using a tenter-type simultaneous biaxial stretching machine, the film was stretched 3.2 times in the machine direction and 3.0 times in the width direction in an atmosphere of 90° C. Furthermore, the stretched film was subjected to a heat treatment in the tenter at 170° C. for 5 sec. Then the film edge was cut away to obtain a roll of biaxially stretched film (average thickness of 12 μm, width of 50 cm, roll length of 4,000 m).

A vapor deposition film was obtained by using batch-type vapor deposition equipment “EWA-105,” manufactured by ULVAC, Inc., on the biaxially stretched film obtained as described above as a base layer to allow vapor deposition of aluminum on one side of the film, at a film surface temperature of 38° C. and a film traveling speed of 200 m/min.

The dried resin composition pellets (resin composition) of Example 1-5 which were used were evaluated in accordance with the procedures described in the evaluation methods (13) and (14). Furthermore, the vapor deposition film obtained was evaluated in accordance with the procedures described in the evaluation methods (15-3), (16), (28), and (29). The evaluation results are shown in Table 39. It is to be noted that the other evaluation results described above for the dried resin composition pellets of Example 1-5 used are reshown in Tables 38 and 39.

### Examples 8-2 to 8-7 and Comparative Examples 8-1 and 8-2

Vapor deposition films were produced by a similar operation to that of Example 8-1, except that the dried resin composition pellets obtained in each of Examples 1-28, 1-38, 1-43, 1-48, 1-2, and 1-7, and Comparative Examples 1-4 and 1-3 were used. The dried resin composition pellets used and the vapor deposition films obtained evaluated in accordance with the procedures described in the evaluation methods (13), (14), (15-3), (16), (28), and (29). The evaluation results are shown in Table 39. Furthermore, the other evaluation results described above for the dried resin composition pellets of each Example or Comparative Example used are reshown in Tables 38 and 39.

### Example 8-8

The EVOH dried resin composition pellets (A10) obtained in Synthesis Example 10 were evaluated in accordance with the procedures described in the evaluation methods (5) to (10), (13), and (14). The evaluation results are shown in Tables 38 and 39.

Furthermore, a vapor deposition film was produced by a similar operation to that of Example 8-1, except that the dried resin composition pellets of this EVOH (A10) were used, and the evaluations of (15-3), (16), (28), and (29), described above, were performed. The evaluation results are shown in Table 39.

TABLE 38

| | EVOH (A) | | | Unsaturated aliphatic aldehyde (B) | | | Conjugated | | | | |
|---|---|---|---|---|---|---|---|---|---|---|---|
| | | ethylene | | | 2,4- | 2,4,6- | polyene (C) | | | | |
| | | unit | melting | crotonaldehyde | hexadienal | octatrienal | | content | | | |
| | | content | point | content b₁ | content b₂ | content b₃ | type | c | b₁/(b₂ + b₃) | b₁ + b₂ + b₃ | b₂ + 2b₃ |
| | type | (mol %) | (° C.) | ppm | ppm | ppm | — | ppm | — | ppm | ppm |
| Example 8-1 | A1 | 32.12 | 183 | 0.50 | 0.03 | 0.02 | sorbic | 5 | 10.0 | 0.55 | 0.07 |
| (Example 1-5)* | | | | | | | acid | | | | |
| Example 8-2 | A2 | 31.87 | 183 | 0.50 | 0.03 | 0.02 | sorbic | 5 | 10.0 | 0.55 | 0.07 |
| (Example 1-28)* | | | | | | | acid | | | | |
| Example 8-3 | A4 | 44.28 | 165 | 0.50 | 0.03 | 0.02 | sorbic | 5 | 10.0 | 0.55 | 0.07 |
| (Example 1-38)* | | | | | | | acid | | | | |
| Example 8-4 | A5 | 27.32 | 190 | 0.50 | 0.03 | 0.02 | sorbic | 5 | 10.0 | 0.55 | 0.07 |
| (Example 1-43)* | | | | | | | acid | | | | |
| Example 8-5 | A6 | 27.24 | 190 | 0.50 | 0.03 | 0.02 | sorbic | 5 | 10.0 | 0.55 | 0.07 |
| (Example 1-48)* | | | | | | | acid | | | | |
| Example 8-6 | A1 | 32.12 | 183 | 0.50 | 0.05 | 0.04 | sorbic | 5 | 5.6 | 0.59 | 0.13 |
| (Example 1-2)* | | | | | | | acid | | | | |
| Example 8-7 | A1 | 32.12 | 183 | 0.50 | 0.01 | 0.01 | sorbic | 5 | 25.0 | 0.52 | 0.03 |
| (Example 1-7)* | | | | | | | acid | | | | |
| Example 8-8 | A10 | 27.32 | 125 | 0.50 | 0.03 | 0.02 | sorbic | in | 10.0 | 0.55 | 0.07 |
| (Synthesis | | | | | | | acid | | | | |
| Example 10)* | | | | | | | | | | | |
| Comparative | A1 | 32.12 | 183 | 4.10 | 0.50 | 0.10 | sorbic | 5 | 6.8 | 4.60 | 0.70 |
| Example 8-1 | | | | | | | acid | | | | |
| (Comparative | | | | | | | | | | | |
| Example 1-4)* | | | | | | | | | | | |
| Comparative | A1 | 32.12 | 183 | 0.50 | 0.00 | 0.00 | sorbic | 5 | — | 0.50 | 0.00 |
| Example 8-2 | | | | | | | acid | | | | |
| (Comparative | | | | | | | | | | | |
| Example 1-3)* | | | | | | | | | | | |

*Example 1-5 and the like, being parenthesized, indicate the type of the resin composition used. In other words, the resin composition of Example 8-1 is that prepared in Example 1-5.

TABLE 39

| | Resin composition evaluation results | | | | | | | | |
|---|---|---|---|---|---|---|---|---|---|
| | | | | monolayer film | | Vapor deposition film evaluation results | | | |
| | | | | | width | average thickness | vapor deposition | | |
| | | | neck-in | | direction | of inorganic vapor | flaw-inhibiting | adhesion | |
| | die buildup | YI | resistance | | uniformity | deposition layer | property | strength | OTR |
| | — | — | — | OTR* | of OTR | nm | — | — | — |
| Example 8-1 | A | 12 | A | 0.30 | A | 50 | A | A | A |
| (Example 1-5)* | | | | | | | | | |
| Example 8-2 | A | 12 | A | 0.29 | A | 50 | A | A | A |
| (Example 1-28)* | | | | | | | | | |
| Example 8-3 | A | 10 | B | 2.23 | A | 50 | A | A | A |
| (Example 1-38)* | | | | | | | | | |
| Example 8-4 | A | 13 | B | 0.15 | A | 50 | A | A | A |
| (Example 1-43)* | | | | | | | | | |
| Example 8-5 | A | 13 | A | 0.14 | A | 50 | A | A | A |
| (Example 1-48)* | | | | | | | | | |
| Example 8-6 | B | 13 | B | 0.30 | B | 50 | B | B | B |
| (Example 1-2)* | | | | | | | | | |
| Example 8-7 | A | 11 | B | 0.30 | B | 50 | A | A | A |
| (Example 1-7)* | | | | | | | | | |
| Example 8-8 | A | 20 | A | 9.57 | A | 50 | A | A | A |
| Synthesis Example 10)* | | | | | | | | | |
| Comparative Example 8-1 | E | 42 | B | 0.30 | B | 50 | C | C | B |
| (Comparative Example | | | | | | | | | |
| 1-4)* | | | | | | | | | |
| Comparative Example 8-2 | A | 11 | D | 0.30 | C | 50 | A | A | B |
| (Comparative Example | | | | | | | | | |
| 1-3)* | | | | | | | | | |

*Example 1-5 and the like, being parenthesized, indicate the type of the resin composition used. In other words, the resin composition of Example 8-1 is that prepared in Example 1-5.
*mL/m² · day · atm

### Example 8-9

Production of Vapor Deposition Film in which Multilayer Film is Used

A multilayer film having a circular elliptical shape was produced with an inflation extrusion molding machine under the following conditions using the dried resin composition pellets (resin composition) obtained in Example 1-5. It is to be noted that the thermoplastic resin layer (d) was laminated in 3 layers each having an average thickness of 30 μm, resulting in the thermoplastic resin layer (d) having an average thickness of 90 μm being one layer.

### Multilayer Film Production Conditions

Multilayer film layer configuration: [outer face side] thermoplastic resin layer (d)/adhesive layer (c)/base layer (α) [inner face side]=90 μm/20 μm/20 μm (overall thickness: 130 μm)

Thermoplastic resin layer (d): δ-1 (40ST05 polyethylene, manufactured by TOTAL)

Adhesive layer (c): γ-1 (Admer (registered trademark) NF528, manufactured by Mitsui Chemicals, Inc.)

Base layer (a): resin composition obtained in Example 1-5

Apparatus: inflation extrusion molding machine for 5 layers each selected from 5 types (manufactured by Dr. Collin)

Die temperature: 210° C.

Blow-up ratio: 2.7

Drawing speed: 4 m/min

Film-folding diameter width: 25 cm

### Conditions for Thermoplastic Resin Layer (d) Extruder 1

Extruder: 30 φ single screw extruder (manufactured by Dr. Collins)

Rotation speed: 60 rpm

Extrusion temperature: feeding zone/compression zone/metering zone=170° C./190° C./210° C.

### Conditions for Thermoplastic Resin Layer (d) Extruder 2

Extruder: 20 φ single screw extruder (manufactured by Dr. Collins)

Rotation speed: 70 rpm

Extrusion temperature: feeding zone/compression zone/metering zone=170° C./190° C./210° C.

### Conditions for Thermoplastic Resin Layer (d) Extruder 3

Extruder: 20 φ single screw extruder (manufactured by Dr. Collins)

Rotation speed: 70 rpm

Extrusion temperature: feeding zone/compression zone/metering zone=170° C./190° C./210° C.

### Conditions for Adhesive Layer (c) Extruder

Extruder: 20 φ single screw extruder (manufactured by Dr. Collins)

Rotation speed: 70 rpm

Extrusion temperature: feeding zone/compression zone/metering zone=170° C./190° C./210° C.

### Conditions for Base Layer (a) Extruder

Extruder: 30 φ single screw extruder (manufactured by Dr. Collins)

Rotation speed: 24 rpm

Extrusion temperature: feeding zone/compression zone/metering zone=190° C./210° C./210° C.

The multilayer film having the circular elliptical shape thus obtained was folded such that the base layer (a) layer overlapped, and was subjected to 6× monoaxial stretching in a vertical direction (MD direction) at 120° C. using a stretching apparatus (SDR-506WK) manufactured by ETO Co., Ltd. to give a stretched multilayer film (thermoplastic resin layer (d)/adhesive layer (c)/base layer (α)=15 μm/3.3 μm/3.3 μm).

Both ends of the stretched multilayer film obtained were cut to produce a planar multilayer film. A multilayer vapor deposition film (layer configuration: d/c/a/b) was produced by using “EWA-105,” manufactured by ULVAC, Inc., on the planar multilayer film thus obtained to allow vapor deposition of aluminum on the base layer (a) such that a thickness thereof was 50 nm.

The multilayer vapor deposition film thus obtained was subjected to oxygen transmission rate (OTR) measurement in accordance with the procedure described in evaluation method (29). The results are shown in Table 42.

### Production of Multilayer Structure

To the multilayer vapor deposition film thus obtained were further provided, as thermoplastic resin layers (d′), a monoaxially stretched PE film (d′-1) having a thickness of 30 μm and an LLDPE film (d′-2) having a thickness of 50 Nm to produce a multilayer structure having the following layer configuration: (monoaxially stretched PE film (d′-1)/adhesive layer (c′)/thermoplastic resin layer (d)/adhesive layer (c)/base layer (a)/inorganic vapor deposition layer (b)/adhesive layer (c′)/LLDPE (d′2)). When providing the monoaxially stretched PE film (d′-1) and the LLDPE film (d′-2) on the vapor deposition film (d/c/a/b), a two-component urethane adhesive (“TAKELAC A-520” and “TAKENATE A-50,” each manufactured by Mitsui Chemicals, Inc.) was applied such that a dried thickness thereof was 2 μm, whereby the adhesive layer (c′) was provided, and lamination was performed by a dry lamination procedure to give a multilayer structure.

The multilayer structure thus obtained was subjected to an evaluation on recyclability in accordance with the procedure described in evaluation method (30). The results are shown in Table 42.

It is to be noted that the other evaluation results described above for the dried resin composition pellets (resin composition) of Example 1-5, which were used in production of the multilayer vapor deposition film of Example 8-9, are reshown in Tables 40 to 42.

### Example 8-10

Into a 60 L stirring tank equipped with a jacket, a stirrer, and a reflux condenser were charged 1.6 kg of the crude dry EVOH (A1) obtained in Synthesis Example 1, 0.4 kg of the crude dry EVOH (A7) obtained in Synthesis Example 7, 0.8 kg of water, and 2.2 kg of MeOH, and a resulting mixture was completely dissolved by stirring at 60° C. for 5 hrs. To a thus obtained solution were added sorbic acid, crotonaldehyde, 2,4-hexadienal, and 2,4,6-octatrienal. This solution was extruded through a die plate with a diameter of 4 mm in a mixed liquid of water/MeOH in a ratio of 90/10 cooled to −5° C. to permit deposition into a strand form, and the strand was cut into a pellet form with a strand cutter to give hydrous EVOH pellets. A moisture content of the hydrous pellets of EVOH thus obtained was measured with “HR73,” a halogen moisture analyzer manufactured by Mettler-Toledo International Inc., and was 52% by mass.

The hydrous EVOH pellets thus obtained were charged into a 1 g/L aqueous acetic acid solution (bath ratio of 20) and washed for 2 hrs with stirring. The washed hydrous EVOH pellets were deliquored, and further charged into a 1 g/L aqueous acetic acid solution (bath ratio of 20), and washed for 2 hrs with stirring. After the deliquoring, the aqueous acetic acid solution was renewed, and the same operation was repeated. An operation in which the hydrous EVOH pellets, having been washed with the aqueous acetic acid solution and then deliquored, were charged into ion exchanged water (bath ratio of 20), washed for 2 hrs with stirring, and deliquored was carried out 3 times, and purification was carried out until an electrical conductivity of the washing liquid became 3 μs/cm or less (measured with “CM-30ET,” manufactured by DKK-TOA Corporation) to give hydrous EVOH pellets from which catalyst residue generated in the saponification reaction was eliminated.

The hydrous pellets thus obtained were charged into an aqueous solution (bath ratio of 20) in which a concentration of sodium acetate was 0.510 g/L, a concentration of acetic acid was 0.8 g/L, a concentration of phosphoric acid was 0.04 g/L, and a concentration of boric acid was 0.05 g/L, and the mixture was immersed for 4 hrs with stirring at regular intervals to perform a chemical treatment. The pellets were deliquored and then dried at 80° C. for 3 hrs and 105° C. for 16 hrs in a nitrogen atmosphere with an oxygen concentration of 1% by volume or less to give dried resin composition pellets having a circular cylindrical shape (average diameter of 2.8 mm, average length of 3.2 mm), and containing the EVOHs (A1 and A7), acetic acid, phosphoric acid, a sodium ion (sodium salt), crotonaldehyde, 2,4-hexadienal, 2,4,6-octatrienal, and sorbic acid. The dried resin composition pellets thus obtained were evaluated in accordance with the procedures described in the evaluation methods (2), (3), (5) to (9), (13), and (14). In the dried resin composition pellets, the sodium ion content was 100 ppm, the phosphoric acid content in terms of a phosphate radical equivalent was 40 ppm, and the acetic acid content was 200 ppm. Contents of the components other than EVOH are each amounts with respect to the content of EVOH. The other evaluation results are shown in Tables 40 to 42. It is to be noted that the added amounts of each of the components of crotonaldehyde, 2,4-hexadienal, 2,4,6-octatrienal, and sorbic acid were adjusted such that a content of each was as described in Table 41.

A vapor deposition film was produced by a similar operation to that of Example 8-1, except that the dried resin composition pellets obtained as described above were used, and the evaluations of (15-3), (16), and (28), described above, were performed. The evaluation results (evaluation results for the vapor deposition film) are shown in Table 42. Furthermore, a vapor deposition film was produced by a similar operation to that of Example 8-9, except that the dried resin composition pellets obtained as described above were used, and the evaluations of (29) and (30), described above, were performed. The evaluation results (evaluation results for the multilayer vapor deposition film) are shown in Table 42.

### Examples 8-12, 8-14, and 8-15, and Comparative Examples 8-3 and 8-4

Dried resin composition pellets, vapor deposition films, and multilayer structures were produced by similar operations to those of Example 8-10, except that the type of the EVOH (Aa), the type of the EVOH (Ab), the mass ratio (Aa)/(Ab), the boric acid content, the content of the unsaturated aldehyde (B), and the content of the conjugated polyene (C) were changed as described in Tables 40 and 41. In the dried resin composition pellets, the sodium ion content was 100 ppm, the phosphoric acid content in terms of a phosphate radical equivalent was 40 ppm, and the acetic acid content was 200 ppm. Contents of the components other than EVOH are each amounts with respect to the content of EVOH. The other evaluation results are shown in Tables 40 to 42. It is to be noted that the boric acid concentration of the aqueous solution to be used in the chemical treatment was appropriately adjusted such that the boric acid content in the dried resin composition pellets obtained was as shown in Table 40.

### Example 8-11

A group of dried resin composition pellets was obtained by dry-blending 80 parts by mass of the dried resin composition pellets obtained in Example 1-5 with 20 parts by mass of the dried resin composition pellets obtained in Example 1-53. Resin composition pellets were obtained by extruding the group of dried resin composition pellets using a 30 mmφ double screw extruder (“TEX-30SS-30CRW-2V,” manufactured by The Japan Steel Works, Ltd.) under conditions involving an extruding temperature of 200° C., a screw rotation speed of 300 rpm, and a resin extrusion amount of 25 kg/hr, performing pelletizing, and then performing hot-air drying at 80° C. for 2 hrs. The dried resin composition pellets thus obtained were evaluated in accordance with the procedures described in the evaluation methods (2), (3), (5) to (9), (13), and (14). The results are shown in Tables 40 to 42. Furthermore, a vapor deposition film was produced by a similar operation to that of Example 8-1, except that the dried resin composition pellets obtained as described above were used, and the evaluations of (15-3), (16), and (28), described above, were performed. The evaluation results (evaluation results for the vapor deposition film) are shown in Table 42. Furthermore, a vapor deposition film and a multilayer structure were produced by similar operations to those of Example 8-9, except that the dried resin composition pellets obtained as described above were used, and the evaluations of (29) and (30), described above, were performed. The evaluation results (evaluation results for the multilayer vapor deposition film) are shown in Table 42.

### Example 8-13

Dried resin composition pellets were obtained by a similar operation to that of Example 8-11, except for dry-blending 90 parts by mass of the dried resin composition pellets obtained in Example 1-48 with 10 parts by mass of the EVOH (A9) obtained in Synthesis Example 9. The dried resin composition pellets thus obtained were evaluated in accordance with the procedures described in the evaluation methods (2), (3), (5) to (9), (13), and (14). The results are shown in Tables 40 to 42. Furthermore, a vapor deposition film was produced by a similar operation to that of Example 8-1, except that the dried resin composition pellets obtained as described above were used, and the evaluations of (15-3), (16), and (28), described above, were performed. The evaluation results (evaluation results for the vapor deposition film) are shown in Table 42. Furthermore, a vapor deposition film and a multilayer structure were produced by similar operations to those of Example 8-9, except that the dried resin composition pellets obtained as described above were used, and the evaluations of (29) and (30), described above, were performed. The evaluation results (evaluation results for the multilayer vapor deposition film) are shown in Table 42.

TABLE 40

| | EVOH (Aa) | | | EVOH (Ab) | | | | Ethylene | | |
|---|---|---|---|---|---|---|---|---|---|---|
| | | ethylene | | | ethylene | | | unit | Melting | Boric |
| | | unit | melting | | unit | melting | Mass | content | point | acid |
| | | content | point | | content | point | ratio | difference | difference | content |
| | type | (mol %) | (° C.) | type | (mol %) | (° C.) | (Aa)/(Ab) | (Ab − Aa) | ° C. | ppm |
| Example 8-9 | Example 1-5 | 32.12 | 183 | — | — | — | 100/0 | — | — | 0 |
| Example 8-10 | A1 | 32.12 | 183 | A7 | 47.88 | 157 | 80/20 | 16 | 26 | 160 |
| Example 8-11 | Example 1-5 | 32.12 | 183 | Example 1-53 | 47.88 | 157 | 80/20 | 16 | 26 | 160 |
| Example 8-12 | A6 | 27.24 | 190 | A7 | 47.88 | 157 | 80/20 | 20 | 33 | 800 |
| Example 8-13 | Example 1-48 | 27.24 | 190 | A9 | 44.28 | 106 | 90/10 | 17 | 84 | 720 |
| Example 8-14 | A1 | 32.12 | 183 | A7 | 47.88 | 157 | 80/20 | 16 | 26 | 160 |
| Example 8-15 | A1 | 32.12 | 183 | A7 | 47.88 | 157 | 80/20 | 16 | 26 | 160 |
| Comparative | A1 | 32.12 | 183 | A7 | 47.88 | 157 | 80/20 | 16 | 26 | 160 |
| Example 8-3 | | | | | | | | | | |
| Comparative | A1 | 32.12 | 183 | A7 | 47.88 | 157 | 80/20 | 16 | 26 | 160 |
| Example 8-4 | | | | | | | | | | |

TABLE 41

| | EVOH blending procedure | | | | | | | | | |
|---|---|---|---|---|---|---|---|---|---|---|
| | | orthoboric | | | | | | | | |
| | | acid | | | | | | | | |
| | | concentration | Unsaturated aliphatic aldehyde (B) | | | Conjugated | | | | |
| | | during | | 2,4- | 2,4,6- | polyene (C) | | | | |
| | | chemical | crotonaldehyde | hexadienal | octatrienal | | content | b₁/(b₂ + b₃) | | |
| | mixing | treatment | content b₁ | content b₂ | content b₃ | type | c | - | b₁ + b₂ + b₃ | b₂ + 2b₃ |
| | procedure | g/L | ppm | ppm | ppm | — | ppm | — | ppm | ppm |
| Example 8-9 | — | — | 0.50 | 0.03 | 0.02 | sorbic | 5 | 10.0 | 0.55 | 0.07 |
| | | | | | | acid | | | | |
| Example | solution | 0.050 | 0.50 | 0.03 | 0.02 | sorbic | 5 | 10.0 | 0.55 | 0.07 |
| 8-10 | mixture | | | | | acid | | | | |
| Example | compound | — | 0.50 | 0.03 | 0.02 | sorbic | 5 | 10.0 | 0.55 | 0.07 |
| 8-11 | | | | | | acid | | | | |
| Example | solution | 0.250 | 0.50 | 0.03 | 0.02 | sorbic | 5 | 10.0 | 0.55 | 0.07 |
| 8-12 | mixture | | | | | acid | | | | |
| Example | compound | — | 0.50 | 0.03 | 0.02 | sorbic | 5 | 10.0 | 0.55 | 0.07 |
| 8-13 | | | | | | acid | | | | |
| Example | solution | 0.050 | 0.50 | 0.05 | 0.04 | sorbic | 5 | 5.6 | 0.59 | 0.13 |
| 8-14 | mixture | | | | | acid | | | | |
| Example | solution | 0.050 | 0.50 | 0.01 | 0.01 | sorbic | 5 | 25.0 | 0.52 | 0.03 |
| 8-15 | mixture | | | | | acid | | | | |
| Comparative | solution | 0.050 | 4.10 | 0.50 | 0.10 | sorbic | 5 | 6.8 | 4.60 | 0.70 |
| Example 8-3 | mixture | | | | | acid | | | | |
| Comparative | solution | 0.050 | 0.50 | 0.00 | 0.00 | sorbic | 5 | — | 0.50 | 0.00 |
| Example 8-4 | mixture | | | | | acid | | | | |

TABLE 42

| | | | | | | Vapor deposition film | | | | |
|---|---|---|---|---|---|---|---|---|---|---|
| | | | | | | evaluation results | | | | |
| | | | | | | average | | | | |
| | Resin composition evaluation results | | | | | thickness of | vapor | | | |
| | | | | monolayer film | | inorganic | deposition | | Multilayer vapor | |
| | | | | | width | vapor | flaw- | | deposition film | |
| | | | neck-in | | direction | deposition | inhibiting | adhesion | evaluation results | |
| | die buildup | YI | resistance | | uniformity | layer | property | strength | OTR | recyclability |
| | — | — | — | OTR* | of OTR | nm | — | — | — | — |
| Example 8-9 | A | 12 | A | 0.30 | A | 50 | A | A | B | A |
| Example 8-10 | A | 13 | A | 0.36 | A | 50 | A | A | A | A |
| Example 8-11 | A | 18 | A | 0.36 | A | 50 | A | A | A | B |
| Example 8-12 | A | 11 | A | 0.16 | A | 50 | A | A | B | A |
| Example 8-13 | A | 20 | A | 0.20 | A | 50 | A | A | A | B |
| Example 8-14 | B | 13 | B | 0.36 | B | 50 | B | B | B | B |
| Example 8-15 | A | 11 | B | 0.36 | B | 50 | A | A | A | A |
| Comparative | E | 42 | B | 0.36 | A | 50 | C | C | C | C |
| Example 8-3 | | | | | | | | | | |
| Comparative | A | 11 | D | 0.36 | C | 50 | A | A | A | C |
| Example 8-4 | | | | | | | | | | |

*mL/m² · day · atm

As shown in Tables 38 to 42, the resin compositions used in each of Examples 8-1 to 8-15 resulted in the neck-in and the die buildup being inhibited. Furthermore, in the vapor deposition film of each of Comparative Examples 8-1 and 8-3, in which the resin compositions which are susceptible to die buildup were used, there were numerous vapor deposition flaws, the adhesion strength of the inorganic vapor deposition layer was low, and the gas barrier properties were inferior. Moreover, in the vapor deposition film (base layer) of each of Comparative Examples 8-2 and 8-4, in which the resin compositions which are susceptible to neck-in were used, the width direction uniformity of the OTR was low. Furthermore, the vapor deposition films of these Comparative Examples were also inferior in recyclability. In contrast, in each of Examples 8-1 to 8-15, in which the resin compositions which inhibited the die buildup and the neck-in were used, vapor deposition flaws were inhibited, the vapor deposition film was obtained having an inorganic vapor deposition layer with high adhesion strength and superior gas barrier properties, and the width direction uniformity of the OTR in the monolayer film (base layer) was able to be improved. Furthermore, the vapor deposition films of the Examples also had favorable recyclability.

### EXPLANATION OF THE REFERENCE SYMBOLS

1 Cup-shaped container
Cup main body
10A Layer (α)
10B Layer (β)
10C Layer (γ)
10D Layer (δ)
11 Flange portion
12 Opening
13 Inner surface
14 Outer surface
2 Lid
3 Continuous multilayer structure
4 Heating apparatus
40, 41 Heater
5 Die apparatus
50 Lower mold half
51 Upper mold half
52 Recessed part
53 Plug
101 Layer (α)
102 Layer (β)
103 Layer (γ)
104 Layer (δ)
105 Blow-molded container
106 Container inner surface
107 Container outer surface

1. A resin composition comprising:
an ethylene-vinyl alcohol copolymer (A) having an ethylene unit content of 20 mol % or more and 60 mol % or less; and
crotonaldehyde (B1), wherein
the resin composition further comprises at least one selected from the group consisting of 2,4-hexadienal (B2) and 2,4,6-octatrienal (B3), and
the following inequalities (1) and (2) are satisfied:
$$2. \leq {b}_{1} / ( {b}_{2} + {b}_{3} ) < 150. \qquad ( 1 )$$
$${b}_{2} + 2 {b}_{3} \leq 0.65 \qquad ( 2 )$$
wherein, in the above inequalities (1) and (2),
b₁ represents a content (ppm) of crotonaldehyde (B1) with respect to the ethylene-vinyl alcohol copolymer (A);
b₂ represents a content (ppm) of 2,4-hexadienal (B2) with respect to the ethylene-vinyl alcohol copolymer (A); and
b₃ represents a content (ppm) of 2,4,6-octatrienal (B3) with respect to the ethylene-vinyl alcohol copolymer (A).

2. The resin composition according to claim 1, wherein a sum (b₁+b₂+b₃) of the contents of crotonaldehyde (B1), 2,4-hexadienal (B2), and 2,4,6-octatrienal (B3) with respect to the ethylene-vinyl alcohol copolymer (A) is 0.01 ppm or more and 7.0 ppm or less.

3. The resin composition according to claim 1, wherein the content b₁ of crotonaldehyde (B1) is 0.01 ppm or more and 4.0 ppm or less.

4. The resin composition according to claim 1, wherein the content b₂ of 2,4-hexadienal (B2) is 0.005 ppm or more and 0.65 ppm or less.

5. The resin composition according to claim 1, wherein the content b₃ of 2,4,6-octatrienal (B3) is 0.325 ppm or less.

6. The resin composition according to claim 1, further comprising a conjugated polyene compound (C), wherein
a content c of the conjugated polyene compound (C) with respect to the ethylene-vinyl alcohol copolymer (A) is 1 ppm or more and less than 300 ppm.

7. The resin composition according to claim 6, wherein the conjugated polyene compound (C) is sorbic acid.

8. The resin composition according to claim 1, wherein
the ethylene-vinyl alcohol copolymer (A) comprises:
an ethylene-vinyl alcohol copolymer (Aa) having an ethylene unit content of 20 mol % or more and 50 mol % or less; and
an ethylene-vinyl alcohol copolymer (Ab) having an ethylene unit content of 30 mol % or more and 60 mol % or less,
a difference (Ab−Aa) between the ethylene unit content of the ethylene-vinyl alcohol copolymer (Ab) and the ethylene unit content of the ethylene-vinyl alcohol copolymer (Aa) is 4.5 mol % or more, and
a mass ratio (Aa/Ab) of the ethylene-vinyl alcohol copolymer (Aa) to the ethylene-vinyl alcohol copolymer (Ab) is 60/40 or more and 95/5 or less.

9. The resin composition according to claim 1, further comprising an inorganic particle (D), wherein
a content d of the inorganic particle (D) with respect to the ethylene-vinyl alcohol copolymer (A) is 50 ppm or more and 5,000 ppm or less.

10. The resin composition according to claim 1, further comprising an nonionic surfactant (E), wherein
a content e of the nonionic surfactant (E) with respect to the ethylene-vinyl alcohol copolymer (A) is 0.1 ppm or more and 1,000 ppm or less.

11. The resin composition according to claim 1, further comprising an antioxidant (F), wherein
a content f of the antioxidant (F) is 0.01% by mass or more and 5% by mass or less.

12. The resin composition according to claim 1, further comprising a thermoplastic elastomer (G), wherein
a mass ratio (G/A) of the thermoplastic elastomer (G) to the ethylene-vinyl alcohol copolymer (A) is 5/95 or more and 35/65 or less.

13. A molded product comprising a part constituted from the resin composition according to claim 1.

14. A multilayer structure comprising at least one layer constituted from the resin composition according to claim 1.

15. A thermoformed container comprising a layer constituted from the resin composition according to claim 1.

16. A blow-molded container comprising a layer constituted from the resin composition according to claim 1.

17. A vapor deposition film comprising:
a base layer constituted from the resin composition according to claim 1; and
an inorganic vapor deposition layer provided on at least one face of the base layer.
